(19) United States
(12) Patent Application Publication
(10) Pub. No.: US 2007/0121499 A1
(43) Pub. Date: May 31, 2007

(54) Method of and system for physically distributed, logically shared, and data slice-synchronized shared memory switching

(76) Inventors: Subhasis Pal, Hopkinton, MA (US); Rajib Ray, Weymouth, MA (US); John L. Eppling, Acton, MA (US)

Correspondence Address: RINES & RINES, 24 Warren St., CONCORD, NH, 03301, US

(21) Appl. No.: 11/287,676

(22) Filed: Nov. 28, 2005

(51) Int. Cl. H04L 12/26; H04L 12/56

(52) U.S. Cl. 370/230; 370/417

(57) ABSTRACT

An improved data networking technique and apparatus using a novel physically distributed but logically shared and data-sliced synchronized shared memory switching datapath architecture integrated with a novel distributed data control path architecture to provide ideal output-buffered switching of data in networking systems, such as routers and switches, to support the increasing port densities and line rates with maximized network utilization and with per flow bit-rate latency and jitter guarantees, all while maintaining optimal throughput and quality of services under all data traffic scenarios, and with features of scalability in terms of number of data queues, ports and line rates, particularly for requirements ranging from network edge routers to the core of the network, thereby to eliminate both the need for the complication of centralized control for gathering system-wide information and for processing the same for egress traffic management functions and the need for a centralized scheduler, and eliminating also the need for buffering other than in the actual shared memory itself,—all with complete non-blocking data switching between ingress and egress ports, under all circumstances and scenarios.

### FIELD OF INVENTION

The present invention relates to the field of output-buffered data switching and more particularly to shared-memory architectures therefor, as for use in data networking and server markets, among others.

The art has recognized that such architecture appears to be the best candidate for at least emulating the concept of an ideal output-buffered switch—one that would have infinite bandwidth through the switch, resulting in N ingress data ports operating at L bits/sec being enabled to send data to any combination of N egress data ports operating at L bits/sec, including the scenario of N ingress ports all sending data to a single egress port, and with traffic independence, no contention and no latency.

In such an ideal or “theoretical” output-buffered switch, each egress port would be provided with a data packet buffer memory partitioned into queues that could write in data at a rate of N×L bits/sec, and read data at a rate of L bits/sec, thus allowing an egress traffic manager function residing on the egress port to offer ideal bandwidth management and quality of service (QOS). In such a system, QOS is theoretically ideal because the latency of a data packet and jitter are based purely on the occupancy of the destination queue at the time the packet enters the queue, the desired dequeue or drain rate onto the output line, and the desired order of queue servicing.

### BACKGROUND

In recent years, the rapid growth of the Internet has required data networking systems, such as routers and switches, to support ever increasing port densities and line-rates, while achieving high throughput to maximize network utilization. Emerging applications such as Voice Over IP and IP TV, for example, require networks to provide end-to-end latency and jitter guarantees. Network providers are under pressure to reduce cost by converging separate networks that have traditionally carried voice, data and video onto a single network. For all these reasons, next generation networking systems will require a switching architecture that must be capable of providing per flow bit-rate, latency and jitter guarantees, while maintaining optimal throughput under all traffic scenarios. This is commonly referred to as the before mentioned “quality of service” or QOS. In addition, next generation switching architectures must scale in terms of number of queues, number of ports and line-rates, especially for networking applications, which must meet the requirements of systems used from the edge to the core of the network. These types of systems must continue to keep pace with the growing number of users and bandwidth per user. It is widely accepted that the ideal switching architecture for providing quality of service is the “theoretical” output-buffered switch.

While with current technology, a small system can be implemented to perform substantially as an ideal output-buffered switch with a full N×N or N² mesh for the switch, where each link operates at L bits/sec, and a data packet buffer memory residing on each egress port is capable of such N×L bits/sec writes and L bits/sec reads, such approaches unfortunately do not permit of scaling due to practical limitations in memory bandwidth and available connectivity technologies. The industry, therefore, has followed several diverse trends in trying to emulate the operation of an ideal output-buffered switch, including using input-buffered crossbars, combined input-output buffered cross bars, and shared memory architectures above mentioned—all, however, falling short of attaining all of the desired features of such an ideal switch and each having inherent limitations and disadvantages, which it is a specific objective of the present invention to obviate.

### DESCRIPTION OF PRIOR ART

In recent years, there have been some commercially available networking products and next generation prototypes offered that have leveraged the advantages of shared memory architectures to provide QOS features. Fundamentally, data rates and port densities have grown drastically resulting in inefficient systems due to congestion between ingress or input and egress or output (I/O) ports. The current popularity of shared memory architectures resides in the fact that this appears to be the only known architecture that can emulate certain properties of an ideal output-buffered switch—i.e., as before stated, an output-buffered switch having no contention between N ingress or input ports for any combination of N egress or output ports as in later-discussed FIG. 1. Thus, N ingress ports (0 to N−1) operating at L bits/sec would send data to any combination of N egress ports (0 to N−1) operating at L bits/sec, including the scenario of N ingress ports all sending data to a single egress port, and with this movement of data from ingress ports to egress ports being traffic independent, and with no contention and no latency. This requires an N×N full mesh between ingress or input ports and egress or output ports, where each link is L bits/sec, and the N×N mesh serving as an ideal switch between ports. Each of the N egress ports has an ideal packet buffer memory partitioned into queues that can write data at N×L bits/sec, and can read data at L bits/sec, for placing packets on the output line. Thus, an egress traffic manager residing on the egress port can provide ideal QOS. In such a system, QOS is theoretically ideal because the latency of a packet and jitter are based, as before mentioned, purely on the occupancy of the destination queue at the time the packet enters the queue, the desired dequeue or drain rate onto the output line, and the desired order of queue servicing. An exemplary illustration of such a theoretically ideal output-buffered switch is shown in said FIG. 1.

For large values of N and L, however, an ideal output-buffered switch is not practically implementable from an interconnections and memory bandwidth perspective. The interconnections required between the ingress and egress ports must be N×N×L bits/sec to create the non-blocking switch. The write bandwidth of the packet buffer memory residing on each egress port must also be N×L bits/sec, which results in an aggregate system memory write bandwidth of N×N×L bits/sec. The read bandwidth of each packet buffer memory is only L bits/sec to supply data to the output line, and thus the system has an aggregate read bandwidth of N×L bits/sec. One skilled in the art can readily understand the difficulties in a practical implementation of such an output-buffered switch.

### Input-Buffered or Input-Queued Crossbar Approach (FIG. 2)

The art has, as earlier mentioned, had to resort toward techniques to try to approach the desired results. Turning first to the before-mentioned prior art approach of using input-buffered or input-queued crossbars, these have been provided in many available products from Cisco Systems, such as the Cisco 12000 family. A crossbar switch fabric in its basic form is comprised of a multiplexer per egress port, residing in a central location. Each multiplexer is connected to N ingress ports and is able to send data packets or cells from any input to the corresponding egress port. If multiple ingress ports request access to the same egress port simultaneously, however, the switch fabric must decide which ingress port will be granted access to the respective egress port and therefore must deny access to the other ingress ports. Thus, crossbar-based architectures have a fundamental head-of-line blocking problem, which requires buffering of data packets into virtual output queues (VOQs) on the ingress port card during over-subscription. A central scheduler is therefore required, (FIG. 2), to maximize throughput through the crossbar switch by algorithmically matching up ingress or input and egress or output ports. Most of such scheduling algorithms require VOQ state information from the N ingress ports in order to perform the maximal match between input and output ports. Even though priority is a consideration, these schedulers are not, in practice, capable of controlling bandwidth on a per queue basis through the switch, a function necessary to provide the desired per queue bandwidth onto the output line. This, of course, is far more complex than simply providing throughput, and low latency and jitter cannot be guaranteed if the per queue bit-rate cannot be guaranteed. The integration of bandwidth management features into a central scheduler, indeed, has overwhelming implementation problems that are understood by those skilled in the art.

### Combined Input-Output Queued (CIOQ) Crossbar Approach (FIG. 3)

The industry has therefore sought to enhance the basic crossbar architecture with an overspeed factor in an attempt to improve the before-mentioned inadequacies. While such input-buffered or input-queued crossbar architectures can be so improved by incorporating overspeed in the switching fabric, this requires providing a packet buffer memory on both the ingress and egress ports—VOQs physically distributed across the ingress ports to handle over-subscription, and corresponding queues distributed on the egress ports for bandwidth management functions. This approach is later more fully discussed in connection with the embodiment of FIG. 3. This so-called combined input-output queued crossbar (CIOQ) approach is embodied in commercially available products from, for example, Cisco Systems and Juniper Networks.

Typically such implementations may indeed attain 4× overspeed from the switch fabric to each egress port (4×L bits/sec). The fundamental advantage of this architecture over the traditional input-buffered or input-queued crossbar is that the traffic manager, residing on each egress port, can make bandwidth management decisions based on the state of the queues in the local packet buffer memory. The centralized scheduler still attempts to provide a maximal match between ingress and egress ports with the goal of maintaining throughput through the crossbar. The 4× overspeed enhancement appears to work for some traffic scenarios, particularly when the over-subscription of traffic to a single egress port does not exceed 4×. The system appears to operate in a manner similar to an output-buffered switch, because packets do not need to be buffered in the VOQs on the ingress port, and simply move to the egress port packet buffer memory. From the perspective of the egress traffic manager, this appears as a single stage of packet buffer memory as to which it has complete knowledge and control.

For traffic scenarios where the over-subscription is greater then 4×, however, packets build up in the VOQs on the ingress ports, thus resulting in the before-mentioned problems of the conventional crossbar. While the egress traffic manager has knowledge and control over the egress packet buffer memory, it is the central scheduler that controls the movement of packets between the ingress or input ports and the egress or output ports. At times, accordingly, an egress traffic manager can be in conflict with the central scheduler, as the central scheduler independently makes decisions to maintain throughput across all N ports, and not a specific per queue bit-rate. Accordingly, an egress traffic manager may not have data for queues it wants to service, and may have data for queues it doesn't want to service. As a result, QOS cannot be guaranteed for many traffic scenarios.

Another important weakness is that an egress port may not be oversubscribed but instead may experience an instantaneous burst of traffic behavior that exceeds the 4× overspeed. As an illustration, consider the case where N ingress ports each send L/N bits/sec to the same egress port. At first glance the egress port appears not to be over-subscribed because the aggregate bandwidth to the port is L bits/sec. Should all ingress ports send a packet at the same time to the same egress port, however, even though the average bandwidth to the egress port is only L bits/sec, an instantaneous burst has occurred that exceeds the 4× overspeed.

In addition, the 4× overspeed is typically implemented with parallel links that can introduce race conditions as packets are segmented into cells and traverse different links. This may require packets from the same source destined to the same destination to be checked for packet sequence errors on the egress port.

### Shared Memory Approach (FIG. 4)

It has therefore generally been recognized, as earlier mentioned, that the shared memory architecture approach appears currently to be the only one that can substantially emulate an ideal output-buffered switch because the switching function occurs in the address space of a single stage of packet buffer memory, and thus does not require the data to be physically moved from the ingress ports to the egress ports, obviously except for dequeuing onto the output line. This may be compared to an output-buffered switch of ideal infinite bandwidth fabric that can move data between N ingress ports and N egress ports in a non-blocking manner to a single stage of packet buffer memory. The aggregate ingress or write bandwidth of the shared memory, furthermore, is equal to N×L bits/sec. This can be thought of as an ideal egress packet buffer memory with write bandwidth of N×L bits/sec. Similarly, the aggregate read bandwidth of the shared memory is equal to N×L bits/sec, which can be compared to the read bandwidth of an ideal output-buffered switch of N×L bits/sec across the entire system.

Such shared memory architectures are comprised of M memory banks (0 to M−1) to which the N ingress ports and N egress ports must be connected, where N and M can be, but do not have to be, equal. A memory bank can be implemented with a wide variety of available memory technologies and banking configurations. The bandwidth of each link on the ingress or write path is typically L/M bits/sec. Thus, the aggregate bandwidth from a single ingress port to the M memory elements is L bits/sec, and the aggregate write bandwidth to a single memory bank from N ingress ports is L bits/sec, as later discussed in connection, for example, with FIG. 4.

Similarly, the bandwidth of each link on the egress or read path is L/M bits/sec. Thus, the aggregate bandwidth from M memory banks into a single egress port is L bits/sec, and the aggregate read bandwidth of a single memory bank to N egress ports is also L bits/sec. This topology demonstrates a major concept of shared memory architectures, which is that the aggregate ingress and egress bandwidth across N ports is equal to the aggregate read and write bandwidth across M memory banks regardless of the values of N and M. It is this link to memory element topology and bandwidth per link, indeed, that allows the system to be defined as a true shared memory system, with implementation advantages compared to the output buffered switch, where the aggregate bandwidth from all N input ports to all N egress ports requires N×N×L bits/sec, and that the packet buffer memory residing on each egress port must be able to write N×L bits/sec, for an aggregate memory write bandwidth across the system of N×N×L bits/sec. (as in FIG. 1)

In summary, an ideal output-buffered switch would require orders of magnitude more memory bandwidth and link bandwidth compared to a truly shared memory switch. Practically, shared memory switch architectures to date, however, have other significant problems that have prevented offering the ideal QOS and scalability that is required by next generation applications.

Typical prior shared memory architectures attempted to load balance data from the N ingress ports across the M memory banks on the write path, and time division multiplex (TDM) data from the M memory banks to the N egress ports on the read path, such as is described, for example, in US patent application publication 2003/0043828A1 of X. Wang et al, then of Axiowave Networks Inc. The read path can utilize a TDM scheme because each of the N ports must receive L/M bits/sec from each memory bank.

Other examples of this basic shared memory data path architecture can also be found in current core router products from Juniper Networks Inc of Sunnyvale, Calif., and as described in their Sindhu et al U.S. Pat. No. 6,917,620 B1, issued Jul. 12, 2005, as well as described and discussed in academic articles such as C. S. Chang, D. S. Lee and Y. S. Jou, “Load Balanced Birkhoff-von Neumann switches, Part I: one-stage buffering,” Computer Communications, Vol. 25, pp. 611-622, 2002, and C. S. Chang, D. S. Lee and C. M. Lien, “Load Balanced Birkhoff-von Neumann switches, Part II: multi-stage buffering,” Computer Communications, Vol. 25, pp. 623-634, 2002.

The challenges for actually implementing such a state-of-the art shared memory architecture that can easily scale the number of ports and queues and deliver deterministic QOS, reside in the following datapath and control path requirements.

The write datapath must load balance data from N ingress ports across M shared memory banks, in a non-blocking and latency bound manner, which is independent of incoming data traffic rate and destination. The read datapath must be non-blocking between M shared memory banks and N egress ports, such that any queue can be read at L bits/sec regardless of the original incoming data traffic rate, other than the scenario when an egress port is not over-subscribed, and thus only the incoming rate is possible. The forward control architecture between N ingress ports and N egress ports must be able to inform the respective N egress traffic managers of the queue state in a non-blocking and latency bounded manner. Similarly, the reverse control architecture between N egress ports and N ingress ports must be able to update queue state in a non-blocking and latency bounded manner.

Prior art approaches to meet the before-mentioned datapath requirements fall into two categories; a queue striping method as employed by the before cited Axiowave Networks (FIG. 5); and a fixed load balancing scheme as employed by Juniper Networks. The latter is in fact similar to a switching method referred to in the before-cited article on the Birkhoff-von Neumann load balanced switch.

Prior art approaches to deal with the challenges in the control architecture in actual practice have heretofore centered upon the use of a centralized control path, with the complexities and limitations thereof, including the complex control path infrastructure and overhead that are required to manage a typical shared-memory architecture.

### Load-Balancing Approaches and Problems in Shared Memory Schemes

In the above-cited Wang et al Axiowave Networks approach, earlier termed “queue striping”, the essential scheme was that a data packet entering an ingress or input port, is segmented into cells, and makes a request to the central scheduler for an address and space in a particular queue. A single address is sent back, and because the queue in this approach is striped across the memory banks (0 to M−1), the ingress port sprays the segmented cells across the memory banks. The central scheduler meanwhile increments the write pointer by the number of cells in the packet so that it can schedule the next packet with the right start point. Because the queue is striped across the memory banks, a cell is sent to every bank, which achieves load balancing across the memory banks. If a subsequent packet is destined to the same queue from this ingress port, or any other ingress port for that matter, the central scheduler will issue an address that points to the next adjacent memory bank, which in a sense continues the load balancing of cells destined to the same queue across the memory banks (FIG. 5).

In the case of small minimum size packets equal to a cell size, however, wherein subsequent packets are all going to different queues and the current state of the central scheduler is such that all the write pointers happen to be pointing to the same memory bank, every cell will be sent to the same bank, developing a worst-case burst. This scheme therefore does not guarantee a non-blocking write path for all traffic scenarios. To obviate this, it is required to add the expense of FIFOs placed in front of every bank and that have been sized based on the cell size times the number of queues in the system to handle such a worst-case or “pathological” event. While a FIFO per memory bank may absorb the burst of cells such that no data is lost, this is, however, at the expense of latency variation into the shared memory. Even this technique, moreover, while working fine for today's or current routers with requirements of the order of a thousand plus queues, introduces scalability and latency problems for scaling the number of queues by, for example, a factor of ten. In such a case, FIFOs sitting in front of the memory bank would have to be 10,000 times the cell size, resulting in excessively large latency variations, as well as scalability issues and expense in implementing the required memories. Though this approach provides a blocking write path, it does have the advantage of satisfying the read path requirements of allowing any queue to be read at L bits/sec. This is because, regardless of the incoming rate and destination, the queue is striped across the M memory banks, and this allows each memory bank to supply L/M bits/sec to the corresponding egress or output port. It is meeting both the ingress and egress datapath requirements, which is indeed a major challenge to overcome, as will later be explained. Furthermore, while this approach simplified the control path in some ways, it still requires a centrally located compute intensive scheduler with communication paths between ingress and egress ports. Although this is more efficient than a full mesh topology, system cost, implementation and scalability are impacted by the requirement for more links, board real estate and chip real estate for the scheduler. This is later addressed in connection with FIG. 9.

Returning to the second datapath approach of Juniper Networks Inc, U.S. Pat. No. 6,917,620 B1 for fixed scheduling load balancing, this achieves load balancing across the shared memory banks by use of a fixed scheduling algorithm. Each ingress port writes the current cell to memory bank I+1, where I is the last memory bank accessed. This occurs regardless of the destination queue and incoming traffic rate. The benefit to this approach is that the worst-case ingress path latency is bounded by N cells from N input ports being written to a single memory bank. A FIFO in front of each memory bank can temporarily store the cells when this worst-case condition occurs. The burst is guaranteed to dissipate because all N input ports will be forced to write subsequent cells to the next memory bank. It should be noted, however, that the worst-case burst size is not related to the number of queues in the system, as in the before-described Wang-Axiowave approach of FIG. 5, but rather to the number of ports. The burst FIFOs are therefore small and add negligible latency variation.

A similar load-balancing scheme is discussed in the before-cited “Birkhoff Von Neumann Load Balanced Switch” article. This method also employs a fixed scheduling algorithm, but guarantees that only one ingress port has access to a single memory bank in any given time slot. Similar to the Juniper approach, each ingress or input port writes the current cell to, for example, memory bank I+1, of the 0 to M−1 banks, where I is the last memory bank accessed. Each ingress port, however, starts on a different memory bank at system start up, and then follows a fixed scheduling algorithm rotation to the next memory bank. Like the Juniper approach, this also occurs regardless of destination and incoming data traffic rate. There is never more than one ingress port accessing a single memory bank at any time, completely eliminating contention between N ingress ports and eliminating the need for burst FIFOs, (FIG. 6).

Both of these last-described approaches result in cells for the same queue having a fragmented placement across the shared memory banks, where the cell placement is actually dependent on the incoming traffic rate. The Juniper approach, however, is different from the “Birkhoff Von Neumann Load Balanced Switch” approach in that Juniper writes each cell to a random address in each memory bank, whereas the “Birkhoff Von Neumann Load Balanced Switch” employs pointer-based queues in each memory bank that operate independently. The before-mentioned datapath problem, however, is directly related to the placement of cells across the banks due to a fixed scheduler scheme (FIG. 7) and thus the organization within a bank is not relevant because both schemes experience the same problem.

As an example, consider ingress or input ports (0 to 63) with multiple traffic streams destined to different queues originating from the same input port. If the rate for one of the traffic streams is 1/64 of the input port rate of L bits/sec, and say, for example, the shared memory is comprised of 64 memory banks (0 to 63), it is conceivable that the cells would end up with a fragmented placement across the memory banks, and in the worst-case condition end up in the same memory bank. The egress datapath architecture requires that an output port receive L/M bits/sec from each memory bank to keep up with the output line rate of L bits/sec. The egress port will thus only be able to read L/M bits/sec from this queue since all the cells are in a single bank. An egress traffic manager configured to dequeue from this queue at any rate more than L/M bits/sec will thus not be guaranteed read bandwidth from the single memory bank. It should be noted that even though the single memory bank is capable of L bits/sec it must also supply data to the other N−1 ports. Such fragmented cell placement within a queue seriously compromises the ability of the system to deliver QOS features as in FIG. 7.

To obviate this problem, both architectures propose reading multiple queues at the same time to achieve L bits/sec output line rate. Essentially, every memory bank supplies L/M bits for an output port, which would be preferably for the same queue, but could be for any queue owned by the egress port. This approach appears to achieve high throughput, but only for some traffic scenarios.

Consider a simple scenario where an egress port is receiving both high and low priority traffic in two queues from two ingress ports. Assume that the high priority traffic rate can vary from 100% to 0% of L bits/sec. Assume that the low priority traffic rate is fixed at 25% of L bits/sec. Furthermore, the ingress port that is the source of the low priority traffic is also sending 75% of L bits/sec to other ports in the system. This scenario is similar to a converged network application of lucrative high priority voice packets converged with low priority Internet traffic. The egress traffic manager is configured so as always to give 100% of the bandwidth to the high priority traffic when required, and any unused bandwidth must be given to the low priority traffic. Assume that, during a peak time, the high priority traffic rate is 100% of L bit/sec; and also, during this same time, the low priority traffic fills its queue at a rate of 25% of L bits/sec. Based on the fixed load balancing scheduler, the low priority queue is fragmented across the shared memory, and actually only occupies four banks. When the bandwidth requirements for the high priority traffic are met, and the queue goes empty, the egress traffic manager will start dequeuing from the low priority queue. At this point in time, the low priority queue will be backlogged with packets, but the egress traffic manager will only be able to read cells from 4 memory banks for an aggregate rate of 4×L/M bits/sec, essentially limiting the output line to 25% of L bits/sec, even though the queue is backlogged with packets. This obviously seriously compromises QOS.

This also emphasizes the important concept for any switching architecture providing quality of service, that packet departure or dequeue rate must not be dependent on the packet arrival rate.

Another problem that can arise in the above-mentioned prior art schemes is that cells within a queue can be read from the shared memory out of order. Consider again the simple example of N=64 ports and M=64 shared memory banks, where subsequent cells 1, 2 and 3 from the same ingress port are destined to the same queue. Assume, for example, the scenario where the destination queue is currently empty, where cells 1 and 2 are spaced apart by 1/64 of L bits/sec and thus go to the same bank, and where cell 3 is spaced apart from cell 2 by 1/32 of L bits/sec and goes to a different bank. When the egress port reads out of this queue, cell 0 and cell 3 will be read before cell 2 because cell 2 is behind cell 0. This will require expensive reordering logic on the output port and also limits scalability.

### Approaches and Problems for Addressing, in Prior Control Path Infrastructures for Managing a Shared Memory

As mentioned before, general prior art approaches to deal with the challenges in the control architecture, in actual practice, have heretofore centered upon two methods of addressing. The first is random address-based schemes and the second is pointer-based schemes. General prior art approaches, furthermore, utilize two methods of transporting control information—the first utilizing a full mesh connectivity for a distributed approach and the second being a star-connectivity approach to a centralized scheduler. Such techniques all have their complexities and limitations, including particularly the complex control path infrastructure and the overhead required to manage typical shared-memory architectures.

To reiterate, to offer ideal QOS, the forward control architecture (FIG. 4) between N ingress ports and N egress ports should be able to inform the respective N egress traffic managers of the queue state in a non-blocking and latency bounded manner. Similarly, the reverse control architecture between N egress ports and N ingress ports must be able to update queue state also in a non-blocking and latency bounded manner.

In a random access load-balanced scheme of the Juniper approach, each ingress port has a pool of addresses for each of the M memory banks. The ingress port segments a data packet into fixed size cells and then writes to M memory banks, always selecting an address for the earlier described I+1 memory banks, where I is the current memory bank. This is done regardless of the destination data queue. While the data may be perfectly load-balanced, the addresses have to be transmitted to the egress port and sorted into queues for the traffic manager dequeuing function. Addresses for the same packet, furthermore, must be linked together.

As an example, consider the illustrative case where the data rate L bits/sec is equal to OC192 rates (10 Gb/s), and the N ingress ports are sending 40 byte packets at full-line rate to a single egress port, with each ingress port generating an address every 40 ns. This requires the egress port to receive and sort N addresses every 40 ns, necessitating a full mesh control path and a compute-intense enqueuing function by the egress traffic manager, (FIG. 8).

An alternative approach is to employ a centralized processing unit to sort and enqueue the control to the respective egress traffic managers as in FIG. 9 as an illustration.

Other prior art shared memory proposals, as earlier mentioned, use a centralized pointer-based load-balanced approach, wherein each ingress port communicates to a central scheduler having a read/write pointer per queue. The ingress port segments the data packet into, say, j fixed size cells and writes the cells to shared memory based on the storing address from the central scheduler, as in the manner of the Axiowave approach, previously referenced and shown in FIG. 5 illustrating the datapath, and FIG. 9 illustrating the communication path to a central scheduler. The cells are written across the M memory banks I+1 up to j cells, while the central scheduler increments the write pointer by j. As described before, this load-balancing scheme, however, can deleteriously introduce contention for a bounded time period under certain scenarios, such as where the central scheduler write pointers for all queues that happen to synchronize on the same memory bank, thus writing a burst of cells to the same memory bank. Similarly the central scheduler can have a worst-case scenario of all N ingress ports requesting addresses to the same egress port or queue. In essence this can also be thought of as a burst condition in the scheduler (FIG. 9), which must issue addresses to all N ingress ports in a fixed amount of time so as not to affect the incoming line-rate. A complex scheduling algorithm is indeed required to process N requests simultaneously, regardless of the incoming data rate and destination. The pointers must than be transferred to all the N egress ports and respective traffic managers. This can be considered analogous to a compute intense enqueue function.

For all of the above prior methods, however, a return path to the ingress port or central scheduler is required to free up buffers or queue space as packets are read out of the system. Typically this is also used by an ingress port to determine the state of queue fullness for the purpose of dropping packets during times of over-subscription.

In summary, control messaging and processing places a tremendous burden on prior art systems that necessitates the use of a control plane to message addresses or pointers in a non-blocking manner, and requires the use of complex logic to sort addresses or pointers on a per queue basis for the purpose of enqueuing, gathering knowledge of queue depths, and feeding this all to the bandwidth manager so that it can correctly dequeue and read from the memory to provide QOS.

The before mentioned problems, for the first time, are all now totally obviated by the present invention, as later detailed.

### The Role of the Present Invention

As above shown, prior innovations in shared-memory architectures before the present invention have not, in practice, been able to eliminate the need for the complications of centralized control for gathering system-wide information and for the processing of that information for the egress traffic management functions, crucial to delivering QOS.

As later made more specifically evident, the present invention, on the other hand, now provides a breakthrough wherein its new type of shared-memory architecture fundamentally eliminates the need for any such centralized control path, and, indeed, integrates the egress traffic manager functions into the data path and control path with minimal processing requirements, and with the data path architecture being uniquely scalable for any number N of ports and queues.

The approach of the present invention to the providing of substantially an ideal output-buffered switch, as before defined, thus departs radically from the prior-art approaches, and fortuitously contains none of their above-described limitations and disadvantages.

On the issue of preventing over-subscribing a memory bank, moreover, the invention provides a data write path that, unlike prior art systems, does not require the data input ports to write to a predetermined memory bank based on a load-balancing or fixed scheduling scheme, which may result in a fragmented placement of data across the shared memory and thus adversely affect the ability of the output ports to read up to the full output line-rate.

The invention, again in contrast to prior techniques, does not require the use of burst-absorbing FIFOs in front of each memory bank; to the contrary, providing rather a novel FIFO-functional entry spanning physically distributed, but logically shared, memory banks, and not contained in a single memory bank which can develop the before-described burst conditions when data write pointers synchronize to the same memory bank, which may adversely impact QOS with large latency and jitter variations through the burst FIFOs.

The invention, indeed, with its physically distributed but logically shared memory provides a unique and ideal non-blocking write path into the shared memory, while also providing a non-blocking read path that allows any output port and corresponding egress traffic manager to read up to the full output line-rate from any of its corresponding queues, and does so independent of the original incoming traffic rate and destination.

The invention, again in contrast to prior art techniques, does not require additional buffering in the read and write path other than that of the actual shared memory itself. This renders the system highly scalable, and minimizes the data read path and data write path control logic to a simple internal or external memory capable, indeed, of storing millions of pointers for the purpose of queue management.

### OBJECTS OF INVENTION

A primary object of the invention, accordingly, is to provide a new and improved method of and system for shared-memory data switching that shall not be subject to the above-described and other limitations of prior art data switching techniques, but that, to the contrary, shall provide a substantially ideal output-buffered data switch that has a completely non-blocking switching architecture, that enables N ingress data ports to send data to any combination of N egress data ports, including the scenario of N ingress data ports all sending data to a single egress port, and accomplishes these attributes with traffic independence, zero contention, extremely low latency, and ideal egress bandwidth management and quality of service, such that the latency and jitter of a packet is based purely on the occupancy of the destination queue at the time the packet enters the system, the desired dequeue or drain rate onto the output line, and the desired order of queue servicing.

A further object is to provide a novel output-buffered switching technique wherein a novel data write path is employed that does not require the data input or ingress ports to write to a predetermined memory bank based on a fixed load balancing scheduler scheme.

Another object is to provide such an improved architecture that obviates the need for the use of data burst-absorbing FIFOs in front of each memory bank.

An additional object is to eliminate the need for any additional buffering other than that of the shared memory itself.

Still a further object is to provide a novel data-slice synchronized lockstep technique for storing data across the memory banks, which allows a memory slice to infer read and write pointer updates and queue status, thus obviating the need for a separate non-blocking forward and return control path between the N ingress and egress ports.

Still another object is to provide such a novel approach wherein the system is relatively inexpensive in that it is susceptible to configuration with commodity or commercially available memories and generally off-the-shelf parts, and can be scaled to grow or expand linearly with increases in bandwidth. In particular connection with this objective, the invention provides novel combinations of SRAM and DRAM structures that guarantee against any ingress or egress bank conflicts.

The invention also provides a novel switching fabric architecture that enables the use of almost unlimited numbers of data queues (millions and more) in practical “real estate” or “footprints”.

A further object is to provide for such linear expansion in a manner particularly attractive for network edge routers and similar data communication networks and the like.

And still a further object is to provide a novel and improved physically distributed and logically shared memory switch, also useful more generally; and also for providing a new data-slice synchronized lockstep technique for memory bank storage and retrieval, and of more generic applicability, as well.

Other and further objects will be hereafter described and are more particularly delineated in the appended claims.

### SUMMARY

In summary, from one of its broadest points of view, the invention embraces a method of non-blocking output-buffered switching of successive lines of input data streams along a data path between N I/O data ports provided with N corresponding respective ingress and egress data line cards, that comprises,

creating a physically distributed logically shared memory datapath architecture wherein each line card is associated with a corresponding memory bank and a controller and a traffic manager, and each line card is connected to the memory bank of every other line card through an N×M mesh that provides each ingress line card with write access to all the M memory databanks, and each egress line card with read access to all the M memory banks;

dividing the ingress data bandwidth of L bits per second at each ingress line card by M and evenly transmitting data to the M-shared memory banks, thereby providing L/M bits per second data link utilization;

segmenting each of the successive lines of each input data stream at each ingress data line card into M data slices;

partitioning data queues for the memory banks into M physically separate column slices of memory storage locations or spaces, one corresponding to each data slice along the data lines;

writing each data slice of a line along the corresponding link of the ingress N×M mesh to a corresponding memory bank column different from the other data slices of the line, but into the same predetermined corresponding storage location or space in each of the M memory banks columns, whereby the writing-in and storage of the data line occurs in lock-step as a row across the memory bank slices;

and writing the data slices of the next successive line into the corresponding memory bank columns at the same queue storage location or space thereof, adjacent to the storage location or space in that bank of the corresponding data slice already written in from the preceding input data stream line.

The data slice writing into memory is effected simultaneously for the slices in each line, and the slice is controlled in size for load balancing across the memory banks. The data lines are designed to have the same line width; and, in the event any line lacks sufficient data slices to satisfy this width, the line is provided with data padding slices sufficient to achieve the same line width and to enable the before-described lock-stepped or synchronized storage.

The above-summarized physically distributed and logically shared memory datapath architecture is integrated with a distributed data control path architecture that enables the respective line cards to derive respective data queue pointers for en-queuing and de-queuing functions and without requiring a separate control plane or centralized scheduler as in prior techniques. This architecture, furthermore, enables the distributed lockstep memory bank storage operation to resemble the operation of a single logical FIFO of width spanning the M memory banks.

In the egress side of the distributed data control path, each traffic manager monitors its own read and write pointers to infer the status of the respective queues, because the lines that comprise a queue span the memory banks. The read/write pointers for the egress line card queues thus enable monitoring reads and writes of the data slices of the corresponding memory bank to permit such inferring of line count from the data slice count for a particular queue. The integration of this distributed control path with the distributed shared memory architecture enables the traffic managers of the respective egress line cards to provide quality of service in maintaining data allocations and bit-rate accuracy, and for re-distributing unused bandwidth for full output, and also for adaptive bandwidth scaling.

The approach of the present invention to the providing of a substantially ideal output-buffered switch, as before explained, thus departs radically from the above described and other prior art approaches and contains none of their limitations and disadvantages.

On the issue of preventing over-subscribing a memory bank, the invention, as previously stated, provides a data write path that, unlike prior art systems, does not require the data input ports to write to a predetermined memory bank based on a load-balancing scheduler.

The invention, again in contrast to prior techniques, does not, as before mentioned, require the use of burst-absorbing FIFOs in front of each memory bank; to the contrary, the invention enables a FIFO entry to span its novel physically distributed, but logically shared memory banks, and is not contained in a single memory bank which can result in burst conditions when data write pointers synchronize to the same memory bank.

The invention, indeed, with its physically distributed but logically shared memory provides a unique and ideal non-blocking write path into the shared memory, while also providing a non-blocking read path that allows any output port and corresponding egress traffic manager to read up to the full output line-rate from any of its corresponding queues, and does so independent of the original incoming traffic rate and destination.

The invention, again in contrast to prior art techniques, requires no additional buffering in the read and write path other than the actual shared memory itself. This renders the system highly scalable, minimizing the data write path control logic to simple internal or external memory capable, indeed, of storing millions of pointers.

In accordance with the invention, a novel SRAM-DRAM memory stage is used, implemented by a new type of memory matrix and cache structure to solve memory access problems and guarantee against all ingress and egress bank conflicts so vitally essential to the purpose of the invention.

Preferred and best mode designs and implementations and operation are hereinafter discussed in detail and are more particularly set forth in the appended claims.

### DRAWINGS

The invention will now be described in connection with the accompanying drawings in which

FIG. 1, as earlier described, is a schematic block diagram of an “ideal” output buffered switch illustrating the principles or concepts of non-blocking N×N interconnections amongst N input or ingress ports to N output or egress ports, where each interconnect operates at L bits/sec for an aggregate interconnect bandwidth of L×N×N bits/sec, and where each output port has a non-blocking packet buffer memory capable of writing N×L bits/sec, and reading L bits/sec in order to maintain output line-rate;

FIG. 2 is a schematic block diagram of the before-described traditional prior art crossbar switch with virtual output queues (VOQ) located on the ingress port;

FIG. 3 is a schematic block diagram of the previously described prior art enhanced crossbar switch with a 4× overspeed through the switch, requiring VOQs on the ingress ports and additional packet buffer memory on the egress ports;

FIG. 4 is a schematic block diagram of a typical earlier referenced prior art shared memory switch illustrating the N×N interconnections amongst N input or ingress ports and corresponding M shared-memory banks, and similarly the N×N interconnections amongst N output or egress ports and corresponding M shared-memory banks, where each interconnect operates at L/M bits/sec, and where the shared-memory banks are shown physically disposed there-between for purposes of explanation and illustration only;

FIG. 5 is a schematic block diagram illustrating the earlier referenced prior art shared memory architecture with queues striped across M memory banks for the purpose of load balancing the ingress datapath;

FIG. 6 is a schematic block diagram illustrating the before-mentioned Birkhoff-von Neumann load balanced switch, which is a type of prior art shared memory architecture with independent virtual output queues in each of the M memory banks to support a load balancing scheme that always writes the next cell from each ingress port to the next available bank;

FIG. 7 is a similar diagram of a prior art shared memory architecture illustrating the earlier mentioned potential QOS problems that can result if cells are load balanced across the M shared memory banks based on a fixed scheduling algorithm; this figure applying to both Birkhoff-von Neumann switch and the before-mentioned Juniper switch;

FIG. 8 is a similar diagram illustrating the before-mentioned prior art N×N mesh between N ingress and N egress ports to support a forward and reverse control path; and

FIG. 9 is a schematic block diagram illustrating previously described prior art forward and reverse control paths between N ingress and egress ports and a central scheduler or processing unit, where the depicted forward and reverse scheduler are logically a single unit.

The improvements provided by the present invention, as distinguished from the above and other prior art systems, are illustrated commencing with the schematic block diagram of

FIG. 10, which illustrates a preferred embodiment of the present invention and its novel sliced shared memory switch architecture, using the orientation of the queuing architecture of the invention depicted in terms of the same pictorial diagram format as the prior art illustrations of the preceding figures;

FIG. 11 is a diagram similar to FIG. 4, but illustrates the logical blocks of the invention as comprised of N ingress ports, N egress ports and M memory slices, where a memory slice is comprised of a memory controller (MC) and traffic manager (TM) and wherein the read (Rd) and write (Wr) pointers (ptr) are incorporated into the TM block. Though not illustrated in detail, but however implied, as later described, the TM can be further logically divided into ingress and egress blocks referred to as iTM and eTM, shown schematically for memory slice 0, for example. It is also implied that the MC can be further logically divided into ingress and egress blocks referred to as iMC and eMC. It is assumed, also, that the MC is connected to physical memory devices that function as the main packet buffer memory;

FIG. 12 schematically illustrates data streams at successive time intervals tₒ-tᵤ, each comprised of W bits or width of data, termed a data “line” herein, and being fed to an input or ingress port of FIG. 11;

FIG. 13 illustrates the data line segmentation scheme of the invention wherein at each ingress port, each line of data is segmented into N slices, with Dₓ shown segmented in the input port line card as D_{X0} . . . D_{XN-1};

FIG. 14 illustrates a schematic logical view of a queue Q_{q} of data, schematically showing association with address space locations 0-s_{q}−1 for a line card of N data slices (Q_{q}[A]_{0 through} Q_{q}[A]_{N-1}), where s_{q} represents the size or number of W bit-wide lines of data, and with queue write and read pointers represented at wptr_{q} and rptr_{q}, respectively;

FIG. 15 schematically shows the progression of the input or ingress port line segments of FIG. 13 into the memory queue bank of FIG. 14;

FIG. 16 illustrates the physical distribution of the memory in accordance with the present invention, wherein the data queue bank of FIG. 15 has been physically divided into separated parallel memory bank slices, with each slice containing the same column of queue data as in FIG. 15 and with the same logical and location sharing, but in physically distributed memory slices;

FIG. 17 through FIG. 21 illustrate the successive storage of input port data line segments, lock step inserted into the memory slices for the successive data line streams at respective successive times t₀-t₄;

FIG. 22 is similar to FIG. 15, but illustrates multiple (two) queue banks involved in practice;

FIG. 23 through FIG. 27 are similar to FIG. 17 through FIG. 21, respectively, but illustrate the respective input port data line segments lock-step inserted into the memory slices for multiple queues;

FIG. 28 through FIG. 32 are similar to FIG. 23 through FIG. 27, but show the respective output or egress data paths for the multiple queues of FIG. 22 fed to the egress, and illustrated for successive times of readout of the data stored from the ingress or input ports at successive times t=t₀ through t=t₄;

FIG. 33 illustrates an abstract N×N non-blocking switching matrix, wherein each intersection represents a group of queues that can only be accessed by a single ingress port and egress port pair;

FIG. 34 is similar to FIG. 33, but illustrates an exemplary 64×64 switching matrix to represent a 64-port router example, utilizing a memory element that provides 1 write access from 1 ingress port and 1 read access from 1 egress port;

FIG. 35 is similar FIG. 34, but illustrates the 64×64 switching matrix reduced to a 32×32 switching matrix by utilizing a memory element that provides 2 write accesses from 2 ingress ports and 2 read accesses from 2 egress ports;

FIG. 36 is similar to FIG. 35, but illustrates the 64×64 switching matrix reduced to an 8×8 switching matrix by utilizing a memory element that provides 8 write accesses from 8 ingress ports and 8 read accesses from 8 egress ports;

FIG. 37 is similar to FIG. 36, but illustrates the 64×64 switching matrix reduced to an ideal 1×1 switching matrix by utilizing a memory element that provides 64 write accesses from 64 ingress ports and 64 read accesses from 64 egress ports;

FIG. 38 is similar to FIG. 36, but illustrates the 64×64 switching matrix reduced to an array of eight 8×8 matrixes by utilizing a memory element that provides 8 write accesses for 8 ingress ports and 8 read access for 8 egress ports. In this example, however, a memory element only provides 8 byte data transfers instead of 64 byte transfers every 32 ns, demonstrating that 8 parallel memory elements are required to meet the line rate of L bits/sec and that, therefore, a total of 512 memory elements are required in an array of eight 8×8 matrixes to achieve the non-blocking switching matrix;

FIG. 39 a through d illustrate a novel fast-random access memory structure that utilizes high-speed random access SRAM as one element to implement the previously described non-blocking switching matrix, and DRAM as a second element for the main packet buffer memory, FIG. 39a and b detailing the respective use of later-described combined-cache and split-cache modes of a function of the data queues, and switching therebetween as needed to prevent the ingress ports from prematurely dropping data and the egress ports from running dry of data; and FIG. 39c and d showing physical implementations for such two-element memory structure for supporting 8 and 16 ports, respectively;

FIG. 40 illustrates the connectivity topology between ingress ports, egress ports and memory slices for the purpose of reducing the number of physical memory banks on a single memory slice, illustrating but a single group of ingress ports and egress ports connected to M memory slices, which is the least number of links possible, but requires the maximum number of physical memory banks on each memory slice;

FIG. 41 is similar to FIG. 40, but illustrates how the egress ports can be divided into two groups by doubling the number of memory slices, where half the egress ports are connected to the first group of M memory slices, and the other half of the egress ports are connected to the second group of M memory slices; thus, effectively reducing the number of memory banks on each memory slice by half; though at the expense of doubling the number of links from the ingress ports, which must now go to both groups of M memory slices, though the number of links between the memory slices and the egress ports has not changed and the total number of physical memory banks required for the system has not changed;

FIG. 42 is similar to FIG. 41, but illustrates how the ingress ports can be divided into two groups by doubling the number of memory slices, where half the ingress ports are connected to the first group of M memory slices, and the other half of the ingress ports are connected to a second group of M memory slices; thus, effectively reducing the number of memory banks on each memory slice by half, though at the expense of doubling the number of links from the egress ports, which must now go to both groups of M memory slices—the number of links between the memory slices and the ingress ports not changing and the total number of physical memory banks required for the system not changing;

FIG. 43 illustrates a “pathological” traffic scenario on the ingress N×M mesh demonstrating the need for double the link bandwidth for the scenario, where a packet is aligned such that an extra data slice continually traverses the same link, thus requiring double the ingress bandwidth of 2×L/M bits/sec, and also illustrating the physical placement of the data slices across the M memory slices with appropriate dummy-padding slices to align a packet to a line boundary;

FIG. 44 illustrates the novel rotation scheme of the invention that places the first data slice of the current incoming packet on the link adjacent to the link used by the last data slice of the previous packet, requiring no additional link bandwidth and also illustrating that the data slices within a line are still written to the same address location and are therefore rotated in the shared memory. The figure illustrates that the dummy-padding slices for the previous packet are still written to the shared memory to maintain the padding on line boundaries;

FIG. 45 illustrates a detailed schematic of the inferred and actual read and write pointers on a TM and MC residing on a combined line card;

FIG. 46 illustrates a detailed schematic of a combined iTM and eTM, MC, network processor and physical interfaces on a line card;

FIG. 47 illustrates a detailed schematic of the Read Path;

FIG. 48 illustrates the use of N×M meshes with L/2 bits/sec links for small-to-mid size system embodiments; thus allowing the invention to support minimum to maximum line card configurations—again with the link utilization being L/M bits/sec, or L/2 bits/sec for a 2-card configuration;

FIG. 49 illustrates the use of a crosspoint switch with L/M bits/sec links for large system embodiments, thus allowing the invention to support minimum to maximum line card configurations with link utilization of L/M bits/sec.

FIG. 50 illustrates the use of TDM switches with L bits/sec links, which eliminates the need for N×M meshes, for extremely high capacity next generation system embodiments; thus allowing the invention to support minimum to maximum line card configurations—this configuration requiring 2×N×L bits/sec links;

FIG. 51 illustrates a single line card embodiment of the invention, with the TM, MC, memory banks, processor and physical interface combined onto a single card;

FIG. 52 is similar to FIG. 51 but illustrates a single line card with multiple channels supporting multiple physical interfaces;

FIG. 53 illustrates an isometric view showing a single chassis comprised of single line cards stacked in a particular physical implementation of the invention;

FIG. 54 is similar to FIG. 53 in illustrating an isometric view showing a single chassis comprised of single line cards, but also including cross connect cards or TDM cards stacked in a particular implementation of the invention for the purpose of supporting higher system configurations, beyond what can be implemented with an N×M ingress and egress mesh;

FIG. 55 illustrates a two-card embodiment of the invention with separate line and memory cards;

FIG. 56 illustrates a dual chassis embodiment of the invention with a separate chassis to house each of the line cards and the memory cards; and

FIG. 57 illustrates a multi-chassis embodiment of the invention with a separate chassis to house each of the line cards, memory cards, and crosspoint or TDM switches.

### DESCRIPTION OF PREFERRED EMBODIMENT(S) OF THE INVENTION

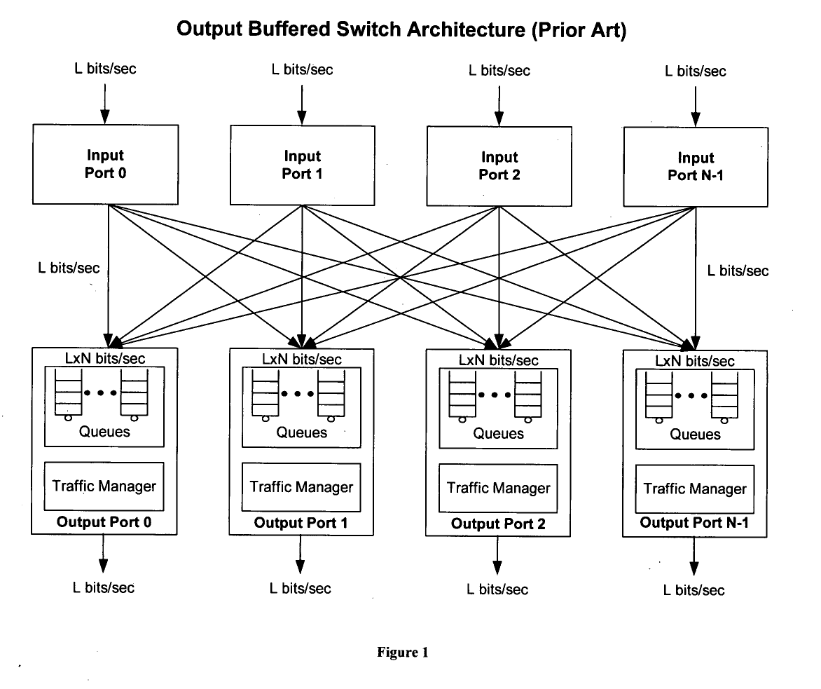

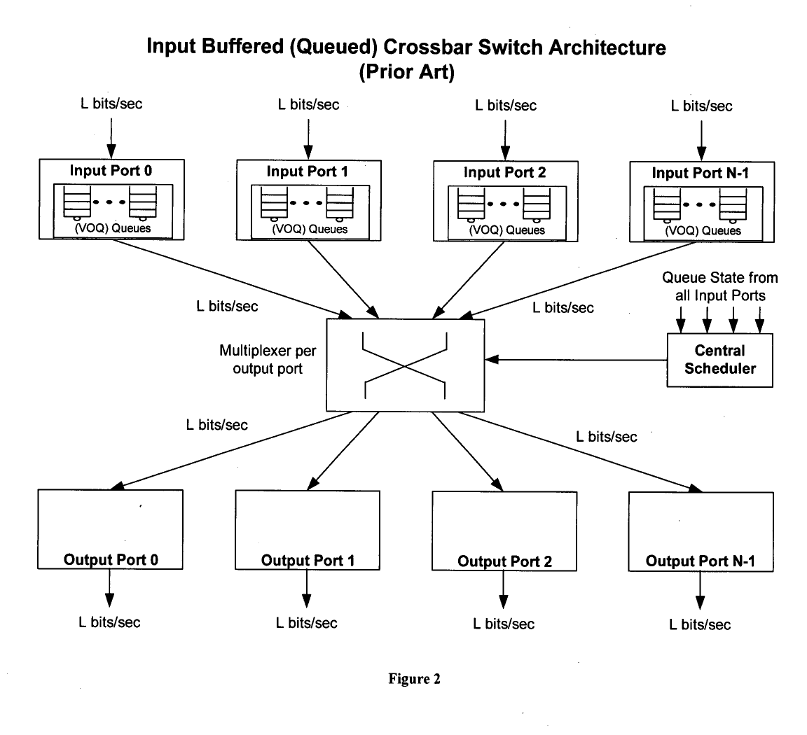

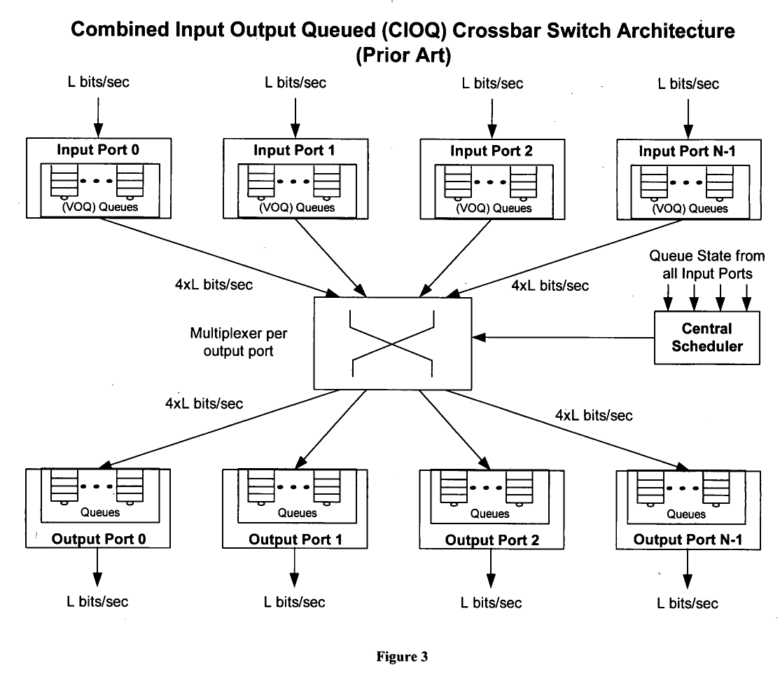

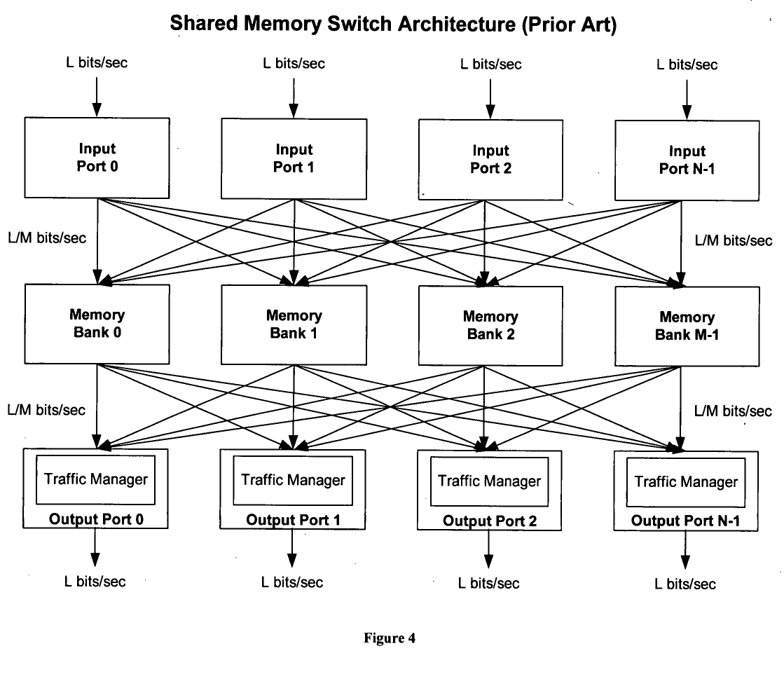

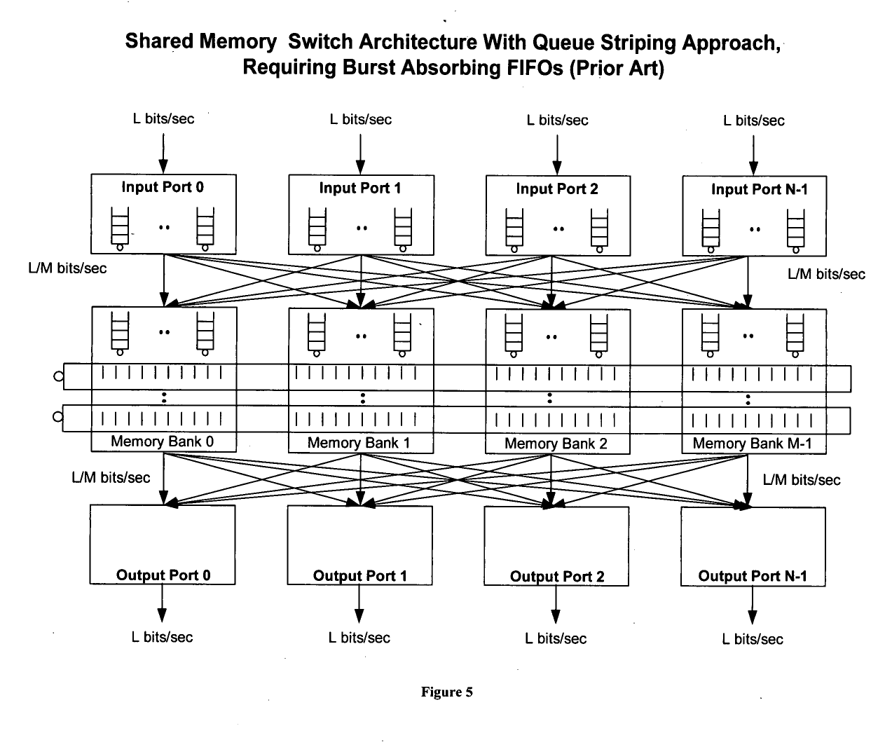

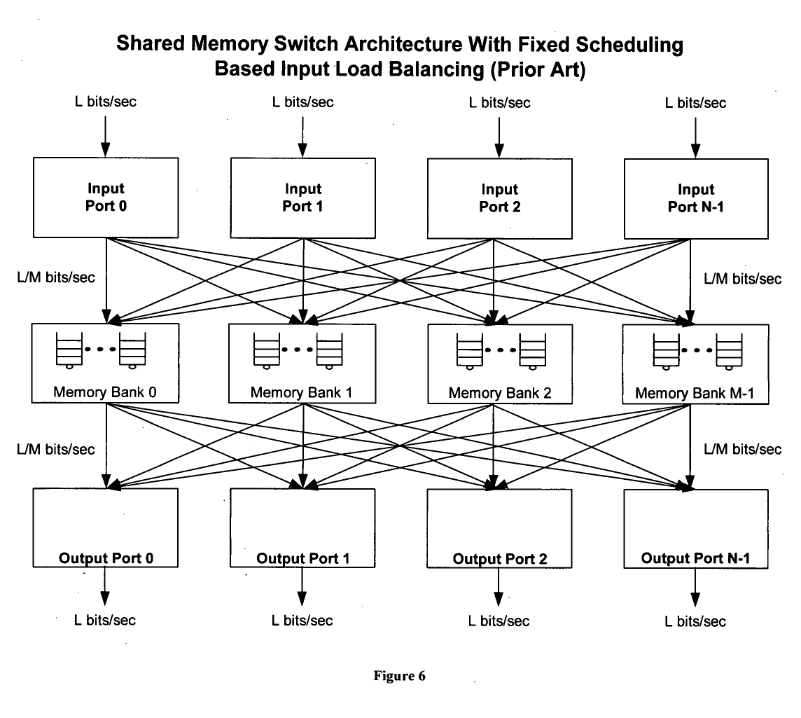

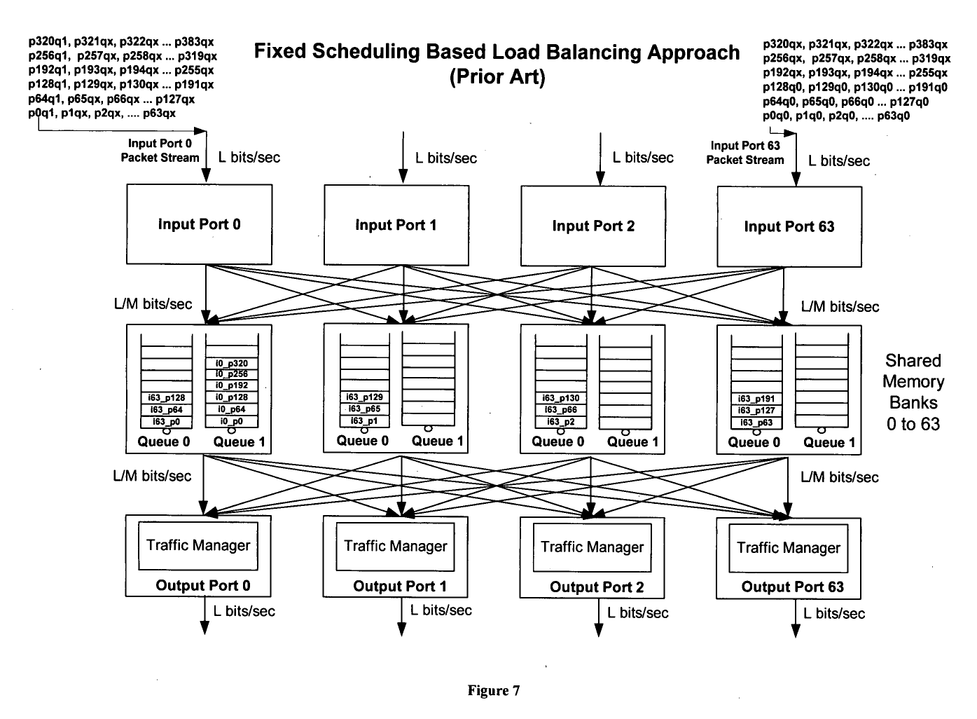

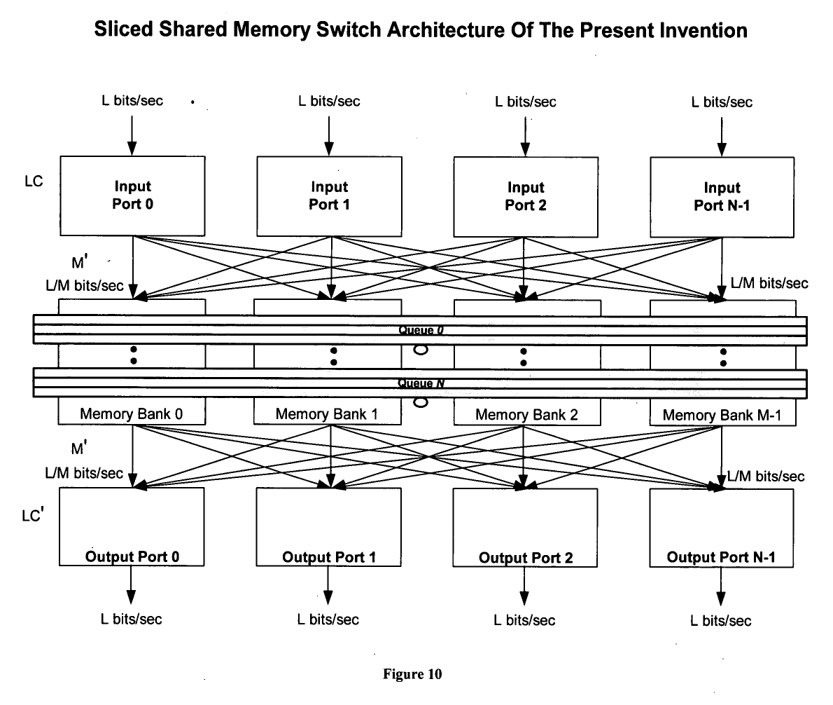

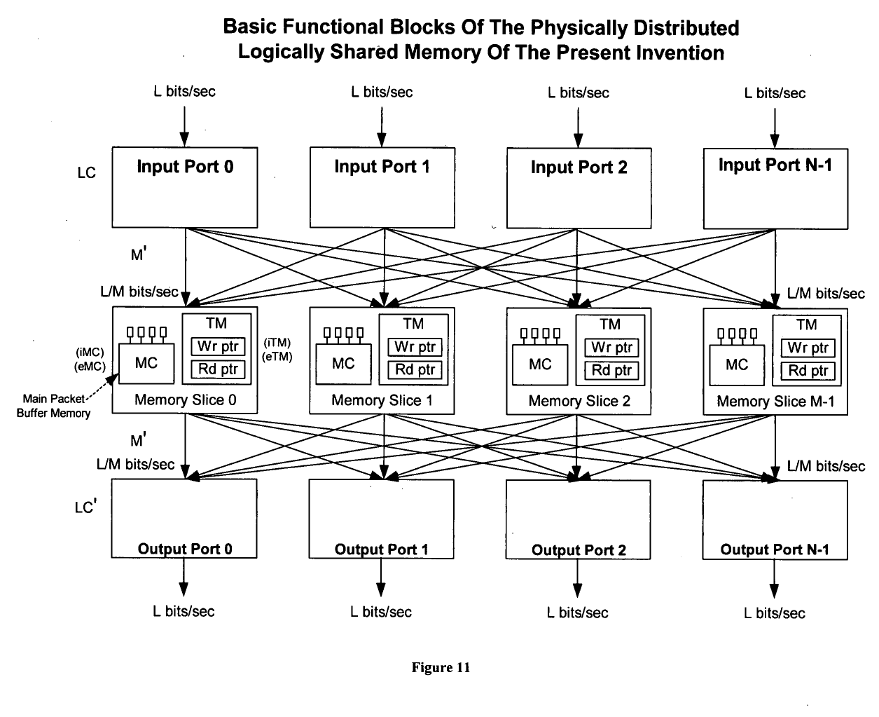

Turning first to FIG. 10, the topology of the basic building blocks of the invention—ingress or input ports, egress or output ports, memory bank units, and their interconnections—is shown in the same format as the descriptions of the prior art systems of FIG. 1 through FIG. 9, with novel added logic units presented in more detail in FIG. 11 of the drawings.

At the ingress, a plurality N of similar ingress or input ports, each comprising respective line cards schematically designed as LC of well known physical implementation, is shown at input ports 0 through N−1, each respectively receiving L bits of data per second of input data streams to be fed to corresponding memory units labeled Memory Banks 0 through M−1, with connections of each input port line card LC not only to its own corresponding memory bank, but also to the memory banks of every one of the other input port line cards in a mesh M′ of N×M connections, providing each input port line card LC with data write access to all the M memory banks, and where each data link provides L/M bits/sec path utilization.

The M memory banks, in turn, are similarly schematically shown connected in such N×M mesh M′ to the line cards LC′ of a plurality of corresponding output ports 0 through N−1 at the egress or output, with each memory bank being connected not only to its corresponding output port, but also to every other output port as well, providing each output port line card LC′ with data read access to all the M memory banks.

As previously described, the system of the invention has N I/O ports receiving and transmitting data at line-rate L bits/sec, for a full-duplex rate of 2L bits/sec. The N I/O Ports are connected to a distributed shared memory comprised of M identical memory banks, where each memory bank may, in practice, be implemented from a wide variety of available memory technologies and banking configurations, such that the read and write access thereby is equal to 2L, providing N=M. With each port connected to each memory bank through an N×M mesh on the ingress (write) path and an N×M mesh on the egress (read) path, each link path comprising the 2×N×M mesh is only required to support a rate of L/M bits/sec. This link path topology implies that the aggregate rate across all the I/O ports is equal to the aggregate rate across all the memory banks, where the rate to and from any single memory bank will not exceed 2L, providing N=M. In FIG. 10, for illustrative purposes only, the I/O ports have been shown logically as separate entities, but there are many possible system partitions for the I/O ports and the memory banks, some of which will later be considered.

In the more detailed diagram of FIG. 11 that includes the logical building blocks, though in schematic form, the memory banks of FIG. 10 are expanded into what may be called “Memory Slices”, later more fully explained, because they are shown associated not just with memory, but also with memory controllers (“MC”) connected to the physical memory bank, essentially to dictate the writes and reads into and from the physical memory. Also included, again schematically, are respective traffic managers (“TM”) with respective read pointers (“Rd ptr”) and write pointers (“Wr ptr”), all hereinafter more fully explained, and intimately involved with the previously described distributed FIFO type architecture used in the present invention. Though not illustrated in detail, but however implied, as later described, the TM can be further logically divided into ingress and egress blocks referred to as iTM and eTM, shown schematically for memory slice 0, for example. It is also implied that the MC can be further logically divided into ingress and egress blocks referred to as iMC and eMC. It is assumed, also, that the MC is connected to physical memory devices that function as the main packet buffer memory.

At this juncture, however, it is desired to point out that the illustrated locations of functional blocks in FIG. 10 and FIG. 11 are not the only possible locations, as also later further described. As but one illustration, however, the traffic manager, memory controller and physical memory devices may be located on the line cards, rather than on memory cards, as shown, etc.

### Data-Handling Architecture

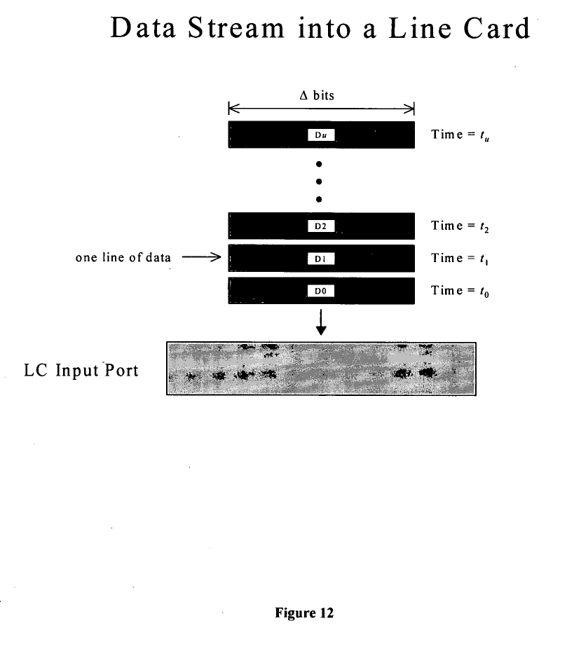

With this general outline of the basic building blocks, it is next in order to describe key concepts on the data handling architecture. Referring, accordingly, to FIG. 12, a data stream into each input port of FIG. 11, is pictorially represented as time-successive lines of data, each W (or Δ) bits in width, being input at a certain rate. Thus, at time t₀, a line of data D₀ is fed into the input port line card LC; and, at successive later times t₁, t₂ . . . t_{μ}, similar lines of W (or Δ) bits of data will enter the input port line card during successive time intervals t Δ.

Each quantity of data Dᵢ enters the line card at time tᵢ as follows:

tᵢ₊₁>tᵢ, t_{Δ}=tᵢ₊₁−tᵢ, where W (or Δ)=bit width of data coming into the line card every t_{Δ}. Therefore the data rate coming into the line card is L=Δ/t_{Δ}or W/t_{Δ}. This, however, in no way implies or is limited or restricted to any serial or parallel or other nature of the data transfer into the line card.

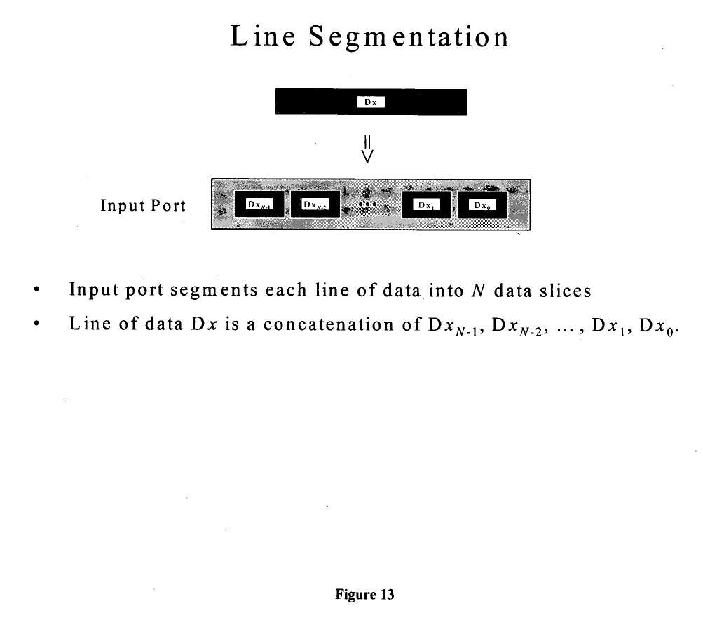

Further in accordance with the invention, once a data line stream Dx entered the input port line card, it is their partitioned or segmented into N or M data slices, shown schematically in FIG. 13 as data slices Dx₀ through Dx_{N-1}; where each line of data Dₓ is a concatenation of Dx_{N-1} . . . Dx₀. For explanatory purposes, the number of memory slices, M, and the number of ports, N, are considered equal; however, in actual practice, the values of M and N are not required to be equal and are based purely on the physical partitioning of a system.

The data slices are now to be written in queried form into address locations in the memory banks by the write pointers (Wr ptr) on the memory slice cards (FIG. 11).

### Queue Addressing Architecture

It is at this point believed to be useful, for explanatory purposes, to examine a logical view of what such a queue may entail, and the matter of addressing in memory.

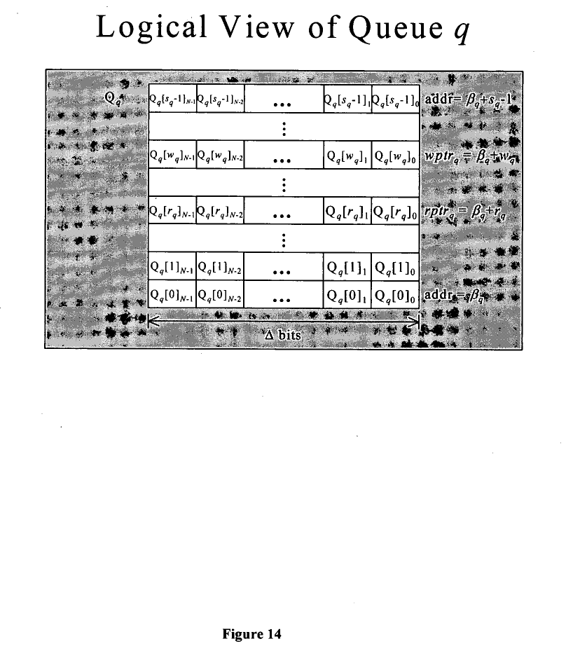

FIG. 14 presents a pictorial logical view of such queue storage in memory, wherein each queue is a FIFO that is W or Δ bits wide and is designated a unique queue number, q. In this illustration, each address location contains space for a line (horizontal row) of N (or M) data slices Q_{q}[A]₀ to Q_{q}[A]_{N-1}, where A represents the memory address within the queue.

As shown, as an illustration, for an address 0 (“addr=0”), the bottom horizontal line or row of spaces for the slices extends from Q_{q}[0]₀ at the far right, to Q_{q}[0]_{N-1} at the far left. The next horizontal row or line of spaces is shown vertically adjacent to bottom-line address “1”; and so on, vertically upward to the limiting address s_{q}−1 for this q of size s_{q}; i.e. holding s_{q} lines of data W or Δ bits wide.

Thus, each queue q, where q is a unique queue number, is a FIFO that is Δ bits wide and contains s_{q} memory locations. The base of the queue is at absolute memory location β_{q}. Each address location contains space for a line of N (or M) data slices Q_{q}[A]₀ to Q_{q}[A]_{N-1}, where A is the relative memory address within the queue (A is the offset address from β_{q}). s_{q} is the size of the queue q; i.e. the queue holds s_{q} lines of data that is W bits wide; and each queue has a write pointer wptr_{q} and a read pointer rptr_{q} for implementing the FIFO as a later-described ring buffer.

In FIG. 14, r_{q} is the read pointer offset address, and w_{q} is the write pointer offset address where r_{q} and w_{q} are offsets that are relative to the base of the queue.

In a useful addressing implementation, the queue FIFO operation may be effected by such a ring buffer as of the type, for example, disclosed in U.S. Pat. No. 6,684,317, under the implementation of each queue write pointer wptr_{q} and read pointer rptr_{q}. To illustrate the novel logical queue concept of the invention, a write pointer address Wq is shown writing an N data slice into the horizontal line or row Q_{q}[w_{q}]_{N-1} . . . Q_{q}[w_{q}]₀, with Q_{q}[W_{q}]₀ in the same location or space in the right-most vertical column as the earlier described slice Q_{q}[0]₀ of the corresponding slice at address 0, (i.e. Q_{q}[0]₀). Similarly, the read pointer rptr_{q} is illustrated as addressing the space Q_{q}[rq]₀, again in the same far-right vertical column above Q_{q}[0]₀, and so on.

The total space allocated for the queue thus consists of a contiguous region of memory, shown in the figure with an address range of, say, β_{q} to β_{q}+s_{q}−1, where β_{q} is the base address of the queue and s_{q} is the size of the queue q; i.e. the queue can hold s_{q} lines of data. Each queue in the system, as before mentioned, has a unique base address where queue q is located in the shared memory. The base addresses of all the queues are located such that none of the queues overlaps any other in memory. At each address location, furthermore, exactly one line of data can be stored. The read pointer points to data that will be the next data item to be read. The write pointer points to the space or location where the next piece of data will be written. For the special case when the queue is empty, the read and write pointers point to the same location. The read and write pointers shown in FIG. 14 consist of the sum of the base address β_{q} and an offset address that is relative to the base address. The actual implementation may, if desired, use absolute addresses for the read and write pointer instead of a base plus an offset; but for examples shown, the queue can be conveniently viewed as a contiguous array in memory that is addressed by an index value starting at 0.

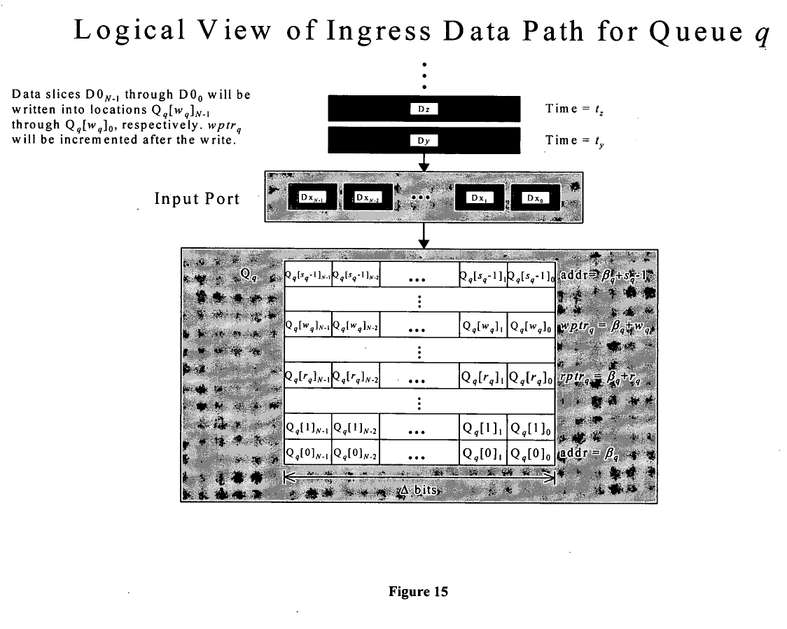

In FIG. 15, the queue storage of FIG. 14 is shown receiving the data-sliced segmented input port line or row of data slices as in FIG. 13, presenting a logical view of the ingress data from the input data stream to the queue in shared memory. After writing slices into the locations or spaces Q_{q}[w_{q}]₀ . . . Q_{q}[w_{q}]_{N-1}, above described, for example, wptr_{q} will be incremented.

### Memory Slice Architecture

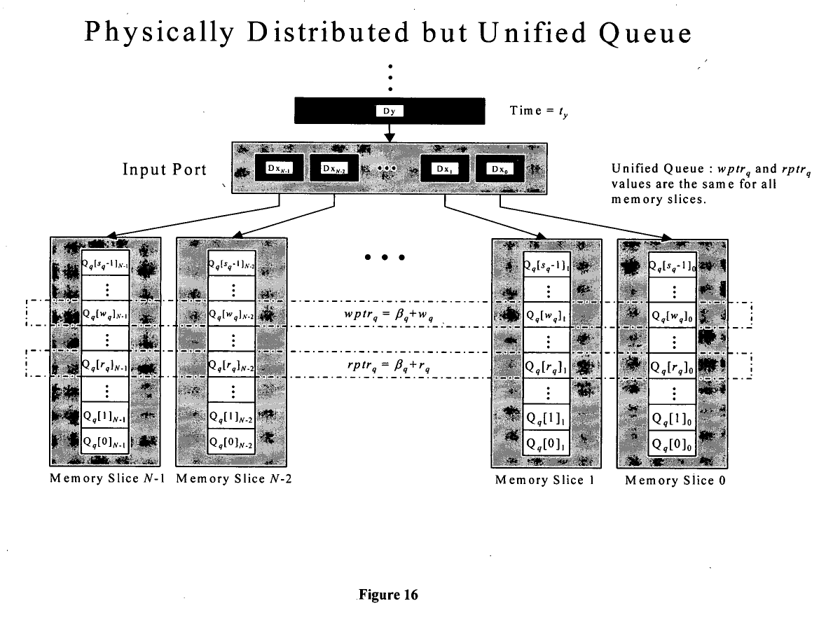

Further in accordance with the invention, the vertical columns of the queue bank of FIG. 15 are broken apart laterally, partitioned into separate memory slice columns Memory Slice 0 . . . N−1, where N=M, creating the novel now physically distributed, but logically unified, queue of FIG. 16, wherein the wptr_{q} and rptr_{q} values are the same for all the columns of memory slices. In this partitioning, each row corresponds to the space at a specific address location within the queue. Each column, in turn, corresponds to a vertical slice of the queue as shown in FIG. 15, where the width of the vertical slice is exactly the width of a single data slice. A column contains exactly the spaces allocated for data slices adding the data slice number. In column 1, for example, Q_{q} represents the column containing the spaces Q_{q}[0]₁, Q_{q}[1]₁, . . . Q_{q}[s_{q}−1]₁. In general, a column γ represents the column containing up to spaces Q_{q}[0]_{γ}, Q_{q}[1]_{γ}, . . . Q_{q}[s_{q}−1]_{γ}.

For a system with N (or M) data slices, as here, the memory is partitioned into N (or M) memory slices identified, as before stated, with labels 0, 1, . . . , N−2, N−1. The queue is partitioned among the memory slices such that memory slice γ contains only column γ of each queue. Once partitioned in this manner, the memory slices can be physically distributed among multiple cards, FIG. 16 showing an example of such a physically distributed, shared memory system of the invention.

Although the slices (or columns) of a queue may be thus physically distributed, each queue is unified in the sense that the addressing of all the slices of a queue is identical across all memory slices. The queue base address β_{q} is identical across all memory slices for each slice of a queue. The read and write pointers rptr_{q} and wptr_{q} for a queue, furthermore, are replicated exactly across all memory slices. When a line of data is written to a queue, each memory slice will receive a data slice for the corresponding queue slice; and when a line of data is read from memory, each memory slice will read one data slice from the corresponding queue slice. At each operation, the read/write pointers will be adjusted identically, with the net result that a read/write to/from a queue will result in identical operations across all memory slices, thus keeping the state of the queue synchronized across all memory slices. This is herein termed the “unified queue”. In FIG. 16, (and succeeding figures), the fact that one read/write pointer value applies across all memory slices is indicated by the horizontal dashed-line rectangle representation.

Each line of data slices is written from the input port into the memory slices with each data slice being fed along a different link path, in the before described N×M mesh, to its corresponding memory slice; i.e. data slice Dx₀ is written into its queue slot in Memory Slice 0; data slice DX₁ into Memory Slice 1, and data slice Dx_{N-1} into Memory Slice N−1.

### Data Packet Segmentation into Data Slices

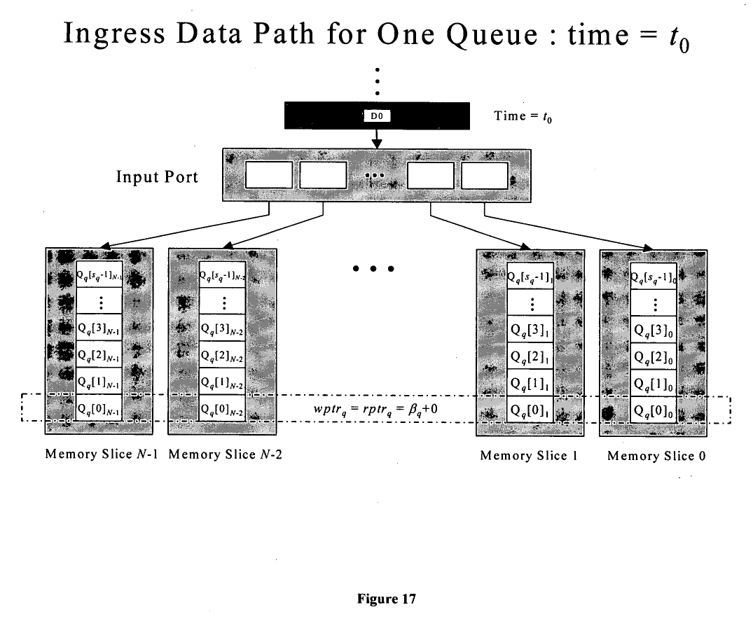

FIG. 17 through FIG. 21 show an example of how a single data packet entering into an input port, gets segmented into data slices, and is thus written into the unified queue of the invention that is distributed across N (or M) memory slices. In this instance, the read and write pointers for the queue are assumed to be initialized to 0 offset, which implies that the queue is initially empty. At time t₀ (FIG. 17), D0, the first line of the packet, is about to enter the input port.

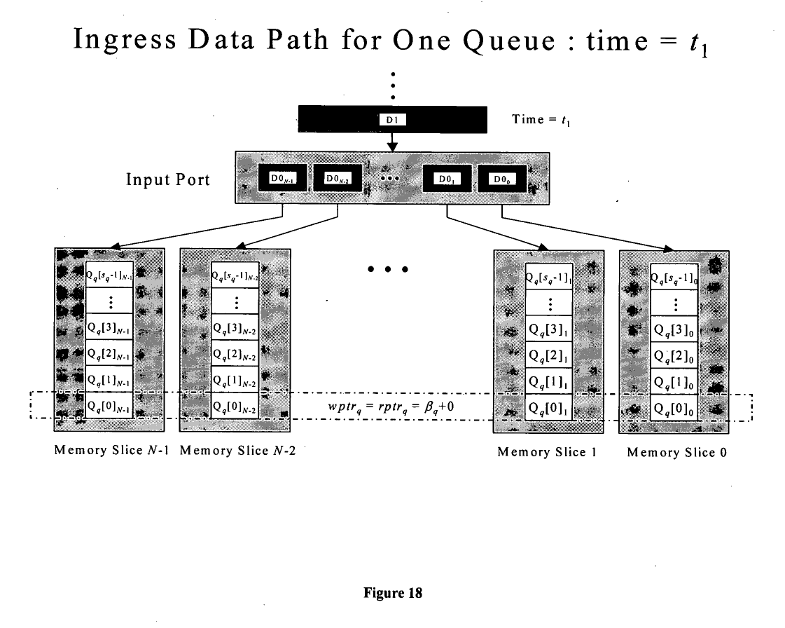

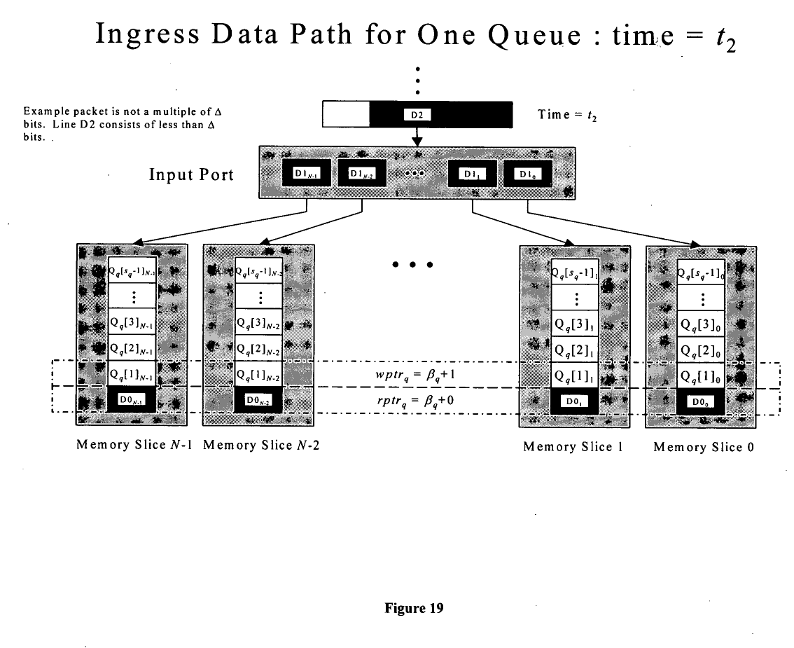

Turning now to FIG. 18, representing time t₁, D0 has now entered the input port and has been segmented into N (or M) data slices. Meanwhile, the next line D1 is in the input stream pipeline, ready to be processed by the input port. FIG. 19 shows the events at time t₂, where the data slices belonging to data line D0, namely D0₀, D0₁, . . . , D0_{N-1} have all been written into the queue in their respective memory slices. As a result of writing a line of data, the write pointer has been incremented to point to the next available adjacent memory location, which is the offset address 1. This figure also shows the next data line D1 having been segmented by the input port.

In FIG. 19, moreover, the end of the next data packet D2 is shown being ready to be processed by the input port.

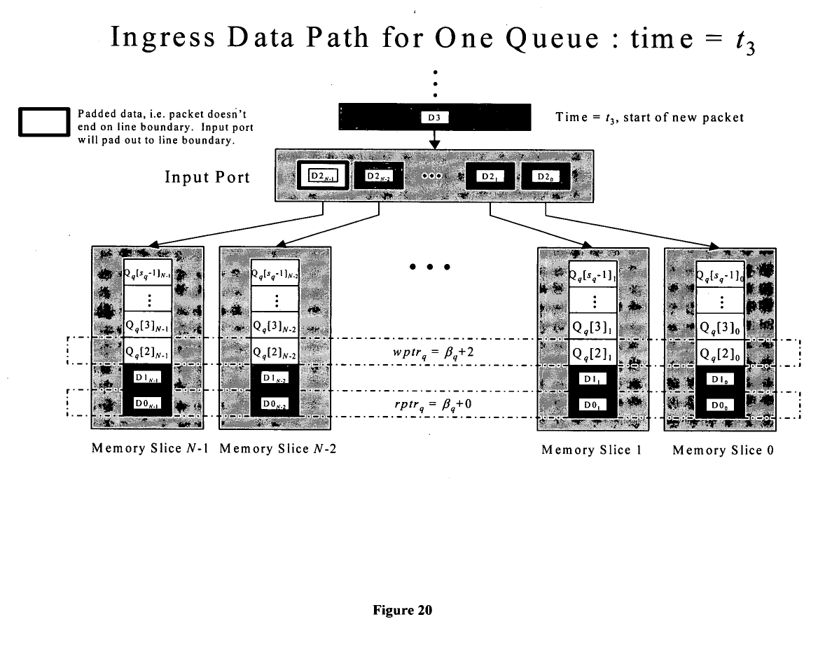

For purposes of further illustrating the possible circumstance before-mentioned, where the data line lacks sufficient bits to provide the necessary W (or Δ) data bits of the lines of data, the example of FIG. 19 shows such a case where the last line of the packet is made up of less than W (or Δ) bits. For simplicity, assume that D2 is missing the last Δ/N; which would be the bits for the last data slice. Continuing with FIG. 20 (time t₃), in the bits in D2 being segmented by the input port there are no bits for the last data slice. As earlier discussed, the invention then provides for the input port to pad the data out to consist of exactly W (or Δ) bits. The black-bordered white box for the data slice D2_{N-1} in the figure represents such padded data.

Also, in this figure, the data slices D1₀, D1₁, . . . , D1_{N-1} have been written into the queue, and the write pointers to each data slice have again been incremented.

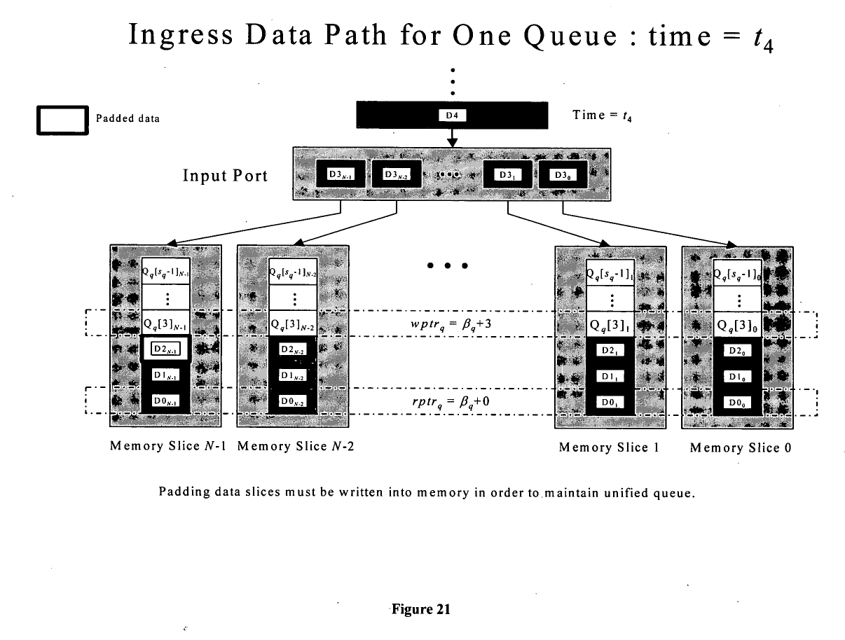

The last figure in this sequence, FIG. 21, shows this line with the padded data being written into memory, being treated just like real data. In this embodiment, the padded data is written to memory to ensure that the state of the queue is identical for all memory slices; i.e. the value of the read and write pointers are identical across all the memory slices, as previously discussed; writing the padded data slice into memory simplifies implementation, however, a novel scheme to maintain synchronization across N (or M) memory slices without actually writing the padded data slice to memory, will later be described.

To recapitulate at this juncture, the present invention, therefore, partitions the shared memory into output queues, where a queue emulates a FIFO with a width that spans the N (or M) memory banks and has write bandwidth equal to L bits/sec. Each FIFO entry is bit-sliced across the N (or M) memory banks, with each slice of a FIFO working in lockstep with every other slice. Each output port owns a queue per input port per class of service, eliminating any requirement for a queue to have more than L bits/sec of write bandwidth. Providing a queue per flow, moreover, allows the system to deliver ideal quality of service (QOS) in terms of per queue bandwidth, low latency and jitter.

A queue, as above explained, operates like a FIFO with a read and write pointer pair, which reference the entries in a queue. A single entry in a queue spans the N (or M) memory banks and is stored at the same address location in each of the memory banks. Similarly, the next entry in the queue spans the N (or M) memory banks and is stored at the same adjacent address in each of the memory banks, and so forth. An input port will maintain write pointers for the queues that are dedicated to that input port, in the form of an array indexed by the queue number. A write pointer is read from the array based on the queue number, incremented by the total size of the data transfer, and then written back to the array. A local copy of the write pointer is maintained until the current data transfer is complete. The time required for this lookup operation must be within the minimum data transfer of the application to keep up with L bits/sec.

In accordance with the invention, as before explained, the actual data written to a single entry in a queue is defined as a line, where the quantum of data written to each memory bank is defined as a data slice. The size of a data slice is defined as C Bits and is based on the application and the memory controller design (theoretically C could be as small as a single bit). The size of a line is thus N×C (or M×C) Bits. The write pointer, discussed above, references the line count and is incremented by the total line count for the current data transfer.

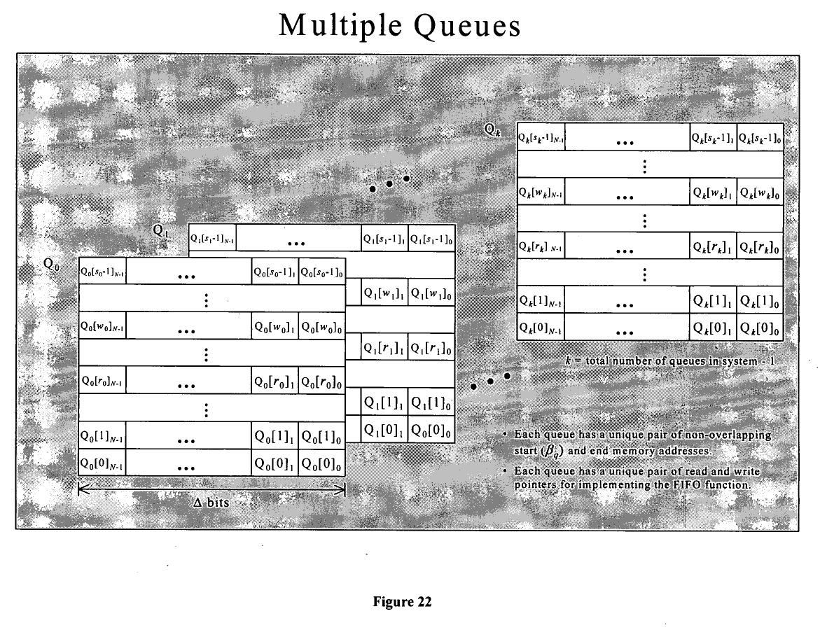

In actual practice, there will usually be multiple data queues and these are presented in FIG. 22, illustrating a logical view of what the shared memory looks like with such multiple queues. In this figure, k represents one less than the total number of queues in the system (this notation being used so as to fit the labels into the available space on the drawing without making the fonts too small to read). Again, each queue in the system has a width of W or Δ bits. Each queue has a unique base address that is assigned such that the queues do not overlap in memory. Each queue may have a unique size if so desired, or all of the queues may be the same size. The sizes of the queues, indeed, will be dependent on the applications being served by the queues. Each queue also has a unique pair of read and write pointers for implementing the FIFO function for each queue.

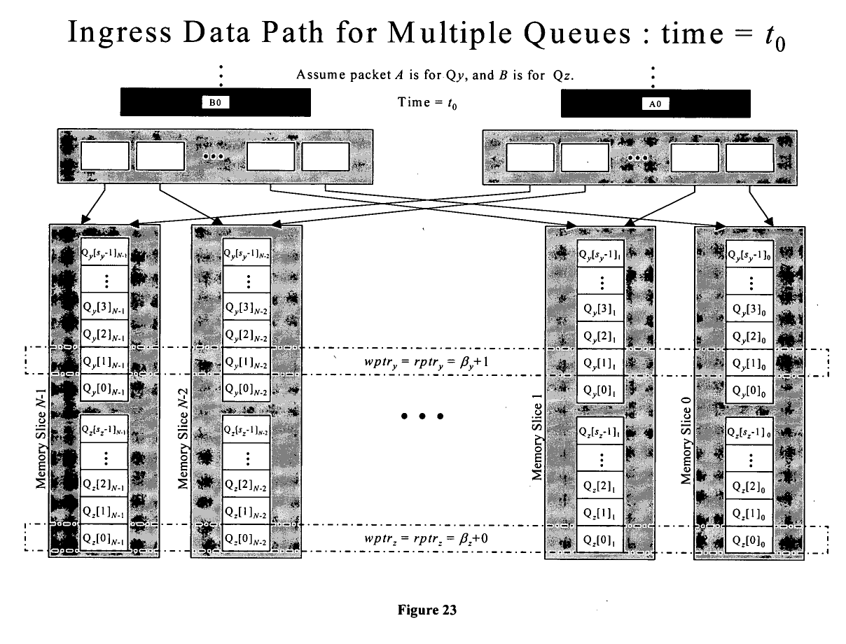

In FIG. 23, the multiple queues of FIG. 22 are shown when the memory is partitioned in accordance with the invention into multiple memory slices. For clarity, the example only shows just two queues; but, in general, each memory slice γ would contain all of the columns γ from each queue in the system. Memory slice 0 contains only columns 0 from all queues; memory slice 1 contains only columns 1 from all queues, and so forth.

FIG. 23 through FIG. 27 demonstrate examples of multiple queues being written with the data at the same time. The two queues in the example, Q_{y} and Q_{z}, are receiving data streams from different input ports—one data stream labeled A, and the second data stream labeled B. For purposes of illustration, let it be assumed that data stream A goes into Q_{y} and data stream B goes into Q_{z}. Each queue has its own distinct base address β_{y} for Q_{y} and β_{z} for Q_{z} and starts with both Q_{y} and Q_{z} empty. To demonstrate that while the read and write pointers for a single queue must be matched across all slices, but the read and write pointers for different queues will be distinct from each other, the read/write pointers for the two queues are shown initialized to different relative offset values. For Q_{y}, the read and write pointer offsets are initialized to 1, and for Q_{z} the read and write pointer offsets are initialized to 0. This demonstrates that the read/write pointers for a queue are synchronized across all slices, but each queue is operating independently of one another.

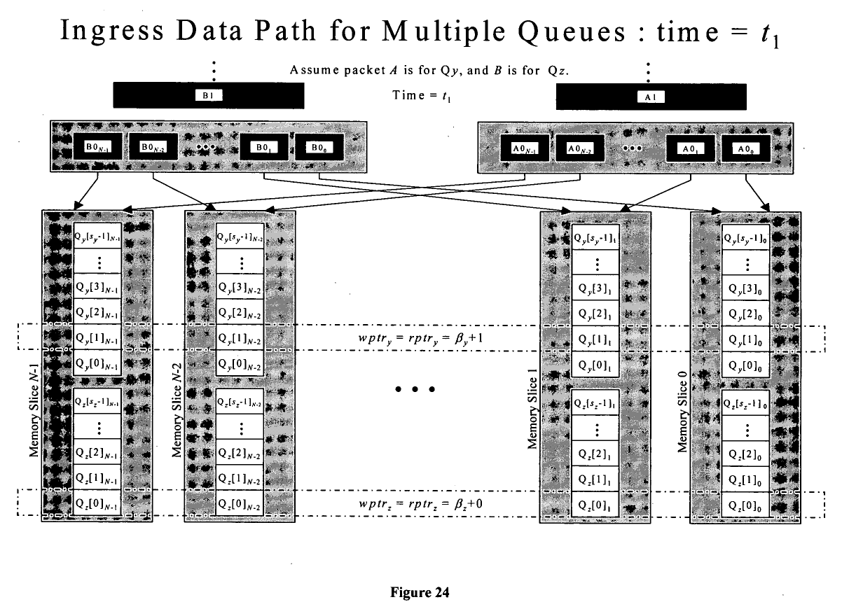

Paralleling the illustrative descriptions of successive FIG. 17 through FIG. 21 for a single queue, FIG. 23 shows the start of this sequence at time t₀, where the first lines of both data streams are ready to enter their respective input ports. In FIG. 24, at time t₁, the first of the data lines (A0 and B0) for the two streams have entered the respective input ports and have been segmented into the data slices. The data lines (A1 and B1) have arrived at the input ports and are ready to enter the pipeline.

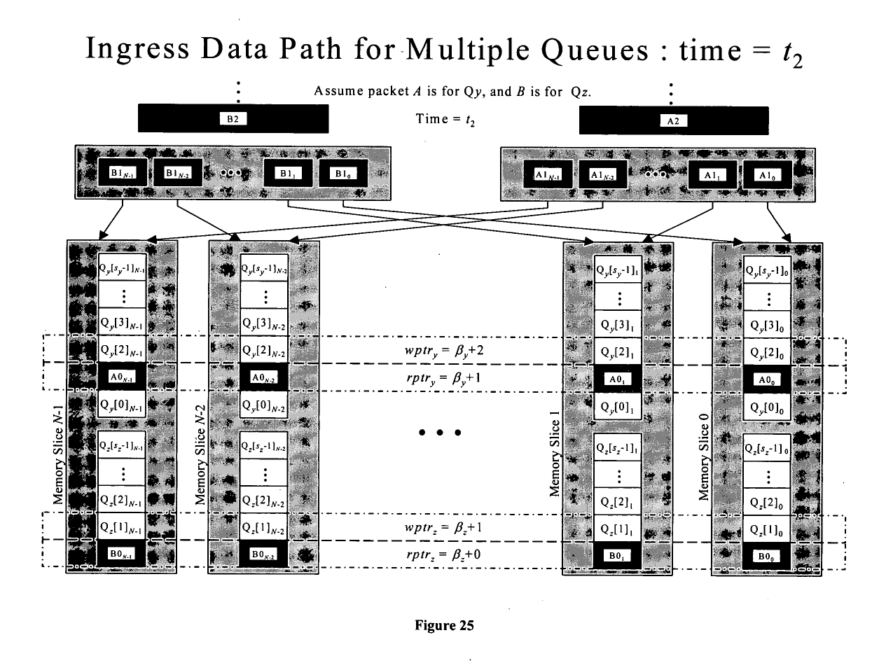

At time t₂, as shown in FIG. 25, the data slices from data lines A0 and B0 have been written into their respective queues. The write pointers for the two queues are then incremented by 1. Just as in the examples of FIG. 17 through FIG. 21, each write pointer is incremented across all the memory slices in order to maintain the unified view of each queue.

In these examples, two data slices, one for Q_{y} and one for Q_{z} are shown being written into each memory slice during one time period that equals t_{Δ}. Irrespective of how long t_{Δ} is in terms of clock cycles, the implementation of the memory slices and the memory controllers within those slices must be able to absorb the number of data slices that will be written during one t_{Δ} interval. In the case of N input ports, each memory slice will have to be able to write N data slices, one for each input port, into memory during each time interval t_{Δ}. For the examples in FIG. 23 through FIG. 27, it is assumed that the memory slices are implemented so that they can write all the data slices during one t_{Δ} interval.

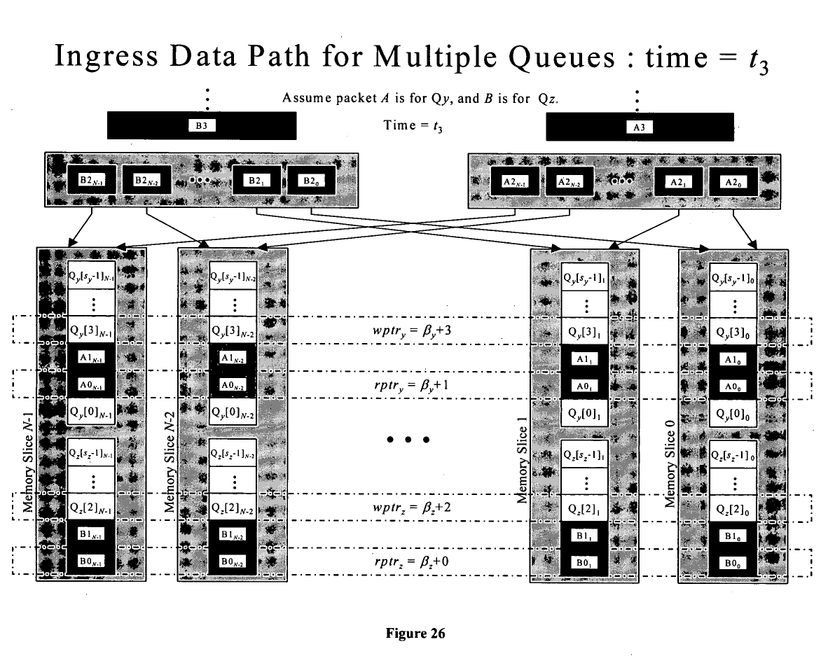

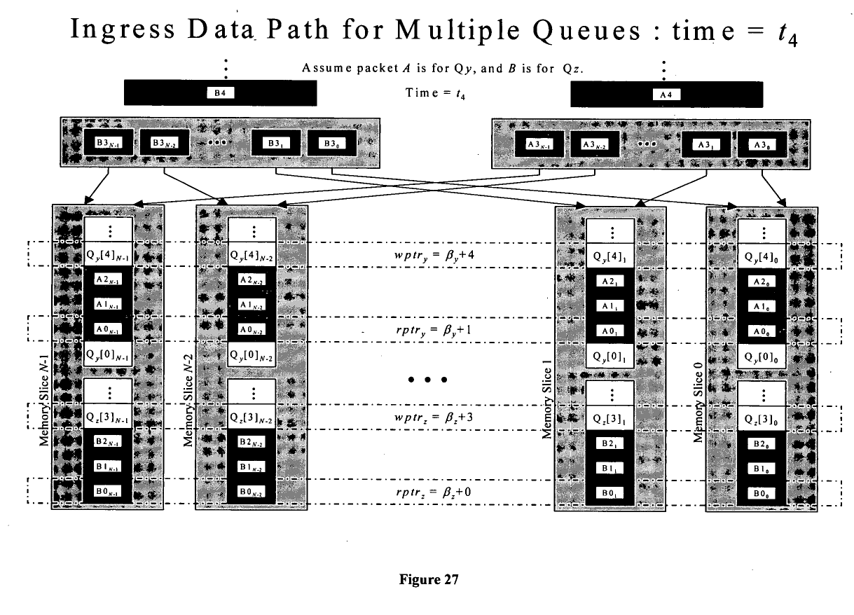

FIG. 26 and FIG. 27 represent the respective multiple queue example sequences for times t₃ and t₄. They show the data lines advancing through the pipeline, with new data lines coming into the input ports. With each write operation, as before, the write pointers are incremented.

### Egress Data Handling

Thus far, only the ingress side of the system of the invention has been described. It is now an order to address the egress side in detail.

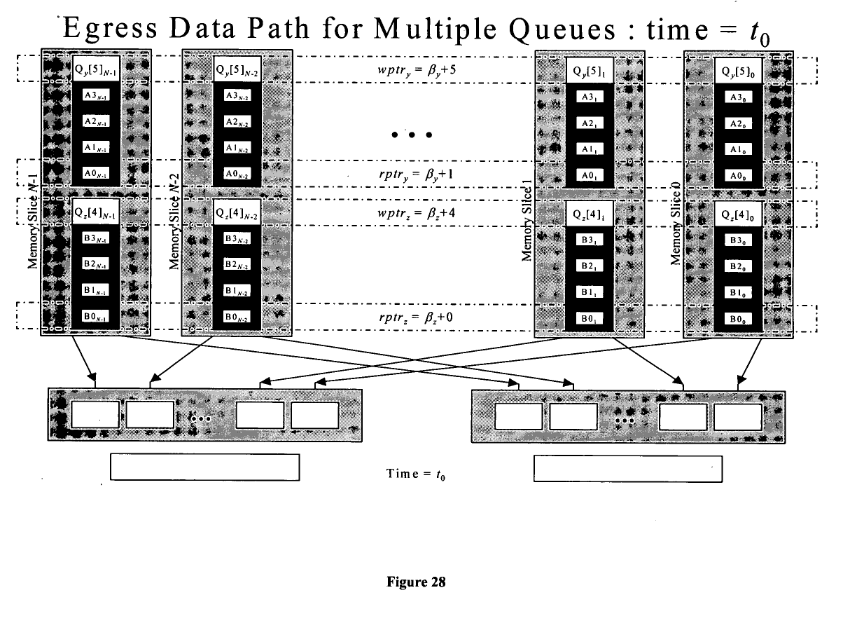

The sequences depicted in FIG. 28 through FIG. 32 exemplarily demonstrate the egress data path involved in multiple queues. The example shows the data from the two queues Q_{y} and Q_{z} being read out over time t₀ through time t₄. For the previously described ingress path example with multiple queues (FIG. 23 through FIG. 27), each memory slice was able to write up to N data slices during each t_{Δ} interval. Similarly for the egress path, each memory slice must be able to read up to N data slices, one for each output port, during each t_{Δ} interval. In this example of the egress data path for the two queues, the end result is shown for each t_{Δ} time interval—two data slices, one for each queue in the example, being read out to their respective output ports.

For time t₀, FIG. 28 shows the initial conditions at the start of the read sequence. Both Q_{y} and Q_{z} have 4 lines of data. Q_{y} has data from offset addresses 1 to 4, while Q_{z} has data from offset addresses 0 to 3. The read and write pointers for the two queues have values that correspond to these conditions.

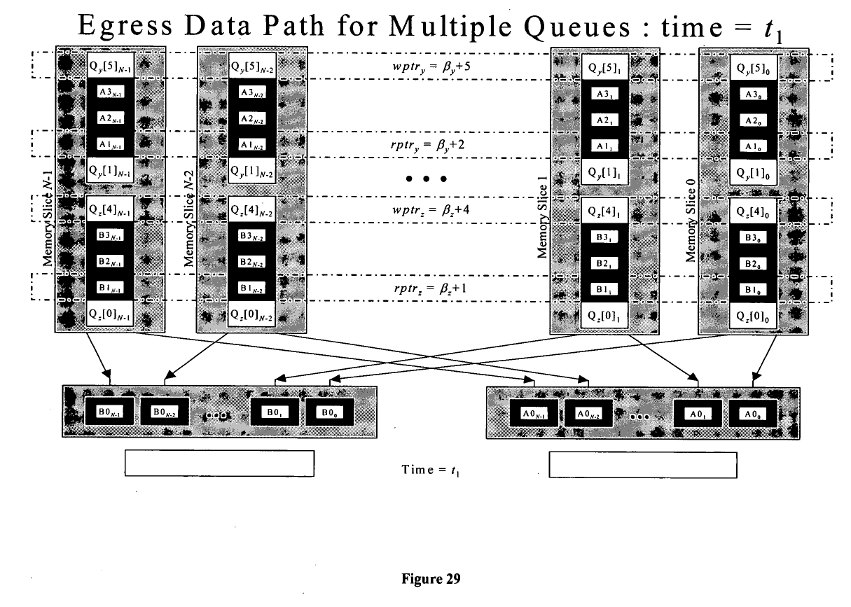

By the end of time t₁, FIG. 29, the data slices A0[0]_{N-1}, . . . , A0[0]₁, A0[0]₀ are read and sent to the egress port that owns Q_{y}, while the data slices B0[0]_{N-1}, . . . , B0[0]₁, B0[0]₀ are read and sent to the egress port that owns Q_{z}. After the read operations, the read pointers are incremented to point the next data slices to be read.

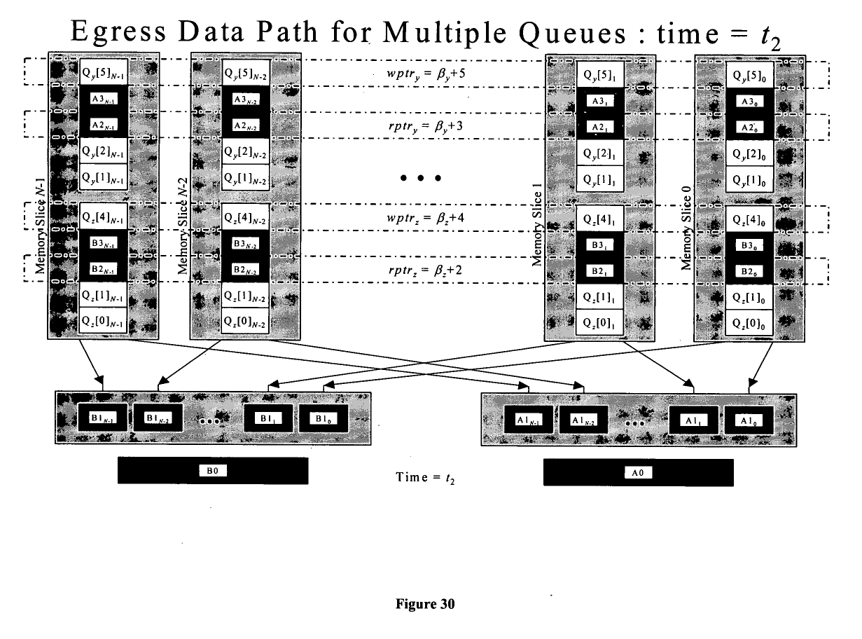

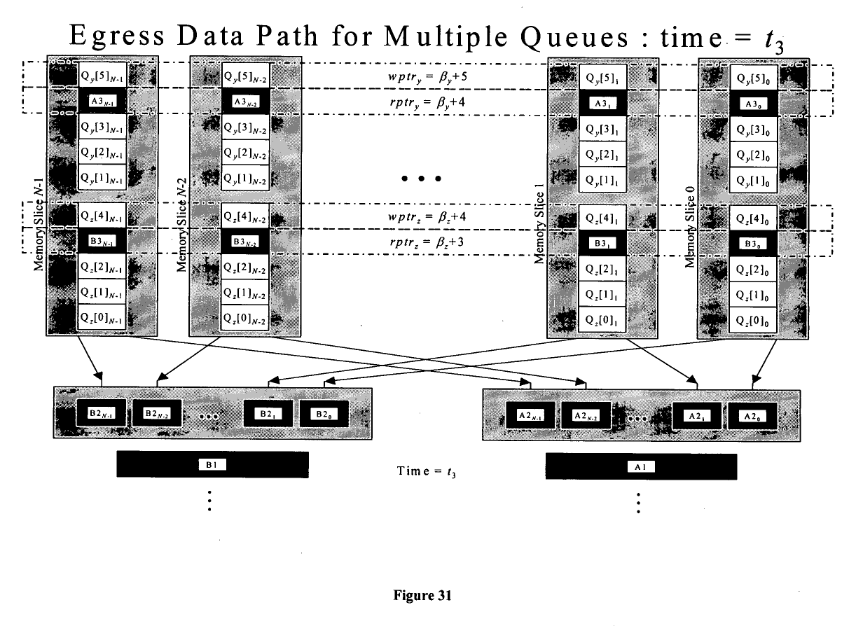

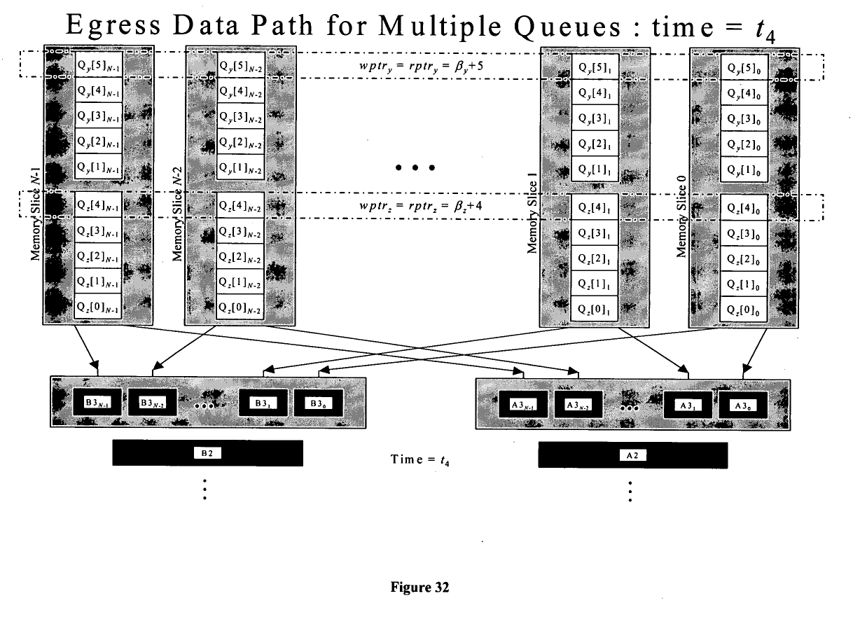

It is again pointed out that a read of a unified queue must involve a read for that queue for every memory slice. This insures that the read pointers for that queue are identical for all memory slices. FIG. 30 through FIG. 32 continue the sequence of reads that started in FIG. 28. The sequences show how the data from the multiple queues are read out of memory such that each output port is supplied with the necessary data to maintain line rate on its output. At time t₂, in FIG. 30, lines A0 and B0 have been sent out by the respective output ports. Each output port has taken the data slices from the N memory slices and reassembled them to form one line of data that is sent out. Similarly at time t₃, in FIG. 31, lines A1 and B1 have been reassembled from N memory slices and sent out by the respective output ports. At time t₄, in FIG. 32, all of the data of both queues has been read out as indicated by the fact that the read and write pointers for each queue are equal. The last lines of data read from the queues (A3 and B3) are shown in the output ports being reassembled to ready them for output.

### Memory Bandwidth and Organization Considerations and Examples

The invention claims a non-blocking write datapath from N ingress ports into M shared memory slices, while also providing a non-blocking read datapath from M shared memory slices to N egress ports for all possible traffic scenarios. The invention provides a write datapath that is non-blocking regardless of the incoming traffic rate and destination, and the read datapath is non-blocking regardless of the traffic dequeue rates. Therefore the invention provides a guaranteed nominal or close-to-0 latency on the write path into the shared memory, and a read path that can provide any dequeue rate up to L bits/sec per port, and independent of the original incoming packet rate. One skilled in the art understands that if an egress port is not over-subscribed, the invention can naturally only provide up to the incoming packet rate and not more. Thus the invention provides ideal QOS under all traffic scenarios.

To reiterate, the invention eliminates ingress contention between N ingress ports for any single memory bank by segmenting the incoming data packets arriving at each ingress port into lines, and further segmenting each line into data slices, which are written simultaneously across all the memory slices and respective memory banks. This effectively divides the ingress port bandwidth by M, with each ingress port transmitting L/M bits/sec to each memory slice. If all N ports write L/M bits/sec to each memory slice, then the memory bandwidth requirement on each memory slice is L bits/sec. Thus if the bandwidth into the memory bank meets this requirement, the latency into the shared memory will be close-to-0 with minimal delay resulting from data traversing the links and pipeline stages before being written to the corresponding memory bank. The invention, furthermore, eliminates contention between N egress ports by giving each egress port equal read access from each memory slice. Each egress port is guaranteed L/M bits/sec from each memory slice for an aggregate bandwidth of L bits/sec.

These features of the invention allow any traffic profile regardless of rate and destination to be written to the shared memory, with close-to-zero latency, and any queue to be read or dequeued at full line rate regardless of the original incoming rate. This non-blocking ingress and egress datapath architecture, in conjunction with the non-blocking inferred control path, will allow the egress traffic manager to provide ideal QOS.

A critical aspect of the ingress and egress datapath architecture of the invention is the memory organization and bandwidth to support the non-blocking requirements described above. This is especially important when considering the requirement for a high random access rate to a single memory bank due to the small size of a single data slice.

As a frame of reference, to illustrate memory bandwidth and organization possibilities, consider the example of a next generation core router where N=64 ports, M=64 memory slices, C=1 byte data slice, and L=16 Gb/s to support 10 Gb/s physical interfaces. The system must handle the worst-case traffic rate of 40 byte packets arriving every 40 ns on all 64 physical interfaces. In a typical networking application, an in-line network processor on every port adds 24 additional bytes based on the result of a packet header lookup. The most relevant information in the 24 byte result is the destination port, interface and priority or QOS level. This is used to determine the final destination queue of the current packet. The network processor, moreover, performs a store and forward function that can result in occasional ingress datapath bursts. It is widely accepted that the rate going into the switch or shared memory is actually 64 bytes every 32 ns or 16 Gb/s from each ingress port. In this example, each memory slice would require 16 Gb/s of write bandwidth and 16 Gb/s of read bandwidth to handle writing 64 slices and reading 64 slices every 32 ns.

The application described above requires a total of 128 read and write accesses in 32 ns on a single memory slice. This would require a single next generation memory device operating in the Gigahertz range. For example, a memory device with dual 8 bit data buses for simultaneous reads and writes, operating at 1 Gigahertz dual data rate, can achieve 128 accesses in 32 ns or 32 Gbits/sec. Each port transfers data every 1 ns on both the falling and rising edge of the clock for a total of 64 accesses (32 ns/1 ns)×2. Thus the total number of read and write accesses is 128 every 32 ns.

While memory technologies are advancing at a fast pace and 800 MHz memories are available today, this is not, however, a practical solution and relies on memory advancements for scalability. Increasing the memory bandwidth by increasing the data bus width, moreover, does not alleviate the problem because the number of memory accesses required has not changed and is still 128 read and write accesses every 32 ns.

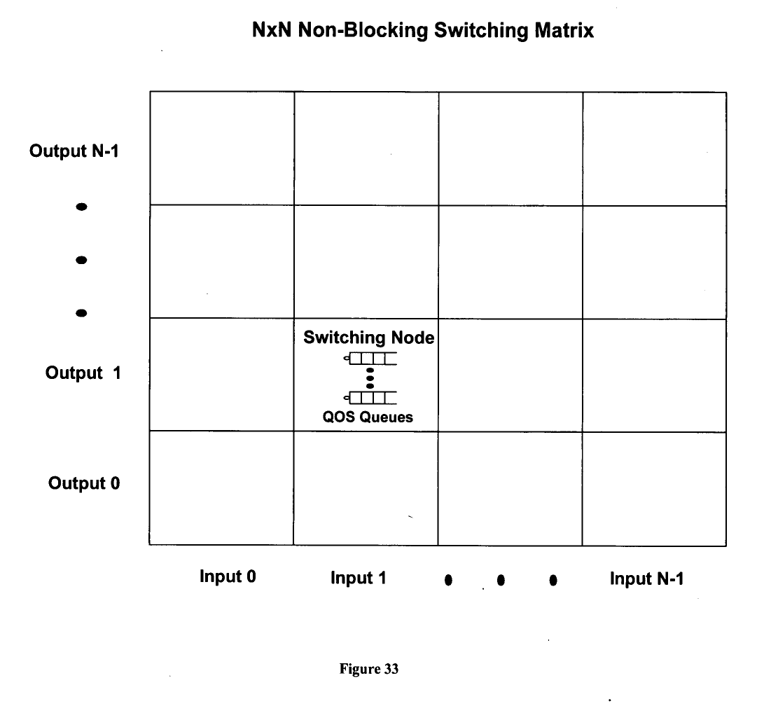

In accordance with the present invention, a novel memory organization and scheme is provided that utilizes commodity memory devices to meet all the non-blocking requirements of the ingress and egress datapath. The novel memory organization of the invention takes advantage of the queue arrangement, where an egress port has a dedicated queue per ingress port per interface per class of service. At an abstract level, each ingress port must be able to write data to any of its dedicated destination queues without contention. Similarly each egress port must be able to read data from any of its egress queues without contention. Thus the memory organization can be illustrated by an N×N matrix of ingress ports and egress ports, where each node represents a memory element that acts as a switch between an ingress and egress port pair. This matrix is possible because a queue is never written by multiple ingress ports and never read by multiple egress ports, as shown in FIG. 33, wherein each intersection of the matrix represents a group of queues that can only be accessed by a single input and output port pair.

In order more fully to describe the memory elements of the invention that will constitute the non-blocking matrix, the following variables must first be defined. The variable T refers to a period of time in units of nano-seconds (ns), required by the application to either transmit or receive a minimum size packet, defined as variable P in units of bits, at a line rate of L bits/sec. The variable J refers to the number of accesses a memory element can perform in time T. The variable D refers to the amount of data in units of bits, that a memory element can read or write within a single access. The variable T is defined as P/L and the bandwidth of a memory element is accordingly defined as (D×J)/T.

Considering the previous networking example of a core router, which has to support a worst-case traffic rate of a minimum 64 byte packet arriving every 32 ns on N ingress ports, and similarly a 64 byte packet departing every 32 ns from N egress ports, each memory element in the N×N matrix must support a single write access and a single read access every 32 ns. The memory element data transfer size per access must be equal to the minimum packet size of 64 bytes or 512 bits. Therefore, based on the above, J=2, D=512 bits and T=32 ns. Thus, the read and write bandwidth of each memory element must be (2×512 bits)/32 ns or 32 Gb/s.

If the N×N matrix illustrated in FIG. 33 is comprised of memory elements that meet these requirements, then the worst-case ingress datapath burst scenario of N ingress ports writing data to a single egress port would be completely non-blocking. Similarly, the worst-case egress datapath scenario of N egress ports reading data from a single ingress port would be completely non-blocking.

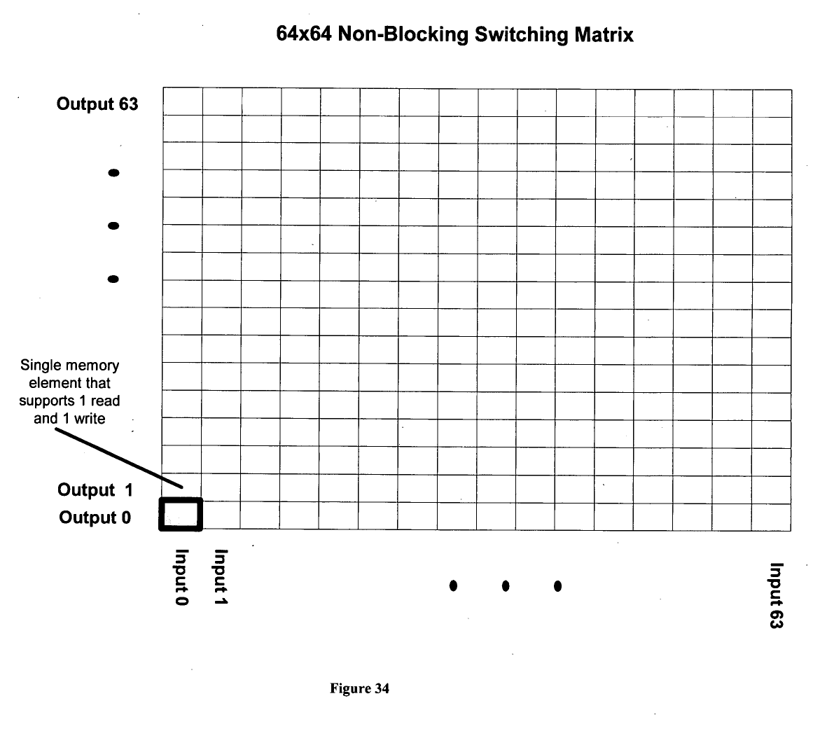

With the before mentioned 64-port core router example utilizing a memory element where J=2, where one read and one write access will be provided every 32 ns, if it be assumed that each memory element can support a data transfer of 64 bytes, a 64-port system requires a 64×64 matrix that would require 4096 memory elements, as in the format of FIG. 34.

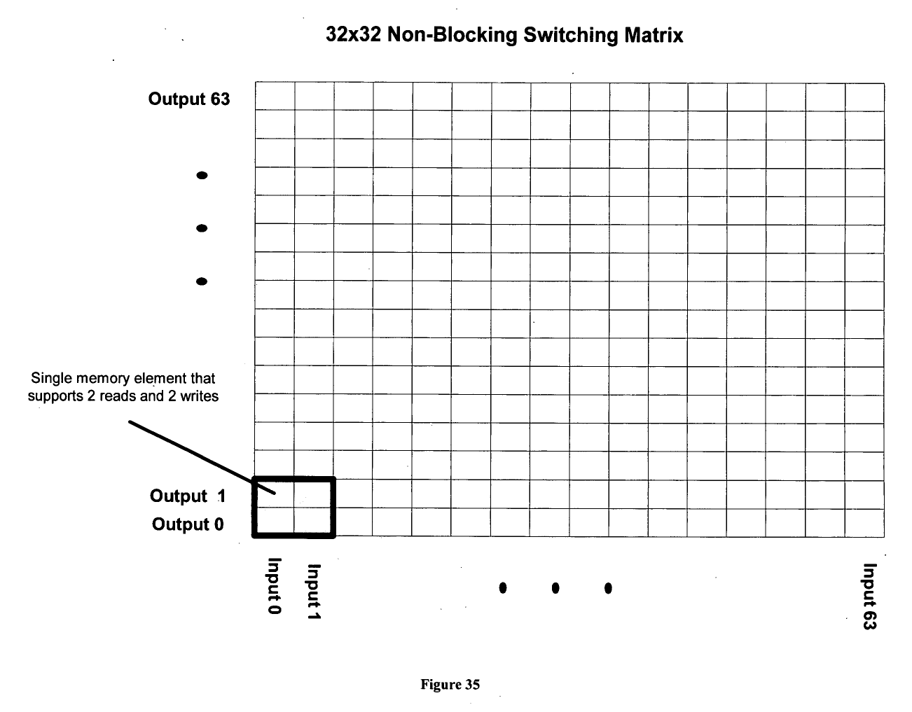

Now considering the before-mentioned 64-port example this time utilizing a memory element where J=4, D=64 bytes and T=32 ns, a single memory element covers a 2×2 region of the 64×64 matrix. In other words, a single memory element can handle two writes from two ingress ports and two reads from two egress ports in a non-blocking manner. This enables reducing the 64×64 matrix to a 32×32 matrix. (N×N)/(J/2×J/2) This implementation of the 64-port system would require 1024 memory elements (FIG. 35).

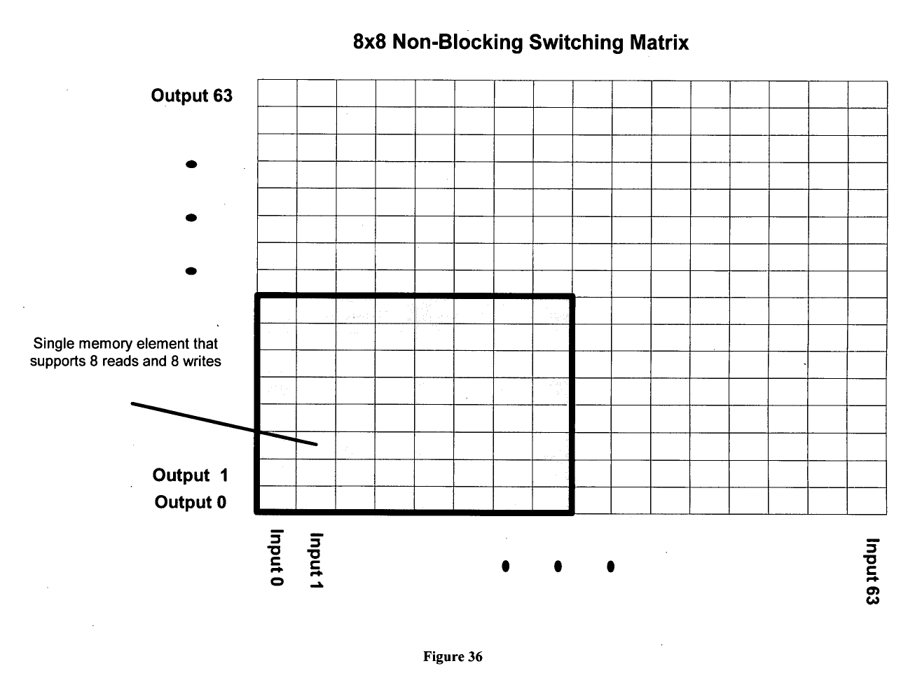

As another example, in the before-mentioned 64-port example utilizing a memory element where J=16, D=64 bytes and T=32 ns, a single memory element will cover an 8×8 region of the 64×64 matrix. In other words, a single memory element can handle eight writes from eight ingress ports and eight reads from eight egress ports in a non-blocking manner, enabling reducing the 64×64 matrix to an 8×8 matrix (N×N)/(J/2×J/2). Such an implementation of the 64-port system would require 64 memory elements (FIG. 36).

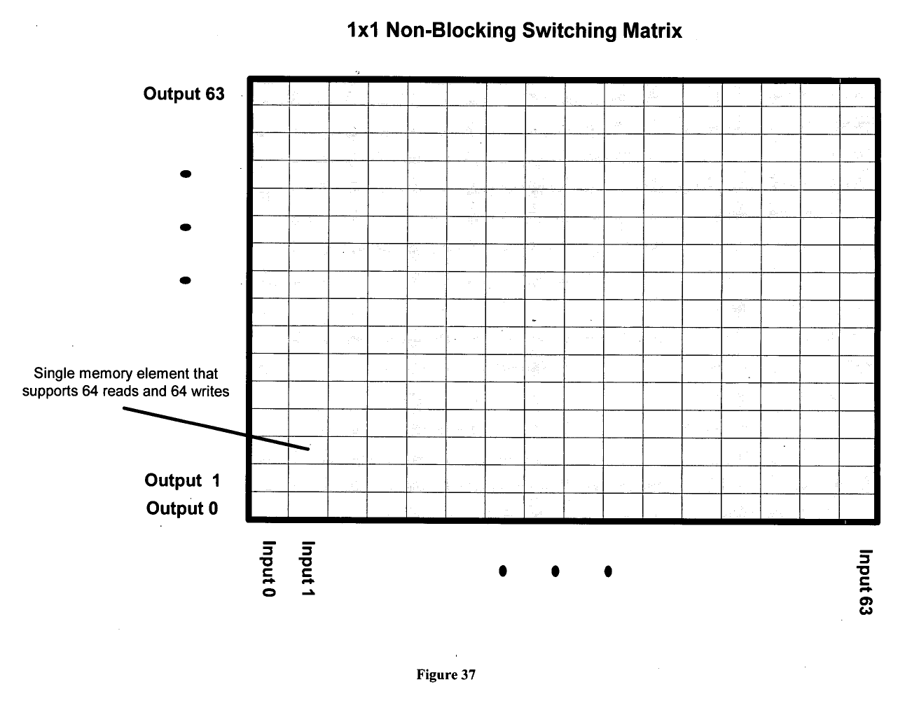

Finally, consider the 64-port example utilizing an ideal memory element where J=128, D=64 bytes and T=32 ns. In this scenario, a single memory element covers the entire 64×64 matrix. In other words, a single memory element can handle 64 writes from 64 ingress ports and 64 reads from 64 egress ports in a non-blocking manner, now reducing the 64×64 matrix to a 1×1 matrix (N×N)/(J/2×J/2)—an implementation of the 64-port system requiring only a single memory element (FIG. 37).

In summary, the more accesses a memory element can provide in T ns, where in this case T=32 ns for a networking application, the further the non-blocking memory matrix can be reduced. The best possible reduction is if a single memory element can support N read and N write accesses in T ns, indeed reducing the matrix to a single memory device, which would require the fewest number of memory elements across a system.

The 64-port core router examples described above assumed that each memory element supported a data transfer size of D bits equal to an application worst-case minimum packet size of P bits every T ns—D=P=64 bytes or 512 bits at a rate of L=16 Gb/s for T=32 ns. If, however, the data transfer size of a single memory element cannot support the worst-case minimum packet size every T ns, then multiple memory elements can be used in parallel. This can be thought of as an array of M memory matrixes, where M is derived from dividing the application worst-case minimum packet size of P bits every T ns by the memory element data transfer size of D bits every T ns. The variable M is defined as P/D and the total number of memory elements required for a system is accordingly defined as ((N×N)/(J/2×J/2))×M.

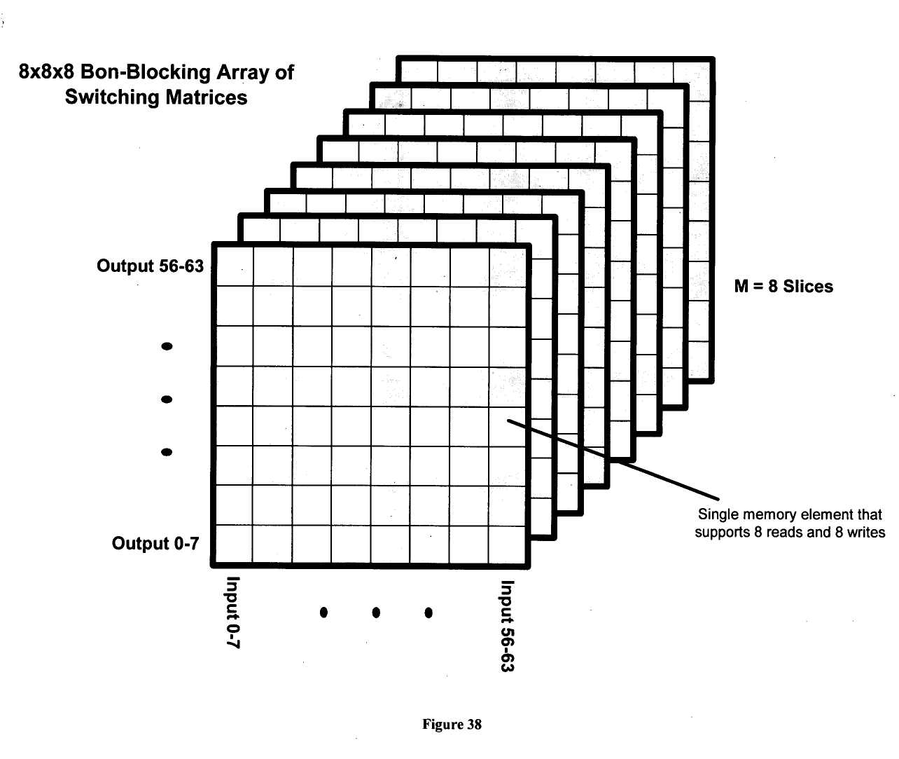

Considering the before-mentioned example of the 64-port router implemented with an 8×8 matrix of memory elements, as previously described, each memory element would then provide 8 writes from 8 ingress ports and 8 reads from 8 egress ports in a non-blocking manner, enabling reducing the 64×64 matrix to an 8×8 matrix (N×N)/(J/2×J/2). For the purpose of illustration, however, now assume that the memory element actual data transfer size is 8 bytes. This implies that the total number of memory elements required to achieve the non-blocking memory is an array of eight 8×8 matrixes for a total of 512 memory elements (FIG. 38). Such a total number of required memory parts, however, will not readily fit onto a single board and therefore must be distributed across multiple boards.

A novel physical system partitioning is to place 64 memory elements on 8 separate boards. Each board will then have an 8×8 matrix of memory elements, where each memory element has an 8 byte interface. This can now be considered a memory slice of the novel shared memory of the invention, where N=64 ingress and egress ports and M=8 memory slices. It may be noted that up until now the number of ports and memory slices have been treated as equal, but this example demonstrates that this is not a requirement for the system. In this example, the natural choice for the size of a data slice is 8 bytes to match the data transfer size of a memory element. An ingress port then writes eight data slices simultaneously to eight memory slices every 32 ns. If all 64 ingress ports are sending data slices simultaneously, a single memory slice will receive 64 8 byte data slices in 32 ns. The illustrated 8×8 matrix of memory elements on a single memory slice will be able to write all the data slices in a non-blocking manner. Similarly, all 64 egress ports can read 64 8 byte data slices in 32 ns from a single memory slice in a non-blocking manner.

It has therefore been demonstrated that in accordance with the present invention, a non-blocking matrix of memory elements can provide the ideal memory organization to guarantee a non-blocking write path from N ingress ports, and a non-blocking read path from N egress ports.

It is now appropriate to discuss, however, the physical limitations in traditional DRAM memory devices that has led to the novel structure of the invention, a fast-random access memory structure comprised of novel combinations of commodity SRAM and DRAM memory devices that can, however, now meet the requirements of the non-blocking switching matrix described above for all conditions of operation.

### Problems with the Use of Traditional DRAM Memory Technology

Typical switching architectures currently utilize DRAM technology for the main packet buffer memory and thus DRAM limitations are an important consideration for use in implementing the present invention. A DRAM is comprised of internal memory banks, where each memory bank is partitioned into rows and columns. The fundamental problem with DRAM technology, however, is achieving any reasonable number of read and writes accesses due to the limitations of the memory row activation and pre-charge requirements. DRAM technology requires a row within a bank to be activated by sense amps, which reads, stores and writes data across an entire row of the corresponding memory bank of memory cells, where each memory cell can store a charge of a “1” or a “0”. After the activation period, the row of data is stored in the corresponding sense amp, which allows a burst of columns to be read or written at a high back-to-back rate, dependent on the operating frequency. In current technology, a 20 ns activation time is considered very fast. The sense amp must then pre-charge the data back into the corresponding DRAM bank. This implies that a typical DRAM accessing data from two different rows in the same bank is limited to two random accesses every 40 ns, due to the before-mentioned row activation and pre-charge time. A typical networking application, furthermore, requires 1 write and 1 read every 40 ns. Standard DRAM vendors, accordingly, offer devices with multiple banks to mask the activation and pre-charge time. So long as a system accesses the banks in a sequential manner, the DRAM appears to read and write data at a fast back-to-back rate. This typical characteristic of a DRAM forces networking architectures to write data across the banks to achieve high bandwidth, resulting in many restrictions to the overall system architecture.

As an illustration, if a queue is striped across the internal banks to meet bandwidth requirements, then the “pathological” case discussed earlier in connection with prior-art can arise, where all ingress ports try to access the same bank continually and therefore oversubscribe the bank, requiring a burst-absorbing FIFO that is sized to accommodate a cell from every port for every queue in the system. Since each internal memory bank requires an external FIFO to handle the burst, as the number of queues grows, the burst-absorbing FIFOs have to scale accordingly. In addition, even if the burst FIFOs were implementable, the latency variation between an empty FIFO and a full FIFO directly adds jitter to the output line. This masking of the DRAM internal pre-charge and activation time can introduce significant restriction ramifications in the overall system architecture and performance.

The pre-charge and activation requirements of DRAM technology do not, however, exist in SRAM technology which allows high rates of read and write accesses to random addresses within a single bank. While this is ideal for switching applications from a memory access perspective, SRAMs, however, have orders of magnitude less memory than DRAMs and unfortunately are therefore not well suited for the storage requirements of a packet buffer memory for networking and other applications.

### Novel 2-Element Memory Stage of the Invention

The requirements of the present invention, accordingly, have now given rise to the creation of a novel 2-element memory structure that utilizes a novel combination of both high-speed commodity SRAMs with their back-to-back random read and write access capability, together with the storage capability of commodity DRAMs, implementing a memory matrix suited to the purposes of the invention. This novel 2-element memory structure resides on each memory slice and has an aggregate read and write bandwidth of 2×L bits/sec per memory slice, providing the number of ports and memory slices is equal. If, on the other hand, the implementation choice is for half the number of memory slices compared to the number of ports, than the aggregate read and write bandwidth would naturally be 2×2×L bits/sec per memory slice, and so forth.

The SRAM-based element provides the fast random access capability required to implement the before mentioned non-blocking matrix, while the DRAM-based element provides the queue depth required to absorb data during times of traffic bursts or over-subscription.

The SRAM-based element may be implemented, in practice, with, for example, a 500 MHz QDR SRAM (quad data rate SRAM) with 32 accesses every 32 ns, divided into 16 read and 16 write operations. The DRAM-based element may, in practice, be implemented with a 500 MHz RLDRAM (reduced latency DRAM) with 16 accesses every 32 ns, divided into 8 read and 8 write operations. The RLDRAM, however, does not have fast random access capability, thus the 16 accesses every 32 ns may only be achieved by utilizing eight internal memory banks, such that each internal bank is accessed with 1 read and 1 write operation every 32 ns. Multiple read or write operations to the same internal bank within 32 ns are not permitted because of the before-mentioned problem of the slow DRAM row activation time.

Considering a system comprised of 8 ports and 8 memory slices, (M=N), an RLDRAM may provide 8 byte transfers per memory access for an aggregate read and write memory bandwidth of 2×8×64 bits every 32 ns or 32 Gb/s. One may erroneously assume a single RLDRAM per memory slice has sufficient bandwidth to support 8 ingress ports and 8 egress ports, reading and writing 8 data slices every 32 ns. To achieve this rate, however, is not possible because of the required random access of the read and write operations. As before mentioned, the ingress port contention may be eliminated but at the expense of egress port contention. If each of the 8 ingress ports, for example, is dedicated to each of the RLDRAM internal banks, then input contention is completely eliminated. If 8 egress ports, however, try to read queues from the same ingress port, only 1 port can access an internal bank in 32 ns; thus a bank conflict arises.

Another approach is to have each ingress port stripe data slices across the internal banks of the RLDRAM. This scheme allows a single egress port to read 8 data slices in 32 ns, which keeps the corresponding output port busy for 8×32 ns, thus allowing the 7 remaining egress ports read access to the memory. The problem of bank conflict arises when multiple ingress ports attempt to write data to the same internal bank of the RLDRAM. This condition may persist, furthermore, for the pathological case where all write pointers for all queues are pointing to the same internal memory bank, thus requiring resorting to external burst absorbing FIFOs, as previously described.

The unique combination of SRAM-based and DRAM-based elements in the novel 2-element memory stage of the invention, now, for perhaps the first time provides the ideal memory access characteristics that are absolutely guaranteed never to have any ingress or egress bank conflicts and to provide zero-delay read access by the egress ports and zero-delay write access by the ingress ports.

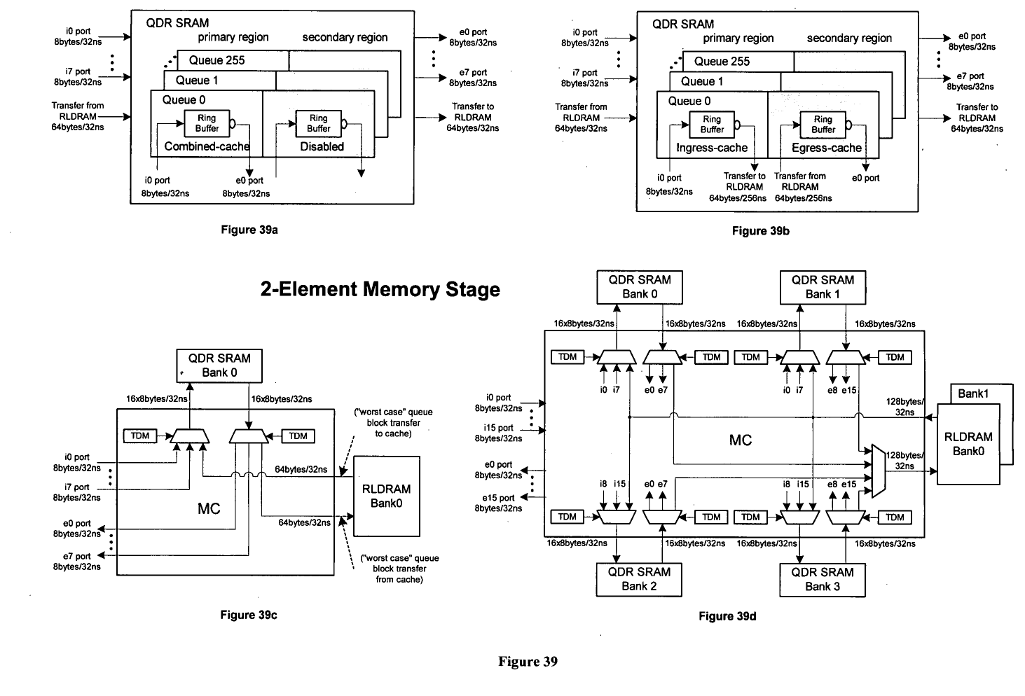

The SRAM-based element of this feature of the invention is comprised of a QDR SRAM that performs as a cache function that is always directly accessed by the connected ingress and egress ports. The ports are therefore not required directly to access the DRAM-element as illustrated in FIG. 39c and d. This implies that the cache always stores the head of each queue for the connected egress ports to read from, and the tail of each queue for the connected ingress ports to which to write. The intermediate data in the body of the queue can be conceptually viewed as stored in the DRAM-element. The random access capability of the SRAM-based cache is guaranteed to meet the ingress and egress ports access requirements of single data slice granularity every 32 ns.

While combining SRAM and DRAM elements has heretofore been suggested, as in an article “Designing Packet Buffers for Router Linecards” by Sundar Iyer et al, published in Stanford University HPNG Tech. Report—TR02-HPNG-031001, Stanford, Calif. March 2002, prior approaches have been incapable of guaranteeing that, for all conditions, the data cache storing the head of the queue cannot run dry of data from the DRAM and starve the output or egress port, deleteriously reducing the line rate; or similarly, cannot guarantee that the data cache holding the tail of the queue can empty data to the DRAM so that the ingress port can continue to write data without premature dropping of the data; and in a manner such that there are no delay penalties for the egress ports reading data or the ingress ports writing data. While the Stanford technical report provides a mathematical analysis and proofs of guarantees, those guarantees are only valid when certain conditions are not violated. The report, however, does not address the cases where the conditions are violated. The Stanford technical report, furthermore, acknowledges the difficulties of implementing a zero-delay solution and proposes an alternate solution that requires a large read or write latency (Section VI of the Stanford HPNG Tech. Report—TR02-HPNG-031001), which cannot be tolerated by a system providing ideal QOS.

While at first blush, as described in the above-cited article, this approach of an SRAM DRAM combination is an attractive direction for trying to attain the performance required by switching applications, it is the novel cache management algorithm and worst case queue detection scheme of the invention, later described, that has now made such a concept work in practice, allowing this 2-element memory stage actually to provide the memory characteristics required for ideal QOS within the context of the whole invention and without the limitations set forth or not addressed, namely under-subscription of a queue, in said Stanford University article.

At this juncture a detailed discussion is in order of the operation of the 2-element memory structure comprised of SRAM and DRAM elements. The QDR SRAM-based element may provide 32 accesses every 32 ns, as mentioned before, divided into 16 reads and 16 write operations, where each data transfer is 8 bytes. Half the read and write bandwidth must be dedicated to RLDRAM transfers. This guarantees that the QDR SRAM bandwidth for the connected ingress ports and egress ports is rate-matched to the transfer rate, to and from the RLDRAM. Thus 8 ingress ports and 8 egress ports may be connected to the QDR SRAM, FIG. 39c, requiring 8 read and 8 write accesses every 32 ns, for an aggregate read and write bandwidth of 2×8×64 bits every 32 ns or 32 Gb/s. Similarly, the aggregate read and write bandwidth for transfers between the QDR SRAM and the RLDRAM is also 2×8×64 bits every 32 ns or 32 Gb/s. This, of course, assumes that a read and write operation to the RLDRAM consists of 8 data slices destined to the 8 internal memory banks every 32 ns. In the schematic diagram of FIG. 39c, the 2-element memory structure of the invention supports 8-ports comprised of a single QDR SRAM and a single RLDRAM device and the connected memory controller (MC).

The QDR SRAM-based cache is illustratively shown partitioned into queues 0 to 255, FIG. 39a and b, that correspond to the queues maintained in the RLDRAM based memory. According to the queuing architecture of the invention, therefore, each egress port has a dedicated queue per ingress port per class of service. In this example of 8 ingress ports and 8 egress ports connected to a single QDR SRAM, the total number of queues is 256 (8×8×4), which corresponds to 256 queues in the connected RLDRAM.

The QDR SRAM-based cache provides the capability for 8 ingress ports and 8 egress ports to each read and write a data slice from any of their corresponding queues every 32 ns. If there is no over-subscription to any queue, the QDR SRAM can meet all the storage requirements without any RLDRAM interaction. If over-subscription occurs, however, then data slices start accumulating in the corresponding queues awaiting transfer to the RLDRAM. The ideal transfer size to and from the RLDRAM, to achieve peak bandwidth efficiency, is 64 bytes comprised of 8 data slices from the same queue. This ideal RLDRAM transfer size of 8 data slices, for this example, is herein termed a “block” of data.

The invention provides a novel cache and memory management algorithm that seamlessly transfers such blocks of data between the SRAM-based cache and the DRAM-based main memory, such that the connected egress and ingress ports are guaranteed read and write accesses respectively to the corresponding queues every 32 ns.

The QDR SRAM-based cache is herein partitioned into two memory regions, designated in FIG. 39a and b, as the primary region and the secondary region. Each queue is assigned two ring buffers, so-labeled, one in each region of memory. A total of 256 queues are required to support the connected 8 ingress ports, shown as “i”, and 8 egress ports, shown as “e”, in the queuing architecture of the invention. There are therefore, a total of 512 ring buffers across both memory regions.

Each queue, moreover, has two possible modes of operation, in accordance with the invention, which are defined as “combined-cache mode”, and “split-cache mode”. When a queue is in the combined-cache mode of FIG. 39a, it operates with a single ring buffer that is written and read by the corresponding ingress and egress ports, labeled “i” and “e” respectively. This mode of operation is termed combined-cache because it emulates an ingress-cache and egress-cache combined into a single ring buffer. FIG. 39a is a logical view of a QDR SRAM illustrating queue 0 in such combined-cache mode, with the second ring buffer disabled. A queue can be viewed conceptually as having a head and a tail, where the egress port reads from the head, and the corresponding ingress port writes to the tail. A queue operating in the combined-cache mode has the head and tail contained within a single ring buffer. If a queue is not oversubscribed, it can thus operate indefinitely in a combined-cache mode, reading data from the head and writing data to the tail.

When a queue is in split-cache mode, it operates with the two ring buffers as shown in FIG. 39b, which is a logical view of the QDR SRAM illustrating queue 0 in the split-cache mode. The first ring buffer functions as an egress-cache, and the second ring buffer operates as an ingress-cache. In the split cache-mode, the egress-cache is read by the corresponding egress port “e”, and written by the MC, FIG. 39c and d, with block transfers from the RLDRAM-based main memory. Similarly, the ingress-cache is written by the corresponding ingress port “i”, and read by the MC for block transfers to the RLDRAM-based main memory. A queue operating in this split-cache mode has the head and tail of the queue stored in the two separate ring buffers. The head is contained in the egress-cache, and the tail is contained in the ingress-cache. The intermediate data in the body of the queue can be conceptually viewed as stored in the RLDRAM-based main memory. This mode is triggered by sustained over-subscription to a queue, thus requiring the storage capability of the RLDRAM-based main memory. A queue can operate indefinitely in the split-cache mode, with the MC transferring blocks of data to the egress-cache to guarantee it doesn't run dry, and transferring blocks of data from the ingress-cache to guarantee it doesn't overflow.

In practice, each ring buffer is comprised of multiple buffers, where a single buffer can store a block of data that is comprised of the exemplary 8 data slices. This implies that a block transfer between the QDR SRAM-based cache, and the RLDRAM-based main memory, will always have the ideal number of data slices and queue association, to achieve the peak RLDRAM bandwidth efficiency of 32 Gb/s. The read and write pointer pairs for the 256 ring buffers in the primary region and 256 ring buffers in the secondary memory region are maintained by the MC in on-chip memory arrays. Note that each queue may utilize its dedicated two ring buffers for either of the cache modes described above.

All memory accesses to the cache are based on a TDM (time-division-multiplexing) algorithm, FIG. 39c and d. The connected 8 ingress ports and 8 egress ports each have a dedicated time slot for access to the corresponding queues every 32 ns. Each connected ingress port “i” can therefore write a data slice every 32 ns, and each connected egress port “e” can read a data slice every 32 ns. Similarly, block transfers that occur in split-cache mode operation, between the QDR SRAM-based cache and the RLDRAM-based main memory, are based on such a TDM algorithm between ports. The worst case queue for each ingress port—i.e. the corresponding ingress-cache with the largest accumulation of data slices greater than a block size—is guaranteed a 32 ns time slot for a block transfer to the RLDRAM every 8×32 ns or 256 ns. Similarly, each egress port worst case queue—i.e. the corresponding egress-cache with the smallest number of data slices and at least one buffer available to receive a transfer—is guaranteed a 32 ns time slot for block transfers from the RLDRAM every 8×32 ns or 256 ns. At this juncture a detailed description of the cache operation is in order.

### Cache Memory Space Operation

At system startup, all queues are initialized to function as a combined-cache. Each queue enables a single ring buffer that may be directly accessed by the corresponding ingress and egress ports. Each queue, as described before, is assigned two ring buffers in the primary and secondary memory regions. The choice is arbitrary as to which of the two ring buffers per queue is enabled, but for purpose of illustration, assume the ring buffers in the primary region are all active. The combined-cache mode implies that there are no block transfers between the QDR SRAM-based cache and the RLDRAM-based main memory. In fact, block transfers are disabled in this mode because the head and tail of a queue are contained within a single ring buffer. The connected 8 egress ports and 8 ingress ports read and write 8 data slices, respectively, every 32 ns. A queue can operate indefinitely in the combined-cache mode of FIG. 39a so long as the enabled ring buffer does not fill up. Some bursts or over-subscription, therefore, may be tolerated up to the storage capacity of the primary ring buffer.

The scenario of an oversubscribed queue resulting in the primary ring buffer filling up is handled by changing the mode of the affected queue from the combined-cache to the split-cache function. The split-cache mode enables the second ring buffer, FIG. 39b, and allows the corresponding ingress port “i” to write the next incoming data slice directly to it in a seamless manner. The primary ring-buffer is now defined as an egress-cache, and the secondary ring-buffer is defined as an ingress-cache. This implies that the egress-cache is storing the head of the queue, while the ingress-cache is storing the tail of the queue. The act of transitioning from a combined-cache mode of FIG. 39a to the split-cache mode of FIG. 39b, enables block transfers between the QDR SRAM-based cache and the RLDRAM-based main memory as in FIG. 39c. By definition, at the crossover point, the egress-cache is full, the ingress cache is empty, and the corresponding queue in the RLDRAM-based main memory is empty.

The memory controller (MC) must transfer blocks of data from the ingress-cache to the main memory in order to prevent the corresponding ring buffer from overflowing. Similarly, the MC must transfer blocks of data from the main memory to the egress-cache in order to prevent the corresponding ring buffer from running dry. The blocks of data stored in the RLDRAM-based main memory can be conceptually viewed as the intermediate body of the queue data. A queue in split-cache mode must have its block transfers efficiently moved in and out of the main memory in order to prevent starving the corresponding egress port, and preventing the corresponding ingress port from prematurely dropping data.

The MC, in accordance with the invention, utilizes a TDM algorithm to guarantee fairness between ingress ports competing for block transfers to the main memory for their queues that are in split-cache mode. The ingress block transfer bandwidth, between the QDR SRAM-based cache and the RLDRAM-based main memory, is partitioned into 8 time slots of 32 ns each, where each time slot is assigned to an ingress port. The MC determines for each ingress port, which of their split-cache queues is the worst-case, and performs an ingress block transfer for those queues, in the corresponding TDM time-slots. This implies that each ingress port is guaranteed an ingress block transfer every 8×32 ns or 256 ns. The MC, furthermore, has an ample 256 ns to determine the worst-case queue for each ingress port. The worst-case ingress-cache, as described before, is defined as the ring buffer with the most accumulated data slices, and at least a completed buffer or block of data available for transfer.

Similarly, the MC utilizes a TDM algorithm to guarantee fairness between egress ports competing for block transfers from the main memory for their queues that are in split-cache mode. The egress block transfer bandwidth, between the RLDRAM-based main memory and the QDR SRAM-based cache, is partitioned into 8 time slots of 32 ns each, where each time slot is assigned to an egress port. The MC determines for each egress port, which of their split-cache queues is the worst-case, and performs an egress block transfer for those queues, in the corresponding TDM time-slots. This implies that each egress port is guaranteed an egress block transfer every 8×32 ns or 256 ns. The MC, furthermore, again has 256 ns to determine the worst-case queue for each egress port. The worst-case queue for the egress-cache is defined as the queue with the least number of data slices and at least an empty buffer ready to accept a block transfer.

As before noted, a queue can operate indefinitely in split-cache mode, providing the fill rate is equal to or higher than the drain rate. If the drain rate, however, is higher than the fill rate, which implies the queue is now under-subscribed, the conditions that are necessary to mathematically guarantee that the egress cache never runs dry are violated.

The previously cited Stanford University report of Sundar Iyer et al does not address the issue of under subscription when there is no data in the DRAM, other than state that the ingress cache must write all of its data to the egress cache without going to the DRAM. The direct transfer of data from the ingress cache to the egress cache, however, will potentially cause a large read latency because the egress port must wait until the data is transferred. The physical transfer of data from the ingress cache to the egress cache, furthermore, must compete with all of the ingress and egress port accesses to the caches, as well as DRAM transfers to and from the caches for queues that are oversubscribed.

The present inventions novel cache management scheme obviates the need for data transfers between the ingress and egress caches. Similar to the full condition that triggers the MC to change the operation of a queue from a combined-cache to a split-cache function, an empty or under-subscribed condition for the egress cache triggers the MC to change the operation of a queue back to the combined-cache function. It should be noted that the ingress cache functions do not have any problems with under subscription. There are no cases that violate the conditions necessary for the validity of the mathematical proof that the ingress cache will never prematurely drop data.

A queue operating in split-cache mode, as described earlier, has both ring buffers enabled in the primary and secondary memory regions. In this example, the ring buffer in the primary memory region is operating as the egress-cache, and the ring buffer in the secondary memory region is operating as the ingress-cache. The ingress and egress TDM algorithms transfer blocks of data for the worst-case queues on a per port basis, from the ingress-cache to the main memory, and from the main memory to the egress-cache. If the condition arises where a queue operating in split-cache mode has a drain rate that exceeds the fill rate, the egress port that owns that queue will eventually drain the corresponding egress-cache. This by definition implies the corresponding queue in the RLDRAM-based main memory is also empty. The MC will recognize this empty condition and allow the egress port to continue reading directly from the ingress-cache, of course, assuming data is available. The MC, in fact, has changed the operation of the queue from split-cache mode to combined-cache mode, which implies both corresponding ingress and egress ports can access the queue directly because the head and tail of the queue are contained within a single ring buffer. The corresponding ring buffer in the primary memory region is no longer active and block transfers between the cache and main memory are disabled for this queue.

The present invention guarantees that during the switch over period between split-cache mode and combined-cache mode, the connected ingress and egress ports continue to write and read respectively in a seamless manner without delay penalty. One may erroneously assume that a boundary condition exists during the switch over, where a DRAM transfer may be in progress or just completed, when the egress cache runs dry. This implies that a block of data is in the DRAM and may result in a stall condition as the egress port waits for the data to be retrieved. In this case and all other boundary cases, the block of data in transit to the DRAM or just written to the DRAM must still be in the ingress cache, even though the ingress cache read pointer has moved to the next block. By using a shadow copy of the ingress cache read pointer, and setting the actual read pointer to this value, the data in essence has been restored. The data in the DRAM is now considered stale and the corresponding DRAM pointers are reset. The ingress cache in split-cache mode may now be seamlessly switched to the combined-cache mode without disrupting any egress port read operations or ingress port write operations.

As earlier stated, the queue can operate indefinitely in the combined-cache mode so long as any bursts or over-subscription do not exceed the storage capacity of the single ring buffer. It should be noted that at system startup the ring buffer in the primary memory region operated in combined-cache mode, while now the ring buffer in the secondary memory region is operating in combined-cache mode. If the traffic condition reverts back to the fill rate exceeding the drain rate, the ring buffer in the secondary memory region will eventually fill up. The MC will detect the full condition and change the queues mode of operation from a combined-cache to a split-cache, and allow the ingress port to write the next data slice to the ring buffer in the primary memory region. Therefore, the ring buffer in the secondary memory region is defined as the egress-cache and the ring buffer in the primary memory region is defined as the ingress-cache. At this switchover point, furthermore, block transfers between the cache and main memory are enabled. This scenario also illustrates the primary and secondary ring buffers operating in the opposite mode to the initial split-cache configuration—the primary ring buffer now operating as the egress-cache and the secondary ring buffer operating as the ingress-cache.

This illustrates the dynamic use in the invention of the cache memory space, allowing each queue to independently operate in either combined-cache or split-cache mode, and providing a seamless switchover without interruption of service to the ingress and egress ports.

### “Worst-case” Queue Algorithm Considerations

At this juncture a discussion on the algorithm to determine the worst-case queue is in order. As previously described, the worst-case queue algorithm is utilized by the MC to determine which queues must have block transfers between the cache and main memory, in order to guarantee that an egress-cache never starves the corresponding egress port, and an ingress-cache never prematurely drops data from the corresponding ingress port. The TDM algorithms guarantee that each ingress port has a block transfer every 8×32 ns or 256 ns, and each egress port has a block transfer every 8×32 ns or 256 ns. Each port must use its allocated TDM time-slot to transfer a block of data between the cache and main memory for its absolute worst-case queue. The determination of the worst-case queue must fit into a 256 ns window based on the TDM loop described above, schematically shown in FIG. 39c as “worst case” queue. The MC maintains the cache pointers in small memory arrays of on-chip SRAM arranged based on the total number of accesses required for read modify write operations for the connected ingress and egress ports to generate the write address for a data slice being written to the ingress-cache, with the read address for a data slice being read from the egress-cache. This can actually be implemented as a smaller on-chip version of the non-blocking memory matrix that the invention utilizes for the QDR SRAM-based element of the main packet buffer memory structure. The on-chip matrix should reserve some read bandwidth for the worst-case queue algorithm to scan through all the corresponding queues. This, of course, is partitioned such that an ingress or egress port only needs to scan through its own queues. Each scan operation has 256 ns to complete, as mentioned-before, based on the TDM algorithm that is fair to all ports. This is ample time in current technology to complete the scan operation for a port. The situation may arise, however, that a queue is updated after the corresponding pointers have been scanned. Therefore, the algorithm may not have the worst-case queue. This is easily remedied with a sticky register (not shown) that captures the worst-case queue update over the TDM window. The algorithm compares the worst-case scan result with the sticky register and then selects the worst of the two. This algorithm is guaranteed to find the worst-case queue within each TDM window for each port.

The total storage, furthermore, of the QDR SRAM-based cache is theoretically bound because the bandwidth in and out is matched. Consider a single ingress port writing a data slice every 32 ns to its queues. A TDM loop between block transfers for the same ingress port is 8 time-slots or 8×32 ns or 256 ns. The most number of data slices that can be written to the cache from a single ingress port is 8 data slices every 256 ns. Now consider that every 256 ns the ingress port is granted a block transfer of the worst-case queue from the cache to the main memory. Since a block transfer is 8 data slices, the rate in and out of the cache is perfectly matched over the 256 ns window. Furthermore, if the cache memory is partitioned into reusable resources managed by a link list, then the cache size can be even further optimized.

### Port Scaling Considerations of the 2-Element Memory Stage

While the before-described example of FIG. 39c utilized a single QDR SRAM and single RLDRAM for the 2-element memory for 8 ingress and 8 egress ports, the invention can be scaled easily for more ports.

If a 16-port system is desired, 8 ingress ports must be connected to two QDR SRAMs, where each QDR SRAM supports 8 egress ports as schematically illustrated in FIG. 39d. This guarantees that if all 8 ingress ports write to the same QDR SRAM, the rate in and out of the QDR SRAM is matched to the rate of the connected 8 egress ports.

If a system is to support 16 ports, FIG. 39d, the further 8 ingress ports will also require two QDR SRAMs to support the 16 egress ports. The total QDR SRAMs required for this configuration is four, labeled as the Banks 0, 1, 2 and 3. Since the RLDRAMs must match the aggregate rate of the ports, 16 egress ports “e” and 16 ingress ports “i” can read and write 16 data slices, respectively, every 32 ns. Two RLDRAMs (Bank 0 and 1) are therefore required as shown, because each RLDRAM can read and write 8 data slices, respectively, every 32 ns, and the two RLDRAMs can read and write 16 data slices, respectively, every 32 ns.

This concept can now be scaled further, as to 32 ports, which would require 4 QDR SRAM per 8 ingress ports to support 32 egress ports. Thus a total of 16 QDR SRAMs are required for 32 ingress ports to support 32 egress ports. The aggregate read and write bandwidth for 32 ingress and 32 egress ports is 32 data slices every 32 ns respectively. A total of 4 RLDRAMs are therefore required to read and write 32 data slices, respectively.

Similarly, 64 ports require 8 QDR SRAM per 8 ingress ports to support 64 egress ports. Thus a total of 64 QDR SRAMs are required for 64 ingress ports to support 64 egress ports. The aggregate read and write bandwidth for 64 ingress and 64 egress ports is 64 data slices every 32 ns, respectively, with a total of 8 RLDRAMs being required to read and write 64 data slices, respectively.

### Considerations for Maximum Queue Size Requirement of the SRAM-based Cache of the 2-Element Memory Stage—“Worst Case ” Queue Depth

At this juncture a more detailed analysis of the maximum queue size of the QDR SRAM-based cache is in order.

Consider the ingress SRAM caches for the queues that are written to by a single ingress port. The theoretical upper bound for the maximum queue size is stated in said Stanford University article of Sundar Iyer et al, to be B*(2+ln (Q)), where B is the block size and Q is the number of queues.

The worst-case depth for any queue is reached with the following input traffic from the single ingress port. All queues are initially filled to exactly B−1 slices. The total number of slices used up to this point is Q*(B−1). After the input traffic fills all the queues to this level, assume that a slice is never written to a queue whose depth is less than B−1; i.e. slices are only written to queues such that the resulting depth is greater than or equal to one block. This means that any queue written to from this point will need a transfer in the future. As a matter of fact, with this restriction, there will always be available some queue to transfer.

Once the queues have been initialized to depth of B−1, the arrival rate of slices is B slices in B cycles. The DRAM transfer rate, however, is also B slices in B cycles, which is one block every B cycles. The slice input rate and the slice transfer rate to the DRAM is thus matched. This means that the total number of slices being used across all the ingress queues for the ingress port under consideration is at most Q*(B−1)+B. The +B term is due to the fact that the DRAM transfer is not instantaneous, so at most, B slices may come in until the transfer reads out B slices to the DRAM. This result holds so long as the block transfer is always performed for the queue with the worst-case depth. If more than one queue has the same worst-case depth, one of them can be chosen at random.

If writes to queues result in a depth that is less than B−1 slices, then that only decreases the total number of slices that are used across all queues because the queue that was just written will not cause any future DRAM transfers, thus freeing up the transfer time to make transfers for other queues.

Even though the total number of slices necessary to support the one ingress port does not grow from this time, the maximum depth of some queues will temporarily increase because, in a DRAM transfer, B slices are being transferred from a single queue; but during the B cycles of the DRAM transfer, B slices are provided for B other queues (remembering that the worst case input traffic will not write to a queue that has a DRAM transfer occurring). It takes a finite amount of time for every queue to have at least one transfer. The one queue that gets serviced after every other queue will have had that much time to accumulate the worst-case depth value.

Once every queue has had exactly one transfer, the process is repeated with the current state of the queues by allowing the input traffic to write to all queues again; still following the rule, however, that any queue that has a DRAM transfer no longer receives further input for the duration of this iteration. The end of the iteration is reached when the last remaining queue gets its DRAM transfer. Even though the state of queues at the start of this iteration had a queue with the worst case depth, since the new slice arrival rate is matched by the slice transfer rate to the DRAM, the total number of slices occupying all the ingress caches for this ingress port does not grow. During the iteration, moreover, the worst-case queue(s) are getting their DRAM transfers, thus lowering their depth. At some point, some other queue (or possibly the same queue) will reach the same maximum depth as the previous iteration, and the process can start all over again. This worst-case traffic pattern is indeed the absolute worst case.

### Interconnect Topology and Bandwidth Considerations

The before-mentioned N×N matrix of memory elements assumes that the read and write bandwidth of each element is a single read and single write access every T ns, where T represents an application smallest period of time to transmit or receive data and meet the required line-rate of L bits/sec. For example, IP networking applications for L=16 Gb/s are required to transfer 64 bytes/32 ns, where T=32 ns, as before described.

As also previously described, a physical memory device can support J read and J write accesses of size D bits every T ns, with the total number of physical memory devices required to meet the aggregate ingress and egress access requirement being (N×N)/(J/2×J/2). This does not account, however, for the size of the data access to meet the requirements of the application—the total number of memory banks required for a system being ((N×N)/(J2×J/2))×(L/(D/T))). For a high capacity system, where N and L are large values, the total number of memory banks will most likely not fit onto a single board. The memory organization is accordingly further illustrated in FIG. 38 as an ((N×N)/(J/2×J/2))×M three-dimensional matrix of memory banks, where M is defined as (L/(D/T)), and represents the number of slices of an (N×N)/(J/2×J/2) matrix that are required to maintain line rate of L bits/sec across N ports. The M-axis depicted in FIG. 38 represents the system of the invention partitioned into memory slices, where each memory slice is comprised of (N×N)/(J/2×J/2) matrix of memory banks.

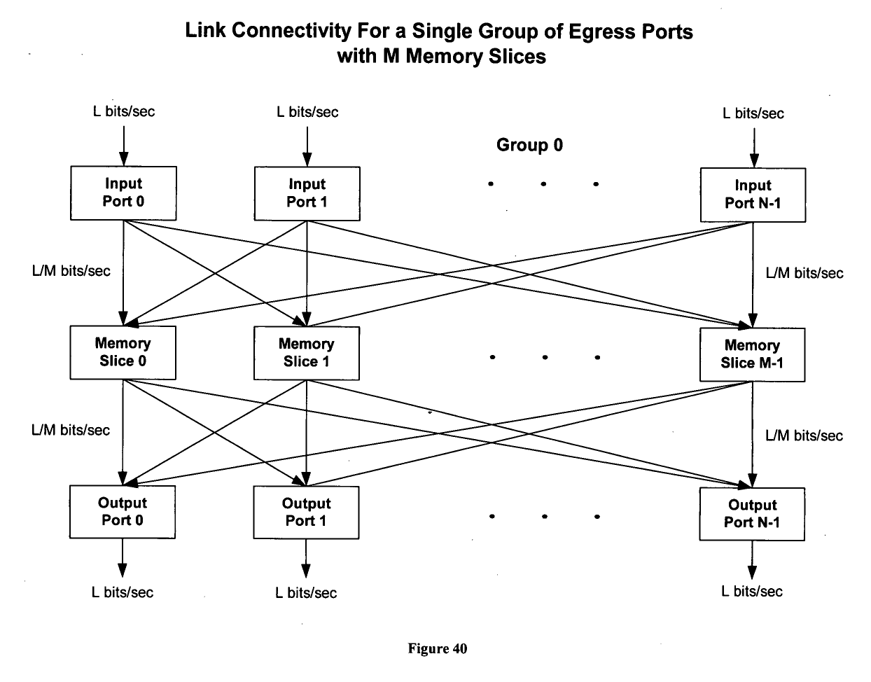

Summarizing, the link topology of the invention assumes that N ingress and egress ports have a link to M memory slices, with a total number of links between the ingress and egress ports and memory slices being 2×N×M—this being the least number of links required by the invention for the above (N×N)/(J/2×J/2) matrix of memory banks on each memory slice. The bandwidth of each link is the line rate L bits/sec divided by the number of memory slices M. FIG. 40 exemplarily shows the connectivity topology between 0 to N−1 input or ingress ports, 0 to N−1 output or egress ports, and 0 to M−1 memory slices for the purpose of reducing the number of physical memory banks on a single memory slice. This is shown illustrated for a single group of ingress ports and egress ports connected to M memory slices.

The (N×N)/(J/2×J/2)×M memory organization of the invention may be optimized to reduce the number of memory banks on a single memory slice by creating a tradeoff of additional links and memory slices. The above equation assumed a system comprised of M memory slices, where each memory slice was implemented with the novel fast-random access memory structure and wherein the SRAM temporary storage satisfied the (N×N)/(J/2×J/2) non-blocking memory matrix requirement. If the implementation of a much larger system is desired and with many more ports, the (N×N)/(J/2×J/2) matrix of SRAM memory banks may not be implementable on a single board. The following optimization technique of the invention will then allow the memory matrix to be significantly reduced though at the cost of additional links.

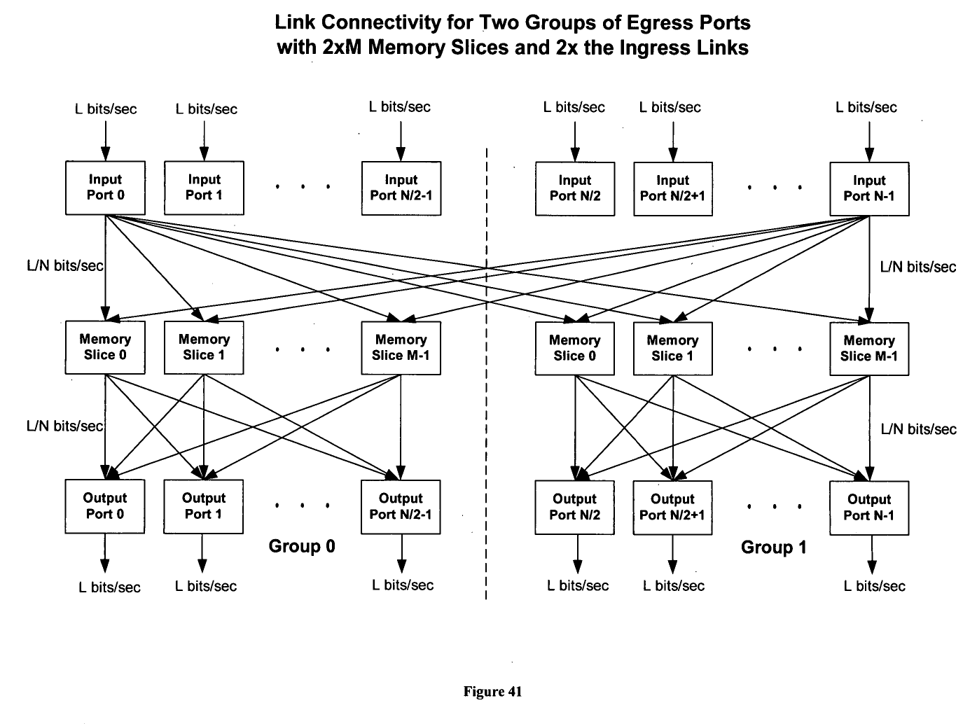

Considering the (N×N)/(J/2×J/2) matrix of FIG. 33, where the x-axis or columns represents N inputs or ingress ports, and the y-axis or rows represents N output or egress ports, the total number of memory banks on a single memory slice is reduced by N for every port removed from the x or y-axis. If, for example, half the egress ports and respective rows are removed, the total number of memory banks on a single memory slice is reduced by 50%. The system then requires double the number of memory slices organized as two groups to achieve the same memory bandwidth,—each group comprised of M memory slices supporting half the egress ports with an ((N×N)/(J/2×J/2))/2 matrix of memory banks on each memory slice. The total number of egress links, however, has not changed, from a single group of M memory slices supporting N egress ports, to two groups of M memory slices each supporting N/2 egress ports. The number of ingress links, on the other hand, has doubled because the x-axis or columns of the matrix of memory banks on each memory slice has not changed. Each ingress port, however, must now be connected to both groups of M memory slices as in the illustration of this link to memory organization in FIG. 41.

As before stated, in FIG. 41, the output or egress ports are shown divided into two groups by doubling the number of memory slices, where half the output ports 0 to N/2−1 are connected to the group 0 memory slices 0 to M−1, and the other half of the output ports N/2 to N−1 are connected to the group 1 memory slices 0 to M−1. This reduces the number of memory banks on each memory slice by half, but doubles the number of links from the input ports, which must now go to both groups of memory slices. The number of links between the memory slices and the output ports, however, has not changed, nor has the total number of required physical memory banks changed for the entire system.

This approach can be also used to further reduce the number of memory banks on a memory slice. For example, four groups of M memory slices reduce the number of memory banks per memory slice to ((N×N)/(J/2×J/2))/4, though at the cost of increasing the ingress links to 4×N×M. Similarly, eight groups of M memory slices can reduce the number of memory banks per memory slice to ((N×N)/(J/2×J/2))/8, again at the cost of increasing the ingress links, this time, to 8×N×M, and so forth. The total number of egress links will remain the same, as the output or egress ports are distributed across the groups of memory slices, and similarly, the total number of memory banks will remain the same, as the memory banks are physically distributed across the groups of memory slices.

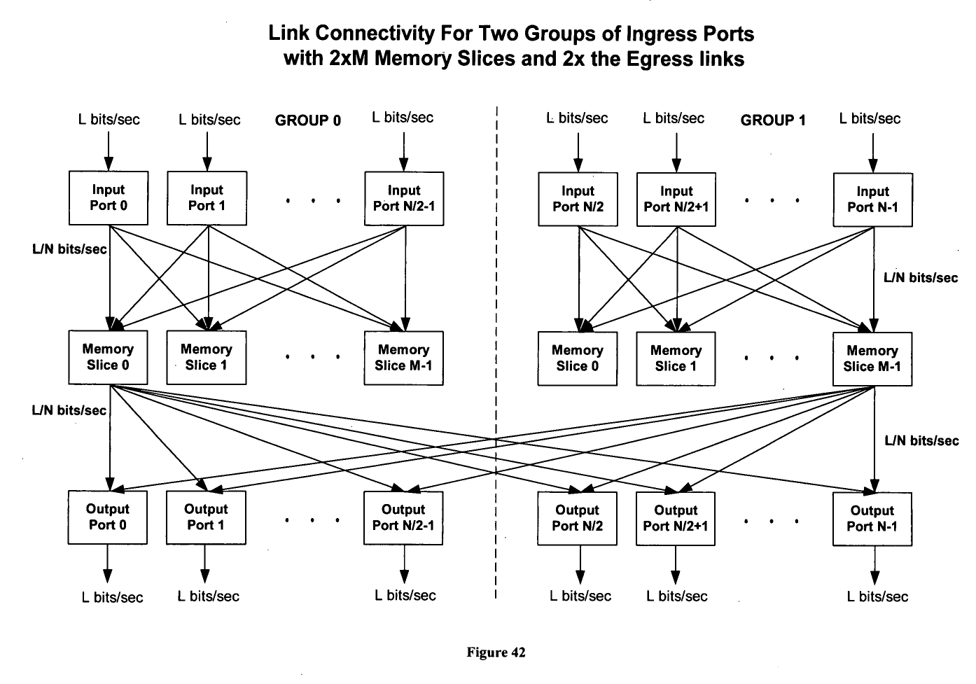

This method of optimization in accordance with the invention can similarly be used to reduce the number of memory banks per memory slice by grouping ingress ports together. In the scenario of a two-group system, as an illustration, half the ingress ports may be connected to a group of M memory slices with the other half of the ingress ports being connected to the second group of M memory slices. The (N×N)/(J/2×J/2) memory matrix reduces by 50% because half the columns of ingress ports are removed from each group. This comes, however, at the expense of doubling the number of egress links which are required to connect each egress port to both groups of M memory slices, as shown in FIG. 42. This optimization can also be used for 4 groups of ingress ports, and for 8 groups of ingress ports, and so forth.

This novel feature of the invention allows a system designer to balance the number of ingress links, egress links and memory banks per memory slice, to achieve a system that is reasonable from “board” real estate, backplane connectivity, and implementation perspectives.

As still another example, the novel memory organization and link topology of the invention can be demonstrated with the before-mentioned example of the 64-port core router, utilizing the readily available QDR SRAM for the fast-random access temporary storage and RLDRAM for the main DRAM-based memory. As previously described, the QDR SRAM memory is capable of 16 reads and 16 writes every 32 ns; however, half the accesses are reserved for RLDRAM transfers. The N×N or 64×64 matrix collapses to an 8×8 matrix with the remaining read and write access capability of the QDR SRAM. To meet the line rate requirement of 64 bytes every 32 ns, eight physical memory banks are required for each memory element. A possible system configuration is M=8 memory slices, with an 8×8 matrix of 64 QDR SRAM with 8 RLDRAM memory banks on each memory slice—the system requiring a total of 512 QDR SRAM and 64 RLDRAM memory banks. Each ingress and egress port requires eight links, one link to each memory slice for a total of N×M or 512 ingress links and 512 egress links.

While this is a reasonable system from a link perspective, the number of QDR SRAM parts per board, however, is high; a designer may still want even further to optimize the system to save board real estate and to reduce the number of memory parts per board. In such event, the before-mentioned link and memory optimization scheme can be employed further to reduce the number of parts per board. As an example, this system can be implemented with two groups of eight memory slices with 32 QDR SRAM and 8 RLDRAM memory banks on each slice, where each group will support 32 egress ports. While the system still has 64 egress ports with 512 egress links, each ingress port must connect to each group, thus requiring an increase from 512 links to 1024 links. The system is then comprised of a total of sixteen memory slices, with 32 QDRSRAM and 8 RLDRAM memory banks on each memory slice; thus the number of memory parts per memory slice has been significantly reduced compared to the before-mentioned 64 QDRSRAM and 8 RLDRAM, though the total number of QDR SRAM memory parts in the system remains the same—512 QDR SRAM memory banks. The total number of RLDRAM parts for the system, however, has increased from 64 to 128, because the number of memory slices has doubled, but the number of parts has not increased per memory slice.

Extending this to the implementation of a 64-port system with 4 groups of egress ports, this requires 4 groups of 8 memory slices, for a total of 32 memory slices with 16 QDRSRAM and 8 RLDRAM memory banks per memory slice. The total number of memory parts in the system is 512 QDR SRAM and 256 RLDRAMs. Each group supports 16 egress ports for a total of 512 egress links. The ingress links again must connect to all 4 groups, thus requiring an increase from 512 links to 2048 links. This configuration of 16 QDR SRAM and 8 RLDRAMs parts per memory slice, however, is a good and preferred option for a system with ample connectivity resources but minimal board real estate.

The before-mentioned memory organization and link topology of the invention thus may remove rows and respective egress ports from the N×N matrix to reduce the number of memory banks per memory slice, while increasing the number of memory slices and ingress links and maintaining the number of egress links. Similarly, columns and respective ingress ports can be removed from the N×N matrix to reduce the number of memory banks per memory slice—this approach increases the number of memory slices and egress links while maintaining the number of ingress links.

### Ingress Data Slice Rotation

At this juncture, a discussion on link bandwidth is appropriate. The ingress N×M mesh and egress N×M mesh until now have been defined as requiring L/M bits/sec per link, with the total number of links being related to the number of groups of ingress ports or egress ports chosen for the purpose of reducing the number of memory parts per memory slice, as before described. A system partitioned into two groups of egress ports, for example, requires two groups of M memory slices and an ingress mesh of 2×N×M, and so forth.

The N×M ingress mesh from N ingress ports to a single group of M memory slices requires L/M bits/sec per link to sustain a data rate of L bits/sec for most general traffic cases. This is because, as previously explained, the invention segments the incoming packets evenly into data slices which are distributed evenly across the M links and corresponding M memory slices, such as the earlier example of a 64-port router, where N=64 ports, M=8 memory slices, C=8 byte data slice, and L=16 Gb/s to support 10 Gb/s physical interfaces. As mentioned before, the system must handle the worst-case traffic rate of 64 byte packets arriving every 32 ns on all 64 physical interfaces. With the technique of the invention, a 64 byte packet is segmented into eight 8 byte data slices and distributed across the 8 ingress links to the corresponding 8 memory slices. Thus, each link is required to carry 8 bytes/32 ns, which is 2 Gb/s. Conforming to the L/M bits/sec formula, 16 Gb/s/8 results in 2 Gb/s per link.

Considering now the case where the incoming packet is 65 bytes, not 64 bytes, in size, while the actual transfer time for a 64 byte packet at L=16 Gb/s is 32 ns ((64 bytes×8)/16 Gb/s), the actual transfer time for a 65 byte packet at L=16 Gb/s is 32.5 ns ((65 bytes×8)/16/Gb/s)—a negligible difference in the transfer time between 65 bytes and 64 bytes.

But consider now the traffic scenario on the ingress N×M mesh if 65 bytes arrive continually back-to-back at L=16 Gb/s. The 65 byte packet is segmented into two lines and each line into respective data slices. The first line is comprised of eight 8 byte data slices spanning M ingress links to M memory slices. The second line is comprised of a single data slice transmitted on the first link, while the remaining 7 links are unused. As described before, in accordance with the invention, dummy-padding slices are actually written to memory to pad out the 2^{nd} line to a line boundary to maintain pointer synchronization across the M memory slices and packet boundaries within the memory.

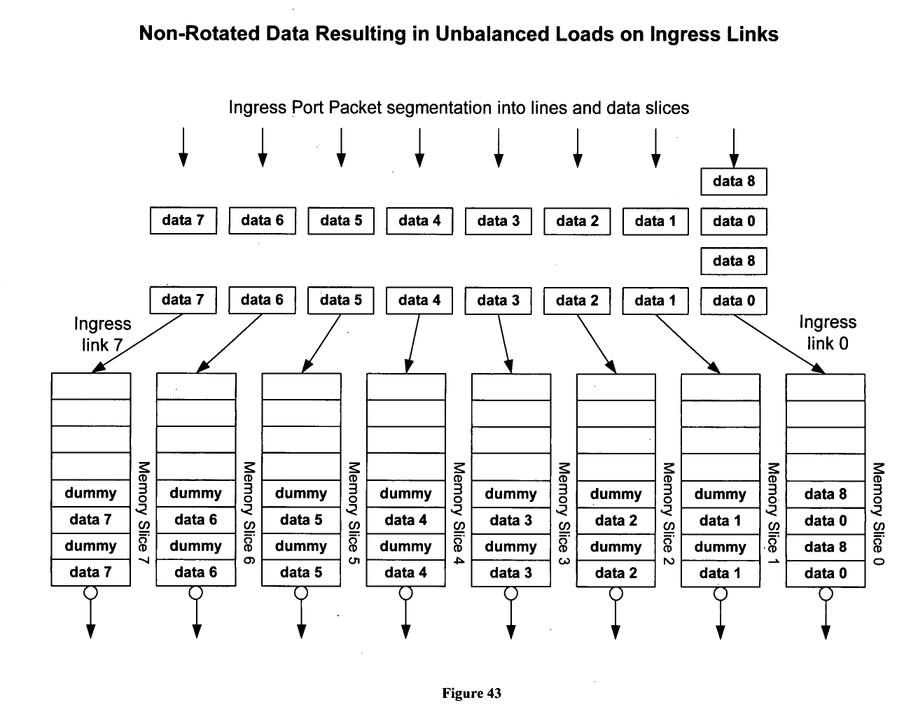

The link bandwidth, however, does not have to be consumed with dummy-padding slices, as will now be explained in connection with the embodiment of FIG. 43. As demonstrated in this figure, every subsequent packet of 65 bytes arrives at L bits/sec and the number of data slices traversing the links is 2× the data slices for a 64 byte packet. As previously explained, though the transfer times between a 64 byte packet and 65 byte packet are approximately the same the 65 byte packet must, however, transmit 2 lines of data due to the 1 extra data slice and 7 dummy-padding slices, for purposes of padding (FIG. 43). Thus, it is logical to conclude that a system would require 2×L/M bits/sec on each link to provide enough bandwidth to transfer 2 data slices every 32 ns. If 2× the link bandwidth is provided on the ingress mesh, then every possible traffic pattern will have sufficient bandwidth to the M memory slices.

Though this solution may be an acceptable one for many system configurations, doubling the ingress bandwidth can add expense, especially if the before-mentioned scheme is employed in which multiple egress port and memory slice groups are used to reduce the per memory slice part count. As before mentioned in the example of a 64-port router with 4 groups of 8 memory slices, the number of memory parts per memory slice can be significantly reduced, but at the expense of 4×N×M ingress links. Having to now double the bandwidth on each of link to cover all traffic scenarios will certainly increase the cost of the backplane.

The invention accordingly provides the following two novel schemes that allow a system to maintain L/M bits/sec on each link and support all possible traffic scenarios.

The first novel scheme, in accordance with the invention, embeds a control bit in the current “real” data slice, indicating to the corresponding MC that it must assume a subsequent dummy-padding slice on the same link to the same queue. The dummy-padding slices are then not required to physically traverse the link to maintain synchronization across the system.

Considering again the previously described 65 byte scenario, the number of data slices traversing the first link is still 2× the link bandwidth, since the subsequent data slice is a “real” data slice, while the remaining 7 links require only 1× the link bandwidth, provided the novel scheme described above is employed. Dummy-padding slices are then not transmitted over the links (FIG. 43).

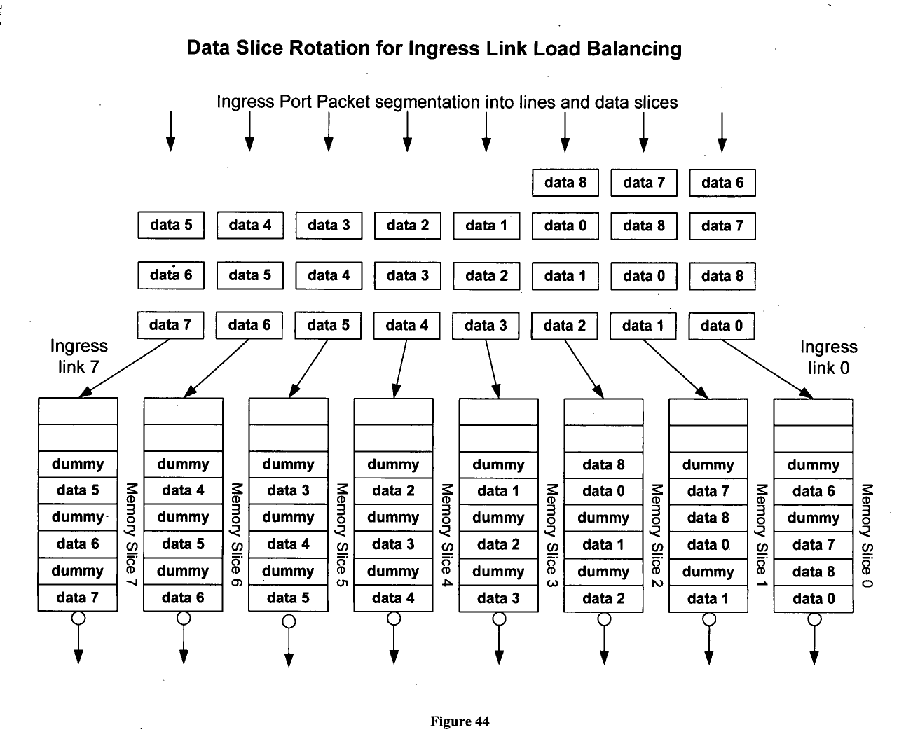

Further in accordance with the invention, a novel rotation scheme has been created that can eliminate the need for 2× the link bandwidth on the ingress N×M mesh. Under this rotation scheme, the first data slice of the current incoming packet is placed on the link adjacent to the link used by the last data slice of the previous packet; thus, no additional link bandwidth is required. In the before-mentioned scenario of 65 byte packets arriving back-to-back at L=16 Gb/s, as an illustration, the 1^{st} data slice of the 2^{nd} packet is placed on the 2^{nd} link and not on the 1^{st} link, as shown in FIG. 44. While the data slices belonging to the same line are still written across the M memory slices at the same physical address, the data slices have been rotated within a line for the purpose of load-balancing the ingress links. A simple control bit embedded with the starting data slice will indicate to the egress logic how to rotate the data slices back to the original order within a line.

As previously shown, the dummy-padding slices are still written by the MC in the shared memory to pad out lines according to the requirement of the invention to maintain synchronization between the memory slices, as shown in FIG. 44. With the use of the above schemes and methods, therefore, the ingress link bandwidth does not have to double to meet the requirements of all packet sizes and traffic profiles.

Lastly, a technique for increasing the line size and utilizing the before-described slice rotation scheme can reduce the bandwidth requirements on the ingress and egress links, and increase the operating window of the memory slice and memory parts. The current processing time for a 64 byte packet is 32 ns at 16 Gb/s. If the line size was increased from 64 bytes to 96 bytes and the link rotation scheme was utilized, an ingress port would take longer to rotate back to the same link, providing it adhered to the requirement of starting on the link adjacent to the link upon which the last data slice of the previous packet was transmitted. In fact, a 16 Gb/s line card reading and writing 64 byte packets every 32 ns actually only transmits a data slice every 48 ns on the same link, because of the increased rotation time due to the 96 byte line. Though this technique adds more memory slices to a system and thus increases expense, it provides the tradeoff of reducing design complexity, utilizing slower parts and saving link bandwidth.

### Physical Addressing Compute Bandwidth and Implementation Considerations

It is now in order to discuss in more detail the physical address computation or lookup bandwidth and implementation considerations in regards to choice of shared memory design. As previously described, each queue is operated in a FIFO-like manner, where a single entry in a queue spans M memory slices and can store a line of data comprised of M×C bits, where C is the size of a single data slice. Incoming packets are segmented into lines and then further segmented into data slices. A partial line is always padded out to a full line with dummy-padding slices. The read and write pointers that control the operation of each queue are located on each memory slice and respective memory controller (MC). Each queue operates as a unified FIFO with a column slice of storage locations on each memory slice, which is independently operated with local read and write pointers. The actual read and write physical addresses are derived directly from the pointers, which provides the relative location or offset within the unified FIFO. A base address is added to the relative address or offset to adjust for the physical location of the queue in the shared memory.

As before mentioned, the pointers are used to generate physical addresses for reading and writing data slices to memory; however, the location of the pointers is purely based on implementation choice, in regards to address lookup rate and memory design.

The pointers, thus far, are assumed to be located on each memory slice and respective MC, which implies multiple copies of the pointers are maintained in the system for a single queue, with one pointer pair per memory slice. This may be considered a distributed pointer approach.

One may assume, though erroneously, that this approach has a high address compute rate or lookup requirement because N data slices are written and read every 32 ns in order to maintain line-rate of L bits/sec, when N=M.

In accordance with the invention, though, the MC does not require knowledge of the physical address until the novel 2-element memory stage of the invention is transferring a block of data from the QDR SRAM to the RLDRAM. Data slices are accordingly written to the fast-random-access element of QDR SRAM at a location based on a minimal queue identifier carried with every data slice. The novel 2-element memory transfers blocks of data between the QDR SRAM and RLDRAM at the RLDRAM rate of 1 block every 32 ns. This is regardless of number of ports, which require more QDR SRAM and RLDRAM with larger block transfer sizes; however, the RLDRAM address lookup rate will always remain 1 every 32 ns for both read and write access. This feature of the invention allows the address generation to reside on the MC and not on N ingress and egress ports, where one skilled in the art, may intuitively, place the function for the purpose of distributing what appears to be an N/32 ns address burst. An additional SRAM or DRAM chip can readily be connected to the MC to store large volumes of address pointers, thus providing significant scalability in terms of number of queues.

The distributed pointers approach has another unique advantage in regard to the design of the 2-element memory stage. Each memory slice is able to operate completely independently of the other memory slices because each memory slice controls a local copy of the read and write pointers. This implies a single queue at times may have different memory slices operating in different cache modes, although still in lock step. This can easily occur by the fact that data slices may have skew to different memory slices due to ingress slice rotation. The local pointers, indeed, allow each memory slice to operate independently, although still in lock step.

It should also be noted that the distributed pointer approach has yet another advantage of not consuming link bandwidth on the ingress and egress N×M meshes.

An alternate approach, as mentioned before, is to locate a single copy of the read and write pointers in the corresponding eTM and iTM, respectively. This implies that physical addresses are required to be transmitted over the ingress N×M mesh to the corresponding memory slices and respective MCs. The address lookup requirement is easy to meet with 1 lookup every 32 ns for both the iTM and eTM; however, the SRAM/DRAM cache design is more complex because the physical address is already predetermined before distribution to the M memory slices. This approach has the implementation advantage of not requiring multiple copies of the same read and write pointer pair across the system.

Furthermore, if a next generation DRAM device has improved access capability, such that the invention memory matrix can be implemented with a reasonable number of parts, then the SRAM component may not be required. If this were the case, the address computation or lookup rate would be N every 32 ns, on each memory slice. Therefore, it would make sense to locate the pointers in the corresponding iTM and eTM and reduce the address compute or lookup rate to 1 every 32 ns, of course, at the expense of additional link bandwidth.

### Preferred Embodiment of a Combined Line Card

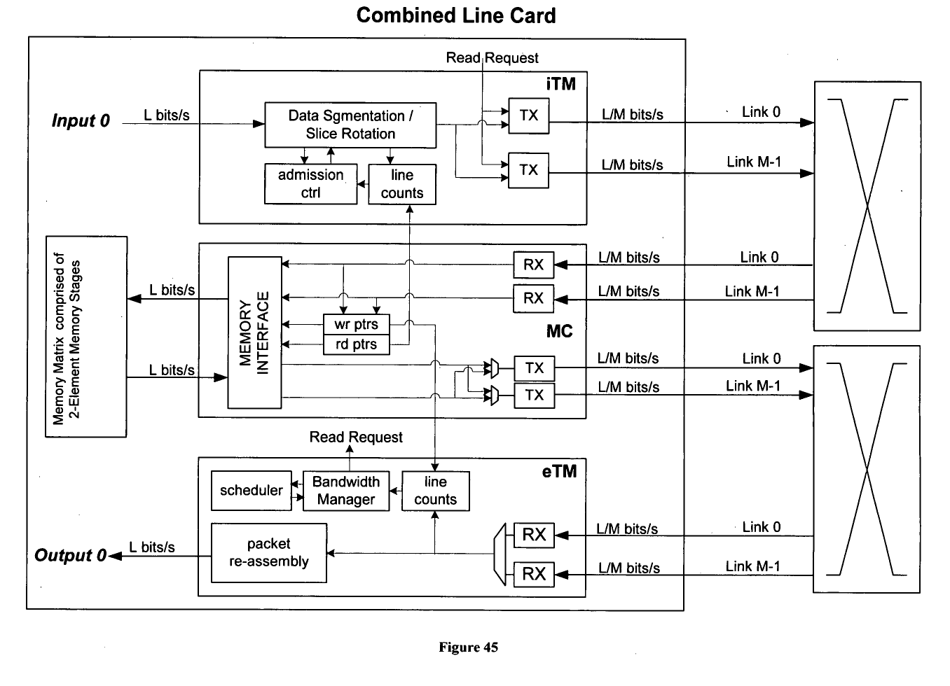

In the previously described preferred combined line card embodiment of the invention, such have been treated as logically partitioned into N ingress ports, N egress ports and M memory slices. This, however, has really been for illustration purposes only since, in fact, the ingress port line and data slice segmentation function, for example, can indeed be combined into the TM, as in FIG. 45. A single line card, therefore, can have

(1) an ingress traffic manager (iTM) function of segmenting the incoming packet and placing the data slices on the ingress N×M mesh;

(2) an MC function to receive the data slices from the ingress mesh and write the data slices accordingly into the respective memory banks; and

(3) an egress traffic manager (eTM) function to read data from the MC and respective memory banks via the egress N×M mesh—all such functions combinable onto a single card.

Again it should be noted that the number of logical ports and memory slices can be different; i.e. N does not have to equal M. In these cases, there may be multiple TMs to a single MC on a single card, or a single TM to multiple MCs on a single card.

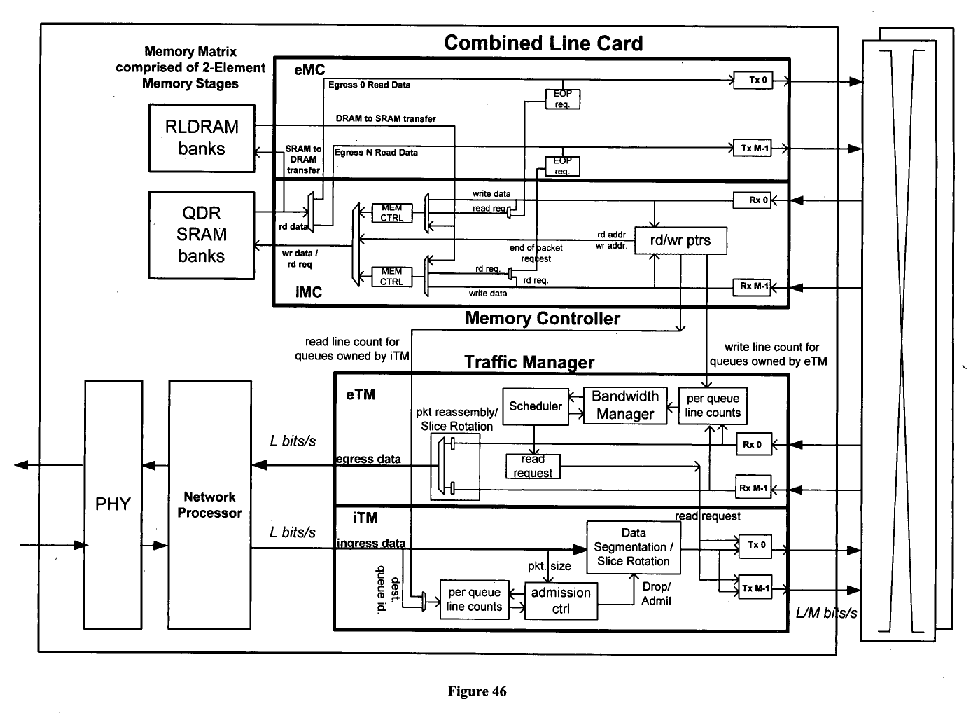

The ingress and egress traffic manager functions can reside in a single chip depending on the implementation requirements. In addition, one skilled in the art understands that an actual networking line card would require a physical interface and network processor, which can also reside on this single combined card, as in FIG. 46, which illustrates a more detailed schematic view of a particular implementation of the MC and TM devices.

### Inferred Control Architecture

It has previously been pointed out that the invention, unlike prior-art systems, does not require a separate control path, central scheduler or compute-intensive enqueuing functions. This is because the invention provides a novel inferred control architecture that eliminates such requirements.

As previously described, prior art shared-memory architectures require a separate control path to send control messages between ingress and egress ports. In the forward direction, each ingress port notifies the destination egress port when a packet is available for dequeuing. Typically, this notification includes the location and size of a packet along with a queue identifier. The location and size of a packet may be indicated with buffer addresses, write pointers and byte counts. In the return direction, each egress port notifies the source ingress port when a packet has been dequeued from shared memory. Typically, this notification indicates the region of memory that is now free and available for writing. This can be indicated with free buffer addresses, read pointers and byte counts.

Prior-art architectures attempting to provide QOS, as also earlier described, require a compute-intensive enqueue function for handling the worst-case scenario when N ingress ports have control messages destined to the same egress port. The traditional definition of enqueuing a packet is the act of completely writing a packet into memory; but this definition is not adequate or sufficient for systems providing QOS. The function of enqueuing must also include updating the egress port and respective egress traffic manager with knowledge of the packet and queue state. If the egress traffic manager does not have this knowledge, it cannot accurately schedule and dequeue packets, resulting in significantly higher latency and jitter, and in some cases loss of throughput.

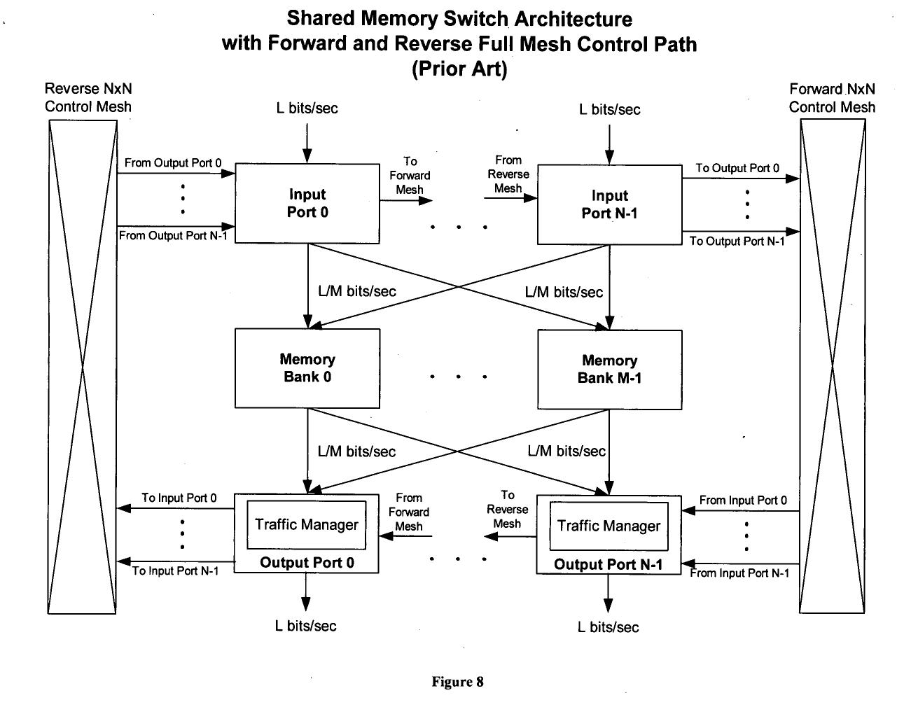

As earlier described in the discussion of prior-art systems, a common approach is to send per packet information to the egress port and respective egress traffic manager via a separate control path comprised of an N×N full mesh connection between input and output ports, with an enqueuing function required on the egress ports, as previously discussed in connection with FIG. 8.

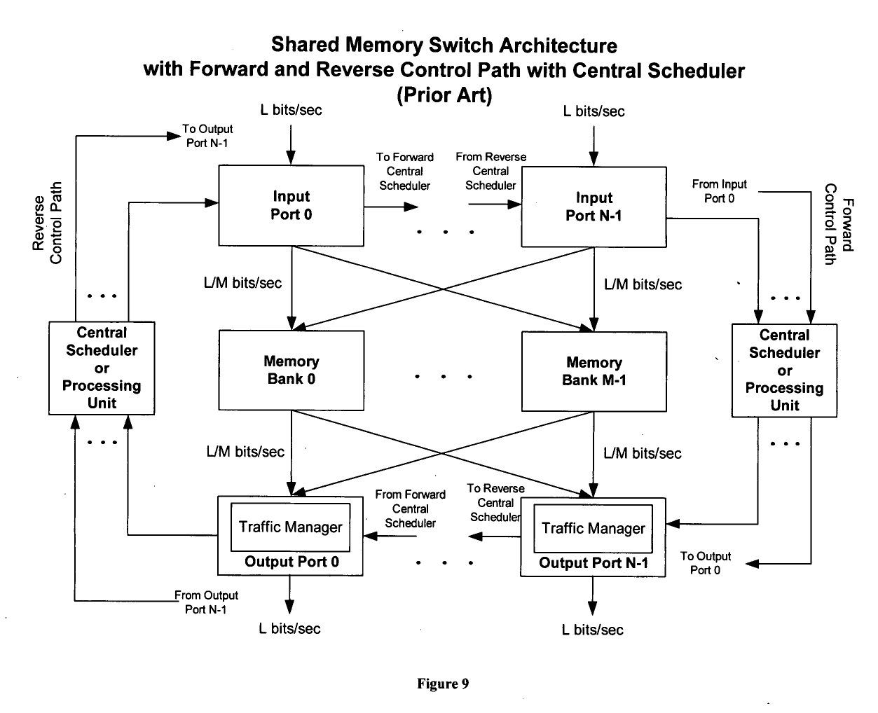

Another earlier-mentioned prior approach is to have a centralized enqueue function that receives per packet information from the ingress ports and processes and reduces the information for the egress traffic manager. This scheme typically requires a 2×N connection between the ingress and egress ports and a central scheduler or processing unit as shown in earlier discussed FIG. 9.

Typical prior-art enqueue functions, as also earlier described, include updating write pointers, sorting addresses into queues, and accumulating per queue byte counts for bandwidth manager functions. If the enqueue function on an egress port cannot keep up with control messages generated at line-rate for minimum size packets from N ports, then QOS will be compromised as before discussed.

Also as before stated, the present invention embodies a novel control architecture that eliminates the need for such separate control planes, centralized schedulers, and compute intense enqueue functions. The novel “inferred control” architecture of the invention, indeed, takes advantage of its physically distributed logically shared memory datapath, which operates in lockstep across the M memory slices.

As previously described, each queue is operated in a FIFO-like manner, where a single entry in a queue spans M memory slices and can store a line of data comprised of M×C bits, where C is the size of a single data slice. Incoming packets are segmented into lines and then further segmented into data slices. A partial line is always padded out to a full line with dummy-padding slices. The data slices are written to the corresponding memory slices, including the dummy-padding slices, guaranteeing the state of a queue is identical across the M memory slices. The control architecture is “inferred” because the read and write pointers of any queue can be derived on any single memory slice without any communication to the other M memory slices as in FIG. 45.

The queuing architecture of the invention requires each egress port and corresponding eTM to own a queue per ingress port per class of service. An eTM owns the read pointers for its queues, while the corresponding iTM owns the write pointers. As described before, the actual read and write pointers are located across the M memory slices in the respective MCs as in FIG. 45.

The eTM infers the read and write pointers for its queues by monitoring the local memory controller for corresponding write operations and its own datapath for read operations. The eTM maintains an accumulated line-count per queue and decrements and increments the corresponding line-count accordingly. An inferred write operation results in incrementing the corresponding accumulated line-count. Similarly, an inferred read operation results in decrementing the corresponding accumulated line-count.

Conceptually, an accumulated line-count can be viewed as the corresponding queues inferred read and write pointer. The accuracy of the inferred write pointer update is within a few clock cycles of when the ingress port writes the line and respective data slices to memory because of the proximity of the eTM to the local MC. The accuracy of the inferred read pointer update is also a few clock cycles because the eTM decrements the corresponding line-count immediately upon deciding to dequeue a certain number of lines from memory. It should be noted, however, that the eTM must monitor the number of read data slices that are returned on its own datapath, because the MC may return more data slices then requested in order to end on a packet boundary. (This will be discussed in more detail later.) The eTM monitoring its own datapath for the inferred read pointer updates and monitoring the local MC for the inferred write pointer updates is shown in FIG. 45.

The incrementing of an accumulated line count based on the corresponding write operation can be viewed as an ideal enqueue function. This novel aspect of the invention eliminates the need for any separate forward control path from N ingress ports to each egress port to convey the size and location of each packet for the purpose of bandwidth management and dequeuing functions.

Similarly, the iTM infers the read and write pointers for its queues by monitoring the local memory controller for corresponding read operations and its own datapath for write operations. The iTM maintains an accumulated line-count per queue and decrements and increments the corresponding line-count accordingly. An inferred write operation results in incrementing the corresponding accumulated line-count. Similarly, an inferred read operation results in decrementing the corresponding accumulated line-count.

The accuracy of the inferred read pointer update is within a few clock cycles of when the egress port reads the line and respective data slices from memory because of the proximity of the iTM to the local MC. The accuracy of the inferred write pointer update is also a few clock cycles because the iTM increments the corresponding line-count immediately upon deciding to admit a packet to a queue, based on the current corresponding accumulated line-count and the available space. The iTM monitoring its own datapath for the inferred write pointer updates and monitoring the local MC for the inferred read pointer updates is shown in FIG. 45.

This further novel aspect of the invention thus eliminates the need for a separate return control path from N egress ports to each ingress port to convey the size and location of each packet read out of the corresponding queues for the purpose of freeing up queue space and making drop decisions.

### Egress Data and Control Architecture Overview

The invention also provides a novel egress datapath architecture that takes advantage of the above-described inferred control and the unique distributed shared memory operating in lock-step across the M memory slices. This contributes to the elimination of the need for a separate control path, a central scheduler and a compute intense enqueue function.

In addition, the read path architecture eliminates the need for a per queue packet storage on each egress port, which significantly reduces system latency and minimizes jitter on the output line. By not requiring a separate control path and per queue packet storage on the egress port, the invention is significantly more scalable in terms of number of ports and queues. The egress traffic manager (eTM) is truly integrated into the egress datapath and takes advantage of the inferred control architecture to provide ideal QOS. The egress datapath is comprised of the following functions: enqueue to the eTM, eTM scheduling and bandwidth-management, read request generation, read datapath, and finally update of the originating ingress port.

### Egress Enqueue Function

The novel distributed enqueue function of the invention takes advantage of the lock-step operation of the memory slices that guarantees that the state of a queue is identical across all M memory slices, as just described in connection with the inferred control description. Each eTM residing on a memory slice monitors the local memory controller for read and write operations to its own queues. Using this information to infer a line has been read or written across M memory slices and respective memory banks, an eTM can infer from the ingress and egress datapath activity on its own memory slice, the state of its own queues across the entire system as in FIG. 46. Thus, no separate control path and no centralized enqueue function are required.

An eTM enqueue function monitors an interface to the local memory controller for queue identifiers representing write operations for queues that it owns. An eTM can count and accumulate the number of write operations to each of its queues, and thus calculate the corresponding per queue line counts as in FIG. 46. The enqueue function or per queue line count is performed in a non-blocking manner with a single on-chip SRAM per ingress port for a total of N on-chip SRAM banks. Each on-chip SRAM bank is dedicated to an ingress port and stores the line counts for the corresponding queues. This distribution of ingress queues across the on-chip SRAM banks guarantees that there is never contention between ingress ports for line count updates to a single SRAM bank. For example, the worst-case enqueue burst, when all N ingress ports write data to a single egress port, is non-blocking because each on-chip SRAM bank operates simultaneously, each updating a line-count from a different ingress port in the minimum packet time.

Consider the case of a 64-port router where 64 byte packets can arrive every 32 ns. If all 64 ingress ports send a 64 byte packet every 32 ns to different egress ports, the enqueue function on each eTM will update the corresponding on-chip SRAM bank every 32 ns. If all 64 ingress ports send a 64 byte packet every 32 ns to the same egress port, the enqueue function on the corresponding eTM will update all 64 on-chip SRAM banks every 32 ns.

The novel non-blocking enqueue function of the invention guarantees an eTM has the latest queue updates as the corresponding data slices are being written into memory, thus allowing an eTM to make extremely accurate dequeuing decisions based on the knowledge of the exact queue occupancy. The lock-step operation of the memory slices guarantees that the state of the queues is the same across all M memory slices, as earlier noted, making it possible for an eTM to infer queue updates from the datapath activity of the local memory slice. This significantly reduces system complexity and improves infrastructure and scalability through completely eliminating the need for a separate control path and centralized enqueue function or scheduler.

### Egress Traffic Manager

An eTM residing on each memory slice provides QOS to its corresponding egress port, by precisely determining when and how much data should be dequeued from each of its queues. The decision to dequeue from a queue is based on a scheduling algorithm and bandwidth management algorithm, and, as previously described, the latest knowledge of the state of the queues owned by the eTM.

An eTM has a bandwidth manager unit and scheduler unit, as in FIG. 45 or FIG. 46, (a more detailed schematic illustration of FIG. 45). The bandwidth manager determines on a per queue basis how much data to place on the output line in a fixed interval of time. This is defined as the dequeue rate from a queue and is based on a user-specified allocation. The scheduler provides industry standard algorithms like strict priority and round robin. The bandwidth manager and the scheduler working together can provide industry standard algorithms like weighted deficit round robin.

An eTM bandwidth manager unit controls the dequeue rate on a per queue basis with an on-chip SRAM-based array of programmed byte count allocations. Each byte count represents the total amount of data in bytes to be dequeued in a fixed period of time from a corresponding queue. The invention provides a novel approach to determine the dequeue rate by making the fixed period of time, the actual time to cycle through all the queues in the on-chip SRAM. The dequeue rate per queue is based on the programmed number of bytes divided by the fixed period of time to cycle through the on-chip SRAM. This novel approach allows the bandwidth manager easily to scale the number of queues. If the number of queues, for example, doubles, then the time to cycle through the on-chip SRAM will double. If all the programmed byte count allocations for each queue are also doubled, then the dequeue rate per queue remains the same, with the added advantage of supporting double the queues.

The bandwidth manager unit, thus, cycles through the byte count allocation on-chip SRAM, determining the dequeue rate per queue. For each queue, the bandwidth manager compares the value read out of the programmed allocation bandwidth array with the value from the corresponding accumulated line count array.

To reiterate, the eTMs non-blocking enqueue function monitors the local MC for inferred read and write line operations to any of its queues. If an inferred read or write line operation is detected the corresponding queues accumulated line count is decremented or incremented respectively, as in FIG. 46.

The smaller of the two values is updated to a third on-chip SRAM-based array defined as the accumulated credit array. This array accumulates per queue-earned credits based on the specified dequeue rate and available data in the queue. Simultaneously, the corresponding queues accumulated line count is decremented by the amount given to the accumulated credit array. It is important to note that the eTM must not double count the inferred read line operations. The number of lines immediately decremented from the accumulated line count will also be monitored on the local MC. This will be discussed later in more detail in the context of the MC reading more lines than requested in order to end on a packet boundary.

If the accumulated line count in terms of bytes is smaller than the programmed allocation, then the absolute difference between the two values is given to a fourth on-chip SRAM defined as the free bandwidth array. In other words, the actual total bytes in the queue did not equal the bytes specified by the byte count allocation on-chip SRAM—the queue did not have enough data to meet the specified dequeue rate. The bandwidth was therefore given to the free bandwidth array and not wasted. The free bandwidth array gives credit based on user-specified priority and weights to other queues that have excess data in the queue because the incoming rate exceeded the dequeue rate.

The bandwidth manager then informs the scheduler that a queue has positive accumulated credit by setting a per queue flag. The positive accumulated credit represents earned credit of a queue based on its dequeue rate and available data in the queue. If the accumulated credit for a queue goes to 0 or negative, the corresponding flag to the scheduler is reset. The scheduler unit is responsible for determining the order that queues are serviced. The scheduler is actually comprised of multi-level schedulers that make parallel independent scheduling decisions for interface selection, for QOS level selection and for selection of queues within a QOS level. The flags from the bandwidth manager allow the scheduler to skip over queues that are empty in order to avoid wasting cycles. As before mentioned, the scheduler can be programmed to service the queues in strict priority or round robin, and when used in conjunction with the bandwidth manager unit, can provide weighted deficit round robin and other industry standard algorithms.

The scheduler then selects a queue for dequeuing and embeds the destination queue identifier and number of lines requested, defined as X, into a read request message for broadcasting to all M memory slices and respective memory controllers (MC). It should be noted that reading the same physical address from each memory slice is equivalent to reading a single line or entry from the queue. The reading by each memory slice of X number of data slices is equivalent to reading X lines from the queue. It should also be noted that the read request messages do not require a separate control plane to reach the N (or M) memory slices, but will traverse the ingress N×M mesh with an in-band protocol, as in FIG. 46.

### Egress Read Datapath

It has before been pointed out that the novel read path architecture of the invention eliminates the need for a per queue packet storage on each egress port, which significantly reduces system latency and minimizes jitter on the output line. This read path is extremely scalable in terms of number of ports and queues. The novel integration of the traffic manager into the datapath along with the inferred control architecture, moreover, allows the invention to provide ideal QOS.

As mentioned in earlier discussion of prior-art structures, some prior art systems utilize a per queue packet storage on the egress port because the traffic manager residing on that port does not have knowledge of the queue occupancy. This problem exists regardless of whether the packet buffer memory is located on the input ports, as in typical previously described crossbar architectures, or in a centralized location, as in typical previously described shared memory architectures. Many of such prior-art systems utilize the per queue packet storage on the egress port as a local view of the queues for the corresponding traffic manager to enable its dequeuing decisions. This type of read path architecture requires significant overspeed into the per queue packet storage to ensure that the traffic manager will dequeue correctly. The advent of burst traffic or over sub-subscription that is more than the egress datapath overspeed, however, will degrade the ability of the traffic manger to provide bounded latency and jitter guarantees, and can result in throughput loss. All of this is unacceptable to systems providing QOS. Prior-art systems also have limitations in scalability in terms of number of queues and ports because of physical limitations in the size of the per queue packet storage and egress datapath overspeed.

To reiterate, a single egress port will receive L/M bits/sec from each of the M memory slices to achieve L bits/sec output line-rate. Each memory controller (MC) residing on a memory slice has a time-division-multiplexing (TDM) algorithm that gives N egress ports equal read bandwidth to the connected memory bank. It should be noted that the time-slots of the described TDM algorithm are not typical time-slots in the conventional sense, but actually clock cycles within a 32 ns window. The novel memory bank matrix comprised of 2-element memory stages provides the system with SRAM performance and access time. The ingress and egress ports connected to a single SRAM bank are rate matched to read and write a data slice every 32 ns. A single egress traffic manager (eTM) resides on each memory slice and is dedicated to a single egress port. As described before, an eTM generates read request messages to M memory slices and respective MCs, specifying the queue and number of lines to read, based on the specified per queue rate allocation. Each memory controller services the read request messages from N eTMs in their corresponding TDM slots. Thus, the MC is responsible for guaranteeing that each of the N egress port receives equal read access (L/M bits/sec) with its TDM algorithm. The queues that are serviced within an egress port TDM time-slot, however, are determined by the read requests from the corresponding eTM, which defines the actual dequeue bit-rate per queue.

Similar to the write path, a line comprised of M data slices is read from the same predetermined address location across the M memory slices and respective memory bank column slices of the corresponding unified FIFO. The state of the queue is identical and in lock step across all M memory slices because each memory slice reads either a data slice or dummy-padding slice from the same FIFO entry. Each data slice or dummy-padding slice is ultimately returned through the egress N×M mesh to the corresponding output ports.

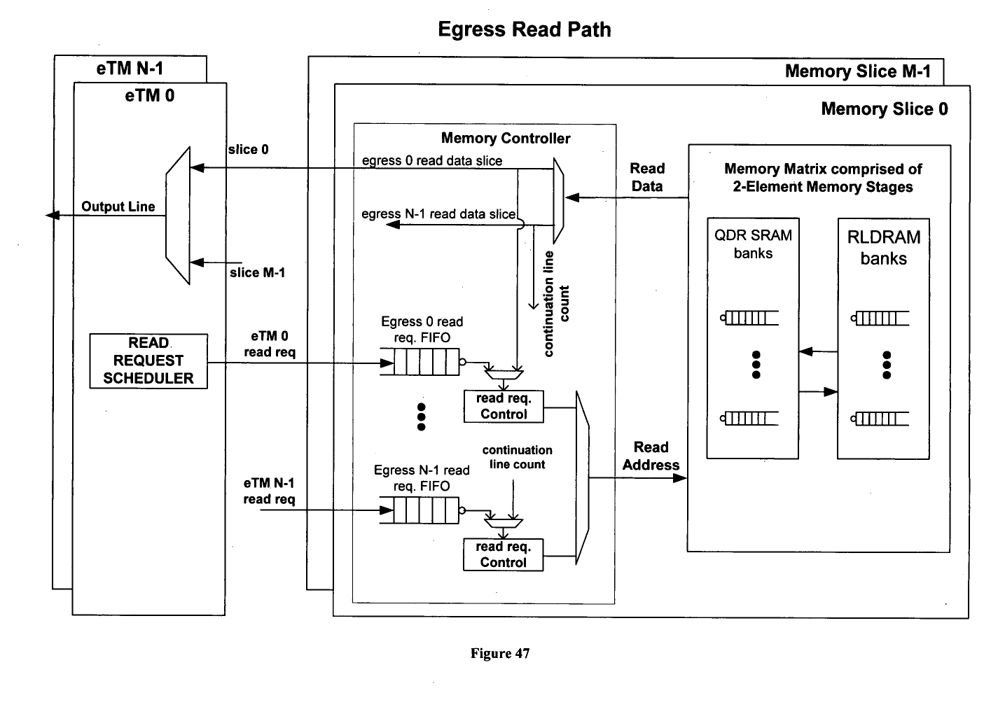

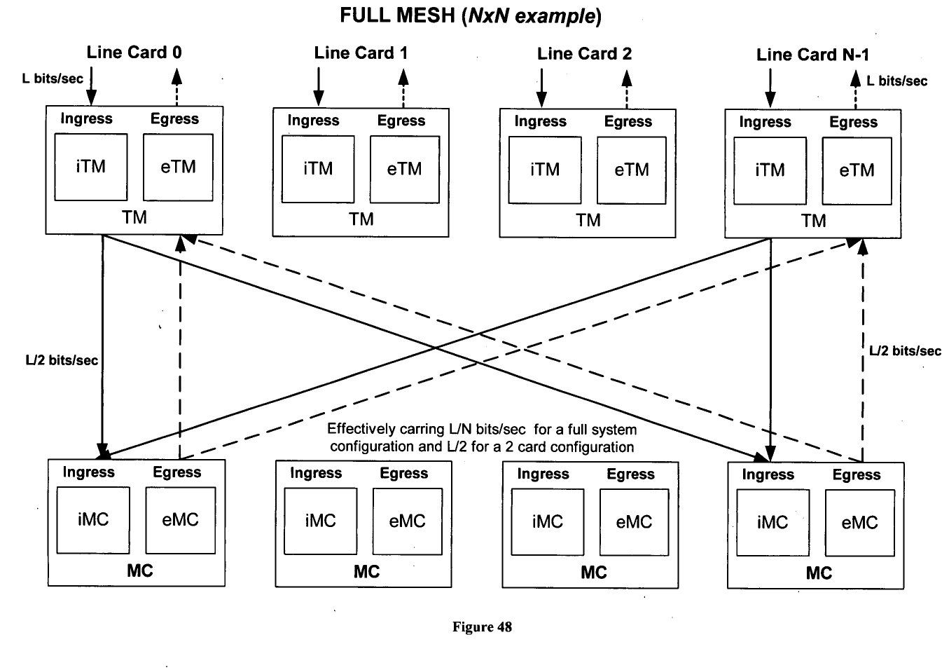

In accordance with the invention, an ability is provided to dequeue data on packet boundaries and thus eliminate the need for a per queue packet storage on the egress port. The ingress logic, or iTM, embeds a count value that is stored in memory with each data slice, termed a “continuation count”. A memory controller uses this count to determine the number of additional data slices to read in order to reach the next continuation count or end of the current packet. The continuation count is comprised of relatively few bits because a single packet can have multiple continuation counts. A memory controller will first read the number of slices specified in the read request message and then continue to read additional slices based on the continuation count. If the last data slice has a non-zero continuation count, the end of packet has not been reached and the read operation must continue as shown in FIG. 47.

One skilled in the art may assume, though erroneously, that the above scheme appears to have an issue. The last read operation of the current continuation count, requires the next continuation count to read the next data slice, providing the end of packet has not been reached. Thus, a hole will occur on the memory read data bus, unless of course the new read requests can be generated within 32 ns, which the present invention is able to do because of the SRAM access time. A traditional DRAM design may require complex pipeline logic and interleave multiple queues simultaneously to fill the hole in the read datapath, which, of course, is completely obviated by the present invention.

As before-described, a memory controller (MC) will most likely read more data slices from memory than was requested by the corresponding eTM, in order to end on a packet boundary. It should be noted that there are no coherency issues as a result of the M memory controllers reading beyond the X lines requested. This is because the actual number of data slices read from a queue will be monitored by the connected eTM, which will decrement the corresponding accumulated line count accordingly. As previously mentioned, the eTM must not double count the read data slices; therefore, the outstanding read requests must be maintained in the eTM until the read operation completes. The original read request is used to guarantee the correct number of additional read data slices is decremented from the corresponding accumulated line count. After such time they can be discarded. The eTM, furthermore, may also adjust its bandwidth accounting, which was also originally based on the X lines requested from the M memory slices.

In summary, this novel feature of the invention allows each memory slice and respective MC to read a queue up to a packet boundary. The eTM and corresponding egress port can therefore context-switch between queues without having to store partial packets, thus eliminating the requirements for per queue packet storage on the egress port. It is important to note that prior-art architectures that are pointer based require this per queue storage on the egress port because fundamentally a pointer cannot convey packet boundary information. These prior-art systems, therefore, typically require per queue packet storage on each egress port, which significantly impacts latency and jitter, and inhibits system scalability in terms of number of queues.

The invention, on the other hand, offers pointer-based queue control with the ability to stop on packet boundaries. The invention also provides a new concept termed “virtual channel”, which suggests that each egress port datapath from the shared memory can context-switch between queues and actually service and support thousands of queues, while, in fact, not requiring any significant additional hardware resources.

### Read Update to the iTM

The invention, as earlier mentioned, also provides the feature of a novel inferred return control that eliminates the need for a separate return control path to inform each ingress port and respective iTM that corresponding queues have been read by the corresponding egress ports and respective eTMs—also taking advantage of the lock-step operation of the memory slices that guarantees the state of a queue is identical across all N (or M) memory slices. Each iTM conceptually owns its corresponding queues write pointers, which are physically stored across the M memory slices and respective MCs, as before described. Each iTM maintains an on-chip SRAM-based array of per queue accumulated line counts that are updated as packets enter the corresponding ingress port. Each iTM infers the state of its queues read pointers by monitoring the local memory controller for inferred line read operations to its queues. The iTM, therefore, increments the corresponding accumulated line count when a packet enters the system and decrements the accumulated line count by the number of inferred read line operations when the corresponding queue is read, as shown in FIG. 46. The accumulated line count is used to admit or drop packets before the packet segmentation function.

Each ingress port and respective iTM can generate the depth of all the queues dedicated to it, based on before-described per queue accumulated line count—this knowledge of the queue depth being used by the iTM to determine when to write or drop an incoming packet to memory.

### Redundancy, Card Hot-swap, Chassis Configurations Overview

The invention, moreover, provides the additional benefit that each of aggregate throughput, memory bandwidth and memory storage, linearly scales with the number of line cards. In view of its physically distributed and logically shared memory architecture, this aspect of the invention allows line cards or groups of line cards to be added and removed incrementally without degradation of throughput and QOS capabilities of the active line cards—providing options for supporting minimum-to-maximum line card configurations and port densities far beyond what is possible today.

The claim of being able incrementally to add and remove line cards allows the invention to offer the following features. The invention can provide various levels of redundancy support based on the needs of the end application. In addition, the invention can provide hot-swap capability for servicing or replacing line cards. Finally, the invention offers a “pay as you grow approach” for adding capacity to a system. Thus, the cost of a system grows incrementally to support an expanding network.

### Minimum-to-Maximum Line Card Configuration Considerations

The dynamic use of link bandwidth in the ingress and egress N×N (or N×M) meshes, and memory bandwidth and storage, provides the system of the invention with flexibility to grow from a minimum to a maximum configuration of line cards (combined ingress port, egress port, and memory slice).

A maximum system configuration comprised of a fully populated chassis of N line cards requires the least amount of bandwidth on each link in the ingress and egress N×N meshes because the bandwidth required per link is truly L/N bits/sec to and from each memory slice for N=M. A system configuration comprised of a partly populated chassis, where the number of line cards is less than the maximum configuration, requires more bandwidth per link to sustain line rate.

Consider the before-mentioned example of a 64-port system, where N=64 and M=64, and L=16 Gb/s to support a 64 byte packet every 32 ns. A fully populated system requires 16/64 Gb/s or 0.25 Gb/s per link in the ingress and egress meshes to sustain line-rate. The same system, partly populated with only 8 line cards, for example, requires 16/8 Gb/s or 2 Gb/s per link in the ingress and egress meshes to sustain line-rate. Therefore the fewer line cards that populate a system, the more bandwidth is required per link to sustain a line rate of L bits/sec. This implies from a worst-case perspective, that a system requires L bits/sec of bandwidth per link in the ingress and egress meshes to support a system populated with a single line card. Thus, the minimum system configuration required by the end application is an important design consideration in terms of link bandwidth requirements. It should be noted, however, that the aggregate read and write bandwidth to a single memory slice is guaranteed to always be 2×L bits/sec, for M=N, regardless of the number of line cards that populate a system and the provided link overspeed to support the minimum configuration.

A number of different options to minimize the bandwidth required by the ingress and egress meshes and still provide flexibility for minimum to maximum system configurations will be discussed later, including the use of crosspoint and TDM switches for larger system configurations.

The memory bandwidth and storage of each line card adds to the aggregate memory bandwidth and storage of a system, enabling the system to distribute data slices for a new system configuration, such that the memory bandwidth per memory slice does not exceed L bits/sec, for M=N.

To illustrate, as new line cards are added to a system, data slices from the active line cards are redistributed to utilize the memory bandwidth and storage of the corresponding new memory slices. This effectively frees up memory bandwidth and storage on the active memory slices, which in turn accommodates data slices from the new line cards. Similarly, as line cards are removed from a system, extra data slices from the remaining active line cards are redistributed to utilize the memory bandwidth and storage of the remaining active memory slices. The slice size and line size may remain the same when adding or removing line cards, with the choice of slice size being based on the largest system configuration. As a single card and corresponding memory slice is removed, for example, the extra data slice from each active line card is re-distributed to a different single active memory slice, such that no two line cards send their extra data slice to the same memory slice.

To further illustrate this data slice distribution scheme, consider the before-mentioned example of a 64-port system, where N=64, M=64, C=1 byte for a line size of 64 bytes, and L=16 Gb/s to support a 64 byte packet every 32 ns. If a system configuration is comprised of a fully populated chassis of 64 line cards, then each line card will transmit 1 data slice to each memory slice every 32 ns. Each memory slice will therefore receive 64 data slices every 32 ns from 64 line cards, for an aggregate memory bandwidth of 64×1 byte/32 ns or 16 Gb/s. Each memory slice writes 64 data slices every 32 ns to the non-blocking memory structure. If one line card is removed, the remaining 63 active line cards will each have 1 extra data slice every 32 ns, which was originally destined to the removed line card and respective memory slice. The remaining 63 memory slices, however, each have 1 less line card to support and therefore have one available memory access every 32 ns. If each line card is configured to write its extra data slice to a different memory slice, then the aggregate bandwidth per memory slice remains 64 data slices every 32 ns or 16 Gb/s.

### Design Considerations in Minimum to Maximum Line Card Configurations as to Dynamic Link Bandwidth

A system designer must consider tradeoffs with the invention between implementation complexities, cost and reasonable restrictions on a minimum system configuration based on the end application.

First, the minimum number of line cards (i.e. the before-mentioned preferred embodiment of a combined ingress port, egress port, and memory slice) required for maintaining line-rate of L bits/sec must be determined based on the per link bandwidth used for implementing the ingress and egress N×N (or N×M) meshes.

If, for example, each link in the ingress and egress N×N (or N×M) meshes is L/2 bits/sec, then a minimum of 2 line cards must populate the system to achieve full line rate for each line card. If each link is L/4 bits/sec, then a minimum of 4 line cards must populate the system to achieve full line rate for each line card, and so forth.

It should be noted that an optimization to support a single stand-alone line card at full line-rate, without each link supporting L bits/sec, may be achievable by adding a local loop-back path on the line card that supports L bits/sec. Each link, therefore, may be implemented to support L/2 bits/sec for a system configuration of 2 line cards; however, a single line card configuration is now possible without the expense of increasing the link bandwidth by 50%.

As an illustration, consider a low-end networking system supporting 1 Gb/sec interfaces. A low-end application may not initially require a lot of capacity and thus may require only 1 or 2 active line cards. Thus each link in the ingress and egress N×N (or N×M) meshes must support 0.5 Gb/s, provided the local loop-back of L bits/sec is available for single line card support.

Turn now, however, to a high-end networking system like a core router supporting 10 Gb/s interfaces or, as previously explained, 16 Gb/sec interfaces at the switch. A high-end core application may initially want to activate 4 line cards for a minimum configuration because the application is a metro hub. Each link in the N×N (or N×M) meshes must then support 4 Gb/s. Similarly the application may want to active 8 line cards for a minimum configuration because the application is a national hub. Each link in the N×N (or N×M) meshes would then be 2 Gb/s.

Such a high-end system could, of course, be designed for a minimum configuration of 2 line cards if each link in the N×N (or N×M) meshes supported 8 Gb/s, and 1 line card if the full bandwidth local loop-back path was provided. 8 Gb/s links to support a minimum configuration of 2 line cards, however, would greatly increase the system cost as compared to 2 Gb/s links to support a minimum configuration of 8 line cards. Thus the decision must be based on the tradeoffs between cost, implementation complexity and the requirements of the end application.

### Redundancy Considerations

Typical prior switch architectures rely on an N+1 approach to redundancy. This implies that if a switching architecture requires N fabrics to support line rate for the total number of ports in the system, then redundancy support requires N+1 fabrics. The redundant fabric is typically kept in standby mode until a failure occurs; but this feature adds cost and complexity to the system. Such systems, furthermore, must have additional datapath and control path infrastructure so the redundant fabric can replace any one of the N primary fabrics. Such N+1 redundancy schemes have typically been used for architectures that use a shared fabric regardless of whether the switching is of the crossbar or shared memory-based types. In addition, prior architectures may have to provide redundancy in the control path—this is certainly the case for systems that are central scheduler-based.

A system redundancy feature is used to protect against graceful and ungraceful failures. A graceful failure is due to a predictable event in the system—for example, a fabric card has a high error rate and needs to be removed for servicing or must be completely replaced. In such a scenario, an operating system detects which of the primary fabrics is about to be removed and enables the redundant fabric to take over. Typically, the operating system will execute actions that will switch over to the redundant fabric with minimal loss of data and service.

An ungraceful failure, on the other hand, is more difficult to protect against because it is unpredictable. A power supply on a fabric, for example, may suddenly short out and fail. In this scenario, an operating system will then switch over to the redundant fabric, but the loss of data is much worse than in the case of a graceful switchover, because the operating system does not have time to execute the necessary actions to minimize data loss.

The drawbacks of the N+1 redundancy scheme are that it only protects against a single fabric failure and, by definition, is costly because it is redundant and has no value until a failure occurs. While a system may support redundancy for multiple fabric failures, this just increases the complexity and cost. The N+1 fabric scheme, however, is a typical industry approach for supporting redundancy for traditional IP networks.

Looking to the future, next generation switching architectures will have to support converged packet-based IP networks that are carrying critical applications such as voice, which have traditionally been carried on extremely reliable and redundant circuit switch networks. Redundancy thus is a most critical feature of a next generation switching architecture.

Fortuitously, the present invention provides a novel redundancy architecture that actually has no single point of failure for its datapath or its inferred control architecture—conceptually providing N×N protection with minimal additional infrastructure and cost and significantly better than the before-mentioned industry standard N+1 fabric protection.

Should the end application only need a traditional N+1 redundancy scheme, instead of the N×N redundancy protection, the invention can also easily support this requirement as well.

The invention, furthermore, as earlier mentioned, has no single point of failure because there is no centralized shared memory fabric, and it thus can support N×N redundancy or N×N minus the system minimum number of line cards. Its shared memory fabric is physically distributed across the line cards but is logically shared and thus has the advantages of aggregate throughput, memory bandwidth and memory storage scaling linearly with the number of line cards—this also implying that as line cards fail, the remaining N line cards will have sufficient memory storage and bandwidth, such that QOS is not impacted.

The invention provides redundancy by rerouting data slices originally destined to a failing line card and corresponding failing memory slice, to active line cards and corresponding active memory slices; thus utilizing the memory bandwidth and storage that is now available due to the failing line card, and taking advantage of the available link bandwidth required for a minimum line card configuration.

The invention maintains its queue structure, addressing and pointer management during a line card failure. Consider the previous example of a 64-port system that has a single line card failure, 63 line cards remain active. Each of the remaining 63 active line cards has an extra data slice every 32 ns that must be rerouted to an active memory slice. If each line card reroutes the extra data slice to a different active memory slice, the per memory slice bandwidth will remain L bits/sec, for M=N. Each of the remaining 63 active memory slices will accordingly receive 64 data slices every 32 ns.

The invention, furthermore, particularly lends itself to a simple mapping scheme to provide redundancy and to handle failure scenarios. Each line card has a predetermined address map that indicates for each line card failure, which active memory slice is the designated redundant memory slice. The address map is unique for each line card. When a failure occurs, accordingly, each active line card is guaranteed to send its extra data slices to a different memory slice. Similarly, each memory slice has an address map that indicates for each line card failure, which active line cards will utilize its memory bandwidth and storage as a redundant memory slice. This address map will allow the memory slice to know upon which link to expect the extra data slices. The memory slice may have local configuration registers that provide further address translation if desired. Fundamentally, however, the original destination queue identifier and physical address of each data slice does not have to be modified. This simple mapping scheme allows the invention to maintain its addressing scheme, with some minor mapping in physical address space for data slices stored in redundant memory slices.

In summary, when a line card fails, the remaining active line cards redistribute the data slices in order to still maintain full throughput and QOS capability, which is possible because the aggregate memory bandwidth and storage requirement reduces in a linear manner to the number of active line cards. And lastly, the novel inferred control architecture of the invention has an inherent built-in redundancy by definition, because each line card can infer pointer updates by monitoring its local memory controller.

### Hot Swap Considerations

The invention also enables a hot swap scheme that supports line cards being removed or inserted without loss of data and disruption of service to traffic on the active line cards, and does not require external system-wide synchronization between N TMs. The provided scheme is readily useful to reconfigure queue sizes, physical locations and to add new queues. Hot swap without data loss capability is an important requirement for networking systems supporting next generation mission critical and revenue generating applications, such as voice and video.

In order to provide hot swap capability, the invention takes advantage of the before mentioned redundancy claims. To reiterate, the invention dynamically utilizes link bandwidth, memory bandwidth, and memory storage by redirecting data slices to the active line cards and corresponding memory slices, such that the bandwidth to each memory slice does not exceed L bits/sec. In the scenario where line cards have been added, data slices are redirected to utilize the new line cards and respective memory slices. In the scenario where line cards have been removed, data slices are redirected to utilize the remaining active line cards and respective memory slices.

With regard to the ability of the present invention to perform the reconfiguration and redirecting of data slices without loss of data, the invention takes advantage of the FIFO-based queue structure, which is managed by read and write pointers. A seamless transition is possible from the old system configuration to the new system configuration, if both the iTM and eTM are aware of a crossover memory address for a queue.

To illustrate this, consider, for example, the last entry of a queue is chosen as the crossover point. An iTM can embed a “new system configuration” indicator flag with the data slice a few entries ahead of the crossover address location. When the iTM reaches the crossover address location, it writes the corresponding data slices with the new system configuration. Similarly, the eTM detects the “new system configuration” indicator flag as it reads the data slices ahead of the crossover point. The flag indicates to the eTM that a new system configuration is in effect at the crossover address location. When the eTM reaches the crossover address location, it reads out the corresponding data slices based on the new system configuration. A new system configuration indicates to an eTM that the data slices from the line card and respective memory slice going inactive have been mapped to a different active line card and respective memory slice, or to expect data slices from a new line card and respective memory slice.

To effect such swap or reconfiguration, the operating system must first program local registers in all N iTMs and eTMs with information about the new system configuration. This information includes a description of which line cards are being added or removed and also address translation information. This operation can be done slowly and does not require synchronization because no crossover operation is occurring at this time. After the operating system has completed updating the TMs on the new system configuration, each iTM independently performs the crossover of all its active queues. It should be noted, as before mentioned, that there is no requirement for external synchronization between the iTMs and eTMs during the actual crossover procedure.

The crossover time for each queue may vary depending on the current locations of the read and write pointers. If an eTM has just read out of the crossover address location, then the time to perform the crossover operation will require the queue to be wrapped once. If the read and write pointers are just before the address locations of both the crossover point and the embedded “new system configuration” indication flag, then the crossover time will be fast. When all active queues are transitioned to the new system configuration, an iTM and corresponding eTM will inform the operating system that its queues have completed the crossover operation. After all TMs in the system report that the crossover operation is complete, the operating system will inform the user that the hot swap operation is complete and the corresponding line card can now be removed; or in the case of adding a new line card, the new line card is completely active. It should be observed that the end of the queue crossover point in the before-mentioned example might actually be any arbitrary location in a queue. In addition, data is not required to be passing through the queues at the time of the hot swap operation. Queues that are currently empty, of course, can be immediately transitioned to the new system configuration.

### Multicast Considerations

Thus far the invention has been described in the context of unicast traffic or packets. A unicast packet is defined as a packet destined to a single destination, which may be an egress port, interface or end-user. Next generation networking systems, however, must also support multicast traffic. A multicast packet is defined as a packet destined to multiple destinations. This may be multiple egress ports, interfaces or end-users. A network must be able to support multicast traffic in order to provide next generation services such as IP TV, which requires a broadcast type medium, (i.e. a single transmission to be received by many end-users).

Typical switch architectures have difficulty supporting full performance multicasting because of the packet replication requirement. This has the obvious problem of burdening both the datapath and control infrastructure with replicated packets and control messages, respectively. Both crossbar and shared memory-based prior-art systems can only support a percentage of such multicast traffic before degradation of performance, based on the particular implementation.

To illustrate the performance limitations of supporting multicast, consider a typical prior-art approach of performing the multicast replication on the ingress port. In this implementation, the incoming line rate is impacted by the multicast rate. If an ingress port replicates 10% of the packets, for example, then it can only support ˜90% line rate for incoming traffic, providing the bandwidth into the switch is limited to 100%. If an application requires multicasting to all N egress ports, however, then only 10%/N can be multicast to each port. Similarly, if the ingress port replicates 50% of the packets, for example, then it can only support ˜50% line rate for incoming traffic; again, providing the bandwidth into the switch is limited to 100%. If an application, in this scenario, requires multicasting to all N egress ports, then only 50%/N can be multicast to each port. This approach thus has the inherent problem of reducing the incoming line-rate to increase the multicast rate. This scheme, moreover, utilizes the ingress port bandwidth into the switch to transmit the replicated traffic to the destinations ports in a serial manner, which may result in significant jitter depending on how the multicast packets are interleaved with the unicast packets.

The invention, on the other hand, provides a multicasting scheme which enables N ingress ports to multicast 100% of the incoming traffic to N egress ports, while maintaining the input line rate of L bits/sec. Similarly, N egress ports are capable of multicasting up to the output line rate of L bits/sec. The invention is able to achieve this functionality without requiring expensive packet replication logic and additional memories, by utilizing its non-blocking aspect of the ingress and egress datapaths into the physically distributed logically shared memory.

The invention enables the novel multicast scheme by dedicating a queue per ingress port per multicast group; thus allowing a multicast queue to be written by a single ingress port and read by 1 to N egress ports. This significantly differs from a unicast queue, which is written and read by a single ingress and egress port, respectively.

At this juncture a conceptual understanding of the multicast scheme may be in order, before a more detailed description within the context of the novel memory-to-link organization and two-element memory stage of the invention.

A multicast group is defined as a list of egress ports that have been assigned to receive the same micro-flow of packets. (A micro-flow refers to a stream of packets that are associated with each other, such as a video signal segmented into packets for the purpose of transmission.) An ingress port first identifies an incoming packet as either multicast or unicast. If a multicast packet is detected, a lookup is performed to determine the destination multicast group and the corresponding dedicated queue. The multicast packet is then written once to the queue residing in the physically distributed logically shared memory. It should be noted that packet replication to each egress port in the multicast group is not required because the destined egress ports will all have read access to the dedicated queue. For all practical purposes, accordingly, a multicast packet is treated no differently than a unicast packet by the ingress datapath. Referring, for example, to the earlier described ingress datapath of FIG. 23 through 27, any of the queues may be assigned to be multicast. This implies each ingress port can write to the shared memory at L bits/sec regardless of the percentage of multicast-to-unicast traffic.

The invention provides an egress multicast architecture (FIG. 28 through 32) that allows all egress ports belonging to the same multicast group to read from the corresponding dedicated queue, and therefore conceptually replicate a micro-flow of packets as many times as necessary to meet the requirements of the network based on the number of destination interfaces, virtual circuits or end-users connected to each egress port. While in FIG. 28 through 32, the ports indicated are respectively reading out of two different unicast queues A and B, if one assumes one of said queues to be multicast to both ports, then both ports will read out of the same queue in their respective TDM read cycles—i.e. reading the same input queue. This essentially emulates packet replication without requiring additional memory or link bandwidth.

Each egress port is configured with the knowledge of the multicast groups to which it belongs, and therefore treats the corresponding multicast queues no differently than its other unicast queues. The read path architecture of the invention, as before described, gives each egress port equal and guaranteed read bandwidth from the physically distributed and logically shared memory based on a TDM algorithm. Each egress port and respective eTM decides which queues to service within its dedicated TDM slot, based on its configured per queue rate and scheduling algorithm. Similar to the unicast queues, multicast queues must also be configured with a dequeue-rate and scheduling priority. In fact, an egress port is not aware of the other egress ports in the same multicast group or that its multicast queue is being read during other TDM time-slots.

One might assume (though this would be erroneous) that pointer management by multiple egress ports for a single queue is a difficult challenge to overcome. The invention, however, provides a simple scheme for a single queue to be managed by multiple pointer pairs across multiple egress ports.

The inferred control architecture, as previously described, requires each memory slice and respective eTM to monitor the local MC for data slices written to its queues. Each eTM is also configured to monitor write operations to queues corresponding to multicast groups to which it belongs. All eTMs in a multicast group, therefore, will update the corresponding write pointer accordingly, and since an ingress port writes a packet once, all write pointers will correctly represent the contents of the queue. Each eTM corresponding read pointer, however, must be based on the actual data slices returned from the MC because the number of times a queue will be read will vary between eTMs based on the amount of multicasting that is required. Each eTM is responsible for keeping its own read pointers coherent based on its own multicast requirement.

To illustrate this scheme, consider a simple example of a 1 Gb/s micro-flow of IP TV packets being multicast to two egress ports, where one egress port must deliver the micro-flow to one customer, and the second egress port must deliver the micro-flow to two customers. Both egress ports and respective eTMs will increment the corresponding write pointers as the micro-flow of packets is written to the multicast queue. The first egress port will read out the first packet once and increment the corresponding read pointer accordingly. The second egress port will read out the first packet twice before incrementing the corresponding read pointer because it has the requirement of supplying two customers. The first eTM must dequeue the micro-flow at 1 Gb/s, while the second eTM must dequeue the micro-flow at 2 Gb/s or 1 Gb/s for each customer. It is important to note that the multicast dequeue rate of each micro-flow must match the incoming rate of the micro-flow to guarantee the queue does not fill up and drop packets. Accordingly, if the 1 Gb/s micro-flow, in this example, is being multicast to 10 customers connected to the same egress port, each packet must be read out 10 times before the corresponding read pointer is incremented and the dequeue rate must be 10 Gb/s or 1 Gb/s per customer. This example demonstrates how coherency between the different read pointers is maintained for a multicast queue by each eTM in the multicast group updating the corresponding read pointer according to the amount of multicasting performed.

Another potential problem with pointer coherency is the source ingress port maintaining accurate inferred read and write pointers or line counts, which is required to determine the fullness of a queue for the purpose of either admitting or dropping an incoming packet. The inferred control architecture requires a memory slice and respective iTM to increment the corresponding line count when writing to a queue, and to monitor the local MC for a read operation to the same queue in order to decrement the corresponding line count.

This scheme works well for unicast queues with a single ingress and egress port writing and reading the queue respectively. Multicast queues, however, are problematic because multiple reads may occur for the same queue and could represent a single line read by all egress ports in the multicast group or multiple lines read by a single egress port. The line count for a multicast queue cannot be decremented until all egress ports have read a line from the queue, otherwise packets may be erroneously written or dropped, which may result in queue corruption. The invention provides the following scheme to achieve per multicast queue line counter coherency across all ingress ports and respective iTMs.

Each eTM in a multicast group will update the corresponding read pointer after reading a packet multiple times based on the number of interfaces, virtual circuits or end-users. After completing the multicast operation a read line update command is sent to the connected iTM, which will transmit the command on the ingress N×N (or N×M) mesh to the memory slice and respective memory controller that is connected to the iTM that originated the multicast packet. The MC has an on-chip SRAM-based read line count accumulator for multicast queues. Each multicast queue, which represents a single multicast group, stores a line count for each egress port in the multicast group. As the read line update commands arrive from different egress ports the individual read line counts are updated. The egress port with the lowest read line count is set to 0 and the value is subtracted from the read line counts of the remaining egress ports. The lowest read line count now truly indicates that all egress ports in the multicast group have read this number of lines. This value is sent to the connected iTM for updating the corresponding inferred read pointer or decrementing the line count. The iTM now considers this region in the corresponding multicast queue free for writing new packets.

At this juncture a discussion is in order, regarding the multicast queuing architecture in the context of the link to memory topology and 2-element memory stage of the invention.

As previously described in the discussion on memory organization, N egress ports can be divided into groups of egress ports, for the purpose of reducing the number of memory banks on a single card, where each group of egress ports is connected to M dedicated memory slices. A system can be constructed with a single group or multiple groups of egress ports depending on the physical implementation requirements, as mentioned above. Note that each group of egress ports does not share memory slices with other groups of egress ports, as shown in FIG. 41, for example.

This system partitioning implies that egress ports in different egress port groups cannot share the same multicast queue because they do not share the same memory space. The invention provides a simple solution to this problem, which requires minimal hardware support.

The multicast queuing architecture requires each multicast group to have a corresponding queue for each egress port group that has at least one port in the multicast group. Each iTM has a local multicast lookup table, which will indicate the destination queues and egress port groups that must receive the incoming packet. Each iTM has L bits/sec of link bandwidth to each egress port group, and therefore has the capability to replicate and transmit an incoming packet to each egress port group simultaneously, without impacting the incoming line-rate. Therefore no additional hardware or bandwidth is required. The physical address of the multiple queues, furthermore, can be the same because each egress port group does not share memory space. Utilizing the same address across the egress port groups is not required but may be advantageous for implementation.

In regard to read line update of the source iTM and multiple queues per multicast group, no changes are required to the before described scheme. This is because read line update commands are transmitted between egress port groups through the ingress N×N (or N×M) mesh. Therefore the read line update command from any eTM can be transmitted to the MC connected to the source iTM, which originated the multicast packet.

The multicast architecture in the context of the 2-element memory structure will now be discussed. As before described, the 2-element memory structure residing on a memory slice is comprised of QDR SRAM and DRAM. The QDR SRAM provides the fast random access required to write data slices destined to any queue in the applications minimum transfer time. The DRAM provides the per queue depth required to store data during times of over-subscription. For networking applications, such as the before mentioned 64-port core router, multiple QDR SRAMs are required to meet the fast access requirement of 64 data slices every 32 ns. Consider a system partitioned into 4 groups of egress ports, which requires the 2-element memory structure to support 16 egress ports. If a 500 MHz QDR SRAM is used for the fast access element, then 16 read and 16 write accesses are available for data transfer. The QDR SRAM, however, has to support 8 read accesses for block transfers to the DRAM and 8 read accesses for data slices that may be immediately required by the connected egress ports. This implies that 8 ingress ports are connected to 2 QDR SRAM to guarantee the read and write bandwidth is matched. The first QDR SRAM supports egress ports 0 to 7 and the second QDR SRAM supports egress ports 8 to 15. This organization is then repeated on the memory slice for the remaining ingress ports.

This memory organization implies an ingress port requires a multicast queue per QDR SRAM, in order to give access to the connected egress ports, providing of course, at least one egress port connected to each QDR SRAM is in the multicast group. This requirement can easily be met because the bandwidth into a single QDR SRAM meets the bandwidth of all the connected ingress ports. If multiple QDR SRAMs are connected to a group of ingress ports, accordingly, all connected QDR SRAM can be written simultaneously with the same data. Note that a multicast group can utilize the same physical address for the corresponding queue in each QDR SRAM. The DRAM will also have queue space corresponding to each multicast queue, which may be required during times of over-subscription.

The multicast queuing architecture can now be summarized as each ingress port can have any number of multicast groups, where a single multicast group requires a queue per egress port group, per connected QDR SRAM and DRAM, of course, providing the egress port group and QDR SRAM and DRAM has at least one connected egress port belonging to the multicast group.

### Introduction of TDM (Time-Division-Multiplexer) and Crosspoint Switches

As before mentioned, if a minimum configuration of 2 line cards is required, then each link in the ingress and egress N×N (or N×M) meshes must be L/2 bits/sec. The N×N (or N×M).mesh can be implemented with available link technologies for most of current networking applications, and for the immediate next generation. In the foreseeable future networking systems with higher line rates and port densities must be supported to meet the ever-increasing demand for bandwidth, driven by the number of users and new emerging applications. Next generation 40 Gb/s line-rates and port densities increasing to 128, 256 and 512 ports and beyond will be required to support the core of the network. As a result, the ingress and egress N×N (or N×M) meshes will be more difficult to implement from a link technology perspective. Supporting a flexible minimum and maximum system configuration, moreover, will also increase the per link bandwidth requirement as described before. The invention, accordingly, offers two alternatives for such high capacity systems.

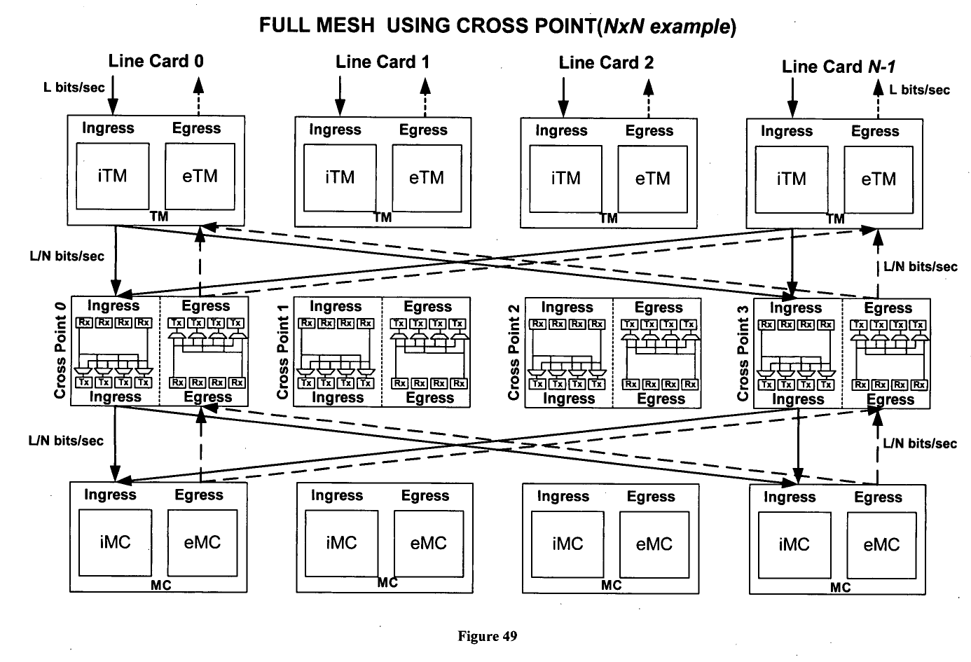

The first approach uses a “crosspoint switch” which provides connectivity flexibility between the links that comprise the ingress and egress N×N (or N×M) meshes. FIG. 49 illustrates the use of such a crosspoint switch with L/M bits/sec links, thus allowing the supporting of minimum-to-maximum line card configurations with link utilization of L/M bits/sec. This allows a system to truly have L/M bits/sec of bandwidth per link regardless of the number of active line cards in the system. This solution offers the lowest possible bandwidth per link and does not require any link overspeed to accommodate the minimum system configuration, though, an ingress and egress N×N (or N×M) mesh is still required.

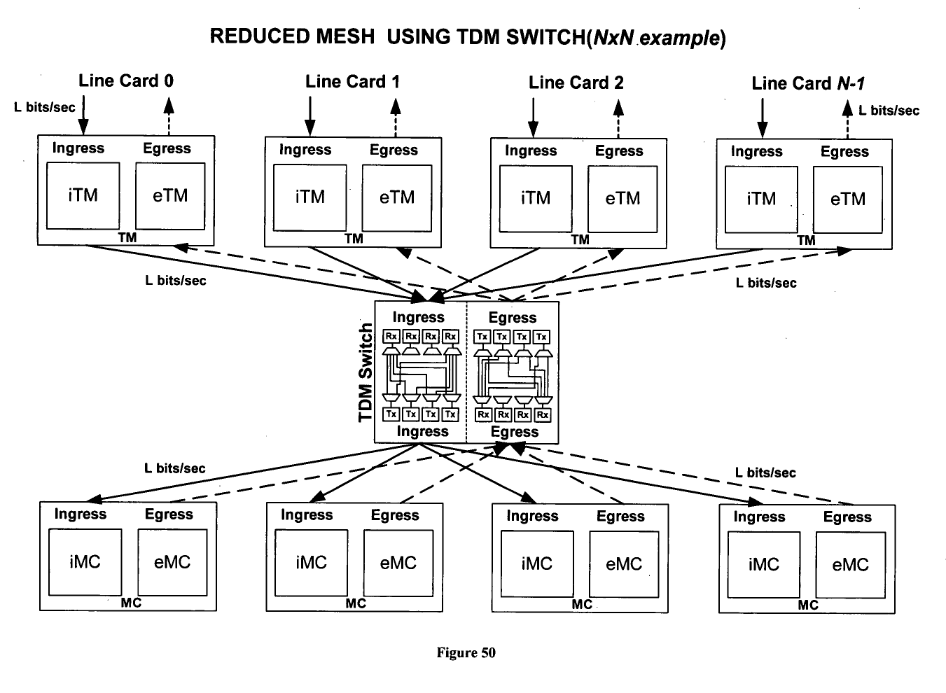

The second approach uses a “time division multiplexer switch”, earlier referred to as a TDM switch, which provides connectivity flexibility between the line cards but without an ingress and egress N×N (or N×M) mesh as shown in FIG. 50. This solution provides ingress connections of 2×N to and from the TDM switch, and egress connections of 2×N to and from the TDM switch, where each connection is equal to L bits/sec. The TDM switch is responsible for giving L/N bits/sec of bandwidth from each input port to each output port of the TDM switch, providing an aggregate bandwidth on each output port of L bits/sec. The TDM switch has no restrictions on supporting the minimum configuration and it has the advantage that the number of links required for connectivity is significantly less than an N×N (or N×M) mesh approach, enabling significantly larger systems to be implemented.

### Crosspoint Switch

The possible use of a crosspoint switch was earlier mentioned to eliminate the need for link overspeed in the ingress and egress N×N meshes required to support a minimum configuration, providing programmable flexible connectivity, as in FIG. 49, and therefore truly requiring only L/N bits/sec of bandwidth per link for any size configuration. (For the purpose of this discussion assume N=M.)

In a distributed shared memory system, the memory is physically distributed across N line cards. This type of a fixed topology requires that all of the N line cards need to be present for any line card to achieve an input and output throughput of 2×Lbit/sec, since each port has L/N bits/sec write bandwidth to each slice of distributed memory and L/N bits/sec (or L/M bits/sec) read bandwidth from each slice of distributed memory. This is considered a fixed topology because the physical links to/from a port to a memory slice cannot be re-configured dynamically based on the configuration, and therefore requires the before mentioned link overspeed to support smaller configurations down to a minimum configuration. This aspect is undesirable for large systems that may have limitations in the amount of overspeed that can be provided in the backplane. Although a system is designed for a maximum configuration, it should have the flexibility to support any configuration smaller than the maximum configuration without requiring overspeed. This flexibility can be achieved with the use of the crosspoint switch.

The basic characteristic of a crosspoint switch is that each output can be independently connected to any input and any input can be connected to any or all outputs. A connection from an input to an output is established via programming configuration registers within the crosspoint chip. This flexibility, in re-directing link bandwidth to only the memory slices that are present, is necessary for maintaining L/N bit/sec.

Consider, as an illustration, a system of N ports having N crosspoint switches. Each crosspoint would receive L/N bits/sec bandwidth from each ingress TM port on its input port and provide L/N bits/sec bandwidth to each memory slice on its output port for supporting ingress write traffic into the switch. Each crosspoint would receive L/N bits/sec from each memory slice and provide L/N bits/sec bandwidth to each egress TM port for supporting egress read traffic out of the switch. In configurations where cards are not populated, the crosspoint can be programmed to re-direct the ingress and egress bandwidth from/to a port to only those slices of memory that are physically available.

### TDM (Time-Division-Multiplexer) Switch

The purpose of the earlier mentioned TDM switch is not only for providing programmable connectivity between memory slices and TM ports, but also for reducing the number of physical links and the number of chips required to provide the programmable connectivity.

Consider a 64-port system with 64 memory slices in the system of FIG. 50 as an illustration. The number of physical links required for the ingress path would be 64×64 or 4096 links with each link supporting a bandwidth of L/N bit/sec. If a crosspoint switch were used to provide the programmable connectivity between ports and memory slices, the number of crosspoints that would be needed would be N and each crosspoint would have a link to each TM port with each link having a bandwidth of L/N bit/sec. The aggregate ingress bandwidth required for each crosspoint would only be L bit/sec.

The number of physical links and the number of chips can be reduced in this example by using a TDM switch instead of a crosspoint switch. The amount of reduction is dependent on the aggregate ingress bandwidth that the TDM switch can support. A TDM switch that can support 4L, for example, would provide a reduction factor of 4 (4L×16 chips=64L for a 64 port system). Therefore, a 64-port system would only need 16 TDM switch chips and each TDM switch chip would have a link to each TM port and each link would support a bandwidth of 4L/N bits/sec.

The unique feature of such use of the TDM switch is that data arriving on an input of the TDM switch can be sent to any output of the TDM switch dynamically based on monitoring a destination identifier embedded in the receive control frame. Essentially this scheme uses higher bandwidth but fewer links by bundling data destined for different destination links on to a single input link to the TDM switch. The TDM switch monitors the destination output id in the control frame received on its input port and directs the received data to its respective output port based on the destination id. The TDM on each input link and output link of the TDM switch guarantees that each TM port connected to the TDM switch effectively gets its L/N memory bandwidth to/from each memory slice.

### Single and Multi-Chassis System Configurations

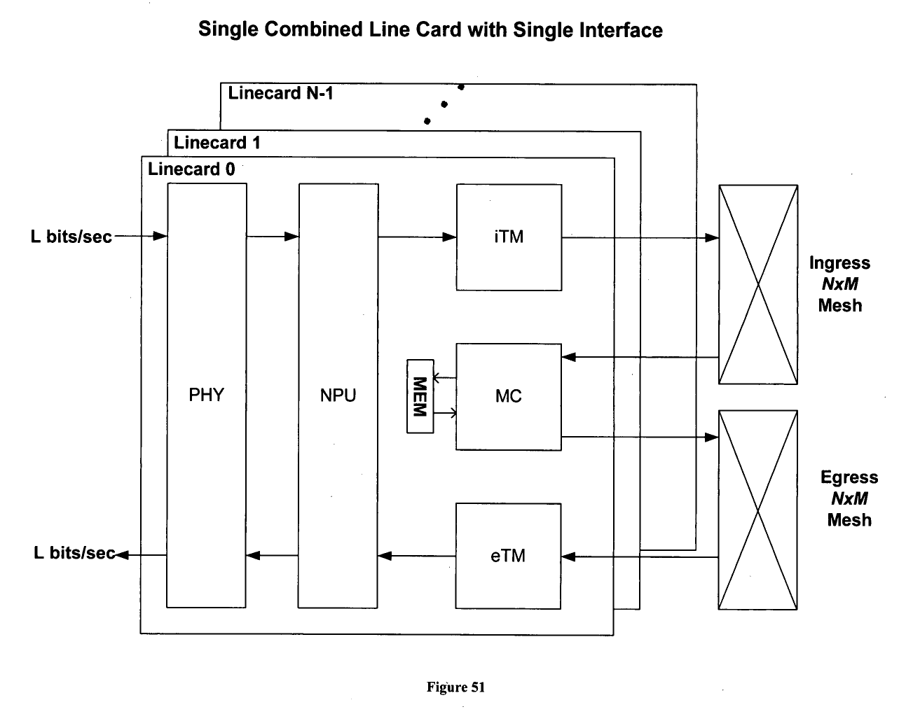

The preferred embodiment of the invention, as earlier explained, combines the ingress port, egress port and memory slice onto a single line card. Thus the TM, MC and memory banks reside on a single line card, along with a network processor and physical interface. (Note that a TM is comprised of the functional iTM and eTM blocks). A system comprised of the above-mentioned line cards is connected to the ingress and egress meshes comprised of N×M links for a total of 2×N×M links, where the bandwidth of each link must meet the applications requirements for the minimum number of active line cards to maintain the per port line rate of L bits/sec. Refer to FIG. 51 for an illustration, where the number of ports and memory slices are equal; therefore N=M. The number of ports and memory slices, however, do not have to be equal. Therefore multiple ports and memory slices can reside on a single line card. The system partitions are primarily driven by tradeoffs between cost and implementation complexity; increase in board real estate, for example, reduces complexity but increases the overall cost of a system.

In the before-mentioned example of a 64-port next generation core router, where N=64 and M=64 implemented with all the functional blocks integrated onto a single line card, as in the embodiment of FIG. 51, there are many possible physical system partitions. The system must support a networking application minimum packet size of 40 byte packets at a physical interface rate of 10 Gb/s, which translates to P=64 byte packets at a rate of L=16 Gb/s, as earlier explained. Thus, the system must meet the requirement of 64 bytes/32 ns being written and read by all N ports. A non-blocking memory bank matrix of (N×N)/(J/2×J/2) is therefore required for the fast-random access element of the 2-element memory stage residing on each card, where J is the access capability of the memory device of choice. The total memory banks required for the fast-random access element across the system is based on the equation ((N×N)/(J/2×J/2))×P/D, as earlier described, where P is the minimum packet size of the application that must be either transmitted or received in T ns, and D is the size of a single data transfer in T ns of the chosen memory device. The readily available 500 MHz QDR SRAM provides 32 accesses every 32 ns and is therefore an ideal choice for the fast-random access element. The 2-element memory stage (FIG. 39), however, requires half the bandwidth for transfers to the DRAM element during times of over-subscription, as earlier described; therefore, 16 accesses, or 8 write accesses and 8 read accesses, are available every 32 ns for the non-blocking matrix.

One possible system configuration is 64 line cards divided into 8 egress groups, where each egress group is comprised of 8 ports, with a single port and memory slice residing on a line card, (M is equal to N). A line and data slice size of 64 bytes and 8 bytes respectively is well suited to the 8 line cards per egress group, and the 8 byte data transfer of the QDR SRAM. This configuration requires 512 ((((64×64)/(8×8))×64/8)) QDR SRAM for the fast-random access element across the entire system, based on the before-described equation, (((N×N)/(J/2×J/2))×P/D). Thus 64 (512/8) QDR SRAMs per egress group or 8 (64/8) QDR SRAMs per card are required. The DRAM element of the 2-element memory stage requires 8 RLDRAMs, where each device is capable of reading and writing 64 bytes/32 ns or together 512 bytes/32 ns. The DRAM element provides a block transfer of 512 bytes/32 ns, which effectively provides a block transfer of 512 bytes/256 ns to each of the QDR SRAM. This effectively gives each QDR SRAM 64 bytes/32 ns of read bandwidth and 64 bytes/32 ns of write bandwidth.

In summary, this 64-port system configuration has 64 line cards, where each line card is comprised of a single input output port and memory slice with the respective TM and MC chips. Each line card, in addition, has 8 QDR SRAM and 8 RLDRAM devices. The number of physical parts by current standards is relatively few and therefore from a board real estate perspective is a good solution, though this comes at the expense of eight times the number of ingress links to support the eight egress port groups.

Another possible system configuration is 32 line cards divided into 4 egress groups, where each egress group is comprised of 16 ports, with two ports and a single memory slice residing on a line card. (M is not equal to N in this case.) This configuration, similar to the previous example, requires 512 QDR SRAMs for the fast-random access element across the entire system. Therefore 128 (512/4) QDR SRAMs per egress group or 16 (128/8) QDR SRAMs per card are required. The DRAM element of the 2-element memory structure requires 8 RLDRAMs, where each device is capable of reading and writing 64 bytes/32 ns or together 512 bytes/32 ns. The DRAM element provides a block transfer of 512 bytes/32 ns, which effectively provides a block transfer of 512 bytes/256 ns to each group of 2 QDR SRAM. This effectively gives each group of 2 QDR SRAM 64 bytes/32 ns of read bandwidth and 64 bytes/32 ns of write bandwidth. The number of RLDRAMS is the same as the previous configuration because the block transfer rate has to match the aggregate ingress bandwidth.

In summary, this 64-port system configuration has 32 line cards, where each line card is comprised of two input output ports and a single memory slice with the respective TM and MC chips. Each line card, in addition, has 16 QDR SRAM and 8 RLDRAM devices. The number of physical parts per card is double, except of the RLDRAM, compared to the previous example; however, half the number of ingress links is required.

Another possible system configuration is 16 line cards divided into 2 egress groups, where each egress group is comprised of 32 ports, with four ports and a memory slice residing on a line card. (Again, in this case M is not equal to N.) This configuration, similar to the previous example, requires 512 QDR SRAMs for the fast-random access element across the entire system. Therefore 256 (512/2) QDR SRAMs per egress group or 32 (256/8) QDR SRAMs per card are required. The DRAM element of the 2-element memory structure requires 8 RLDRAMs, where each device is capable of reading and writing 64 bytes/32 ns or together 512 bytes/32 ns. The DRAM element provides a block transfer of 512 bytes/32 ns, which effectively provides a block transfer of 512 bytes/256 ns to each group of 4 QDR SRAM. This effectively gives each group of 4 QDR SRAM 64 bytes/32 ns of read bandwidth and 64 bytes/32 ns of write bandwidth. Note that the number of RLDRAMS is the same as the previous configuration because the block transfer rate has to match the aggregate ingress bandwidth.

In summary, this 64-port system configuration has 16 line cards, where each line card is comprised of four input output ports and a single memory slice with the respective TM and MC chips. Each line card, in addition, has 32 QDR SRAM and 8 RLDRAM devices. The number of physical parts per card is double, except for the RLDRAM, compared to the previous example; however, half the number of ingress links is required.

All of the before-described possible configurations of a 64-port system demonstrate the flexibility of the invention to tradeoff number of components, boards and backplane links to optimize implementation complexity and cost.

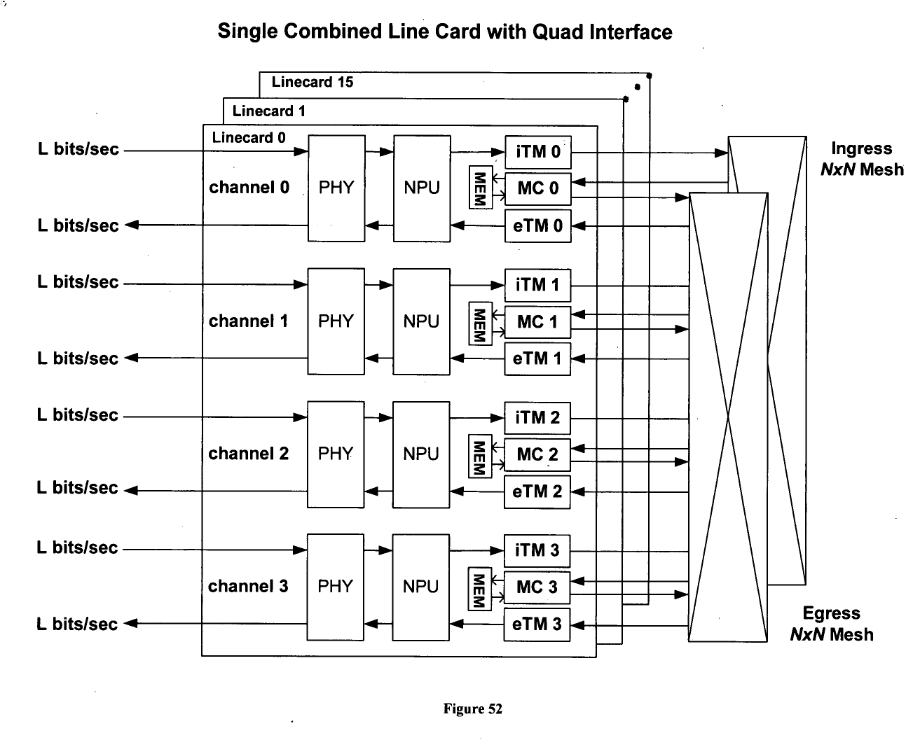

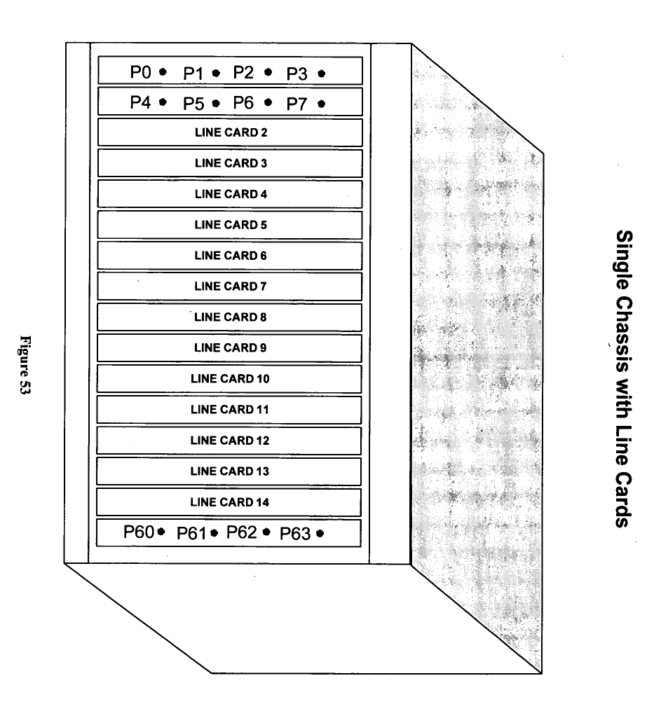

In the before-described example of a 64-port system in a configuration of 16 line-cards comprised of 4 TMs, 4 MCs, 4 network processors and 4 physical interfaces, as in FIG. 52, the number of ports and memory slices are not equal, yet still collapsed together into the preferred embodiment of a system comprised of just line cards. FIG. 53 provides an illustration of this system configuration housed in a single chassis.

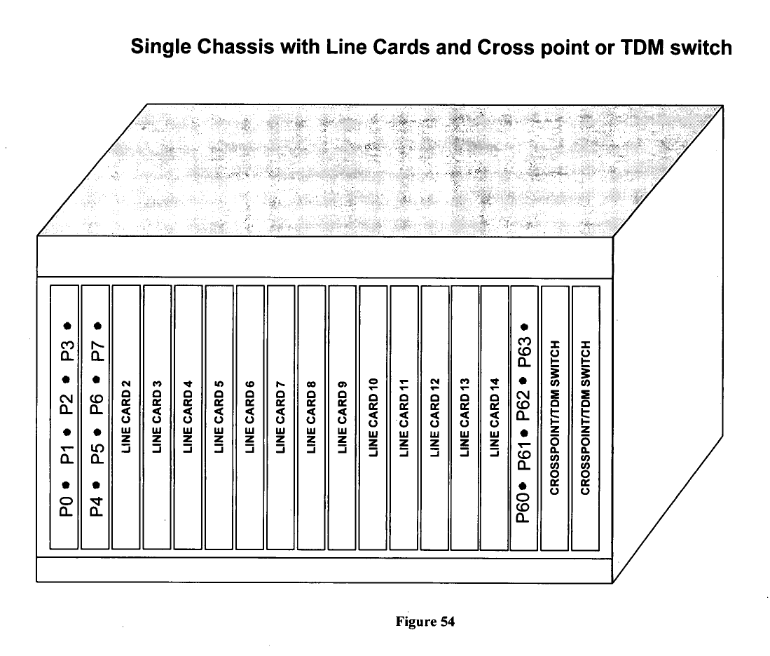

If the application requires the flexibility to support a minimum system configuration of a single line card, there are multiple available approaches as described before. The ingress and egress meshes comprised of 2×N×M links can be implemented to support L/2 bits/sec for a system comprised of just line cards as in FIG. 53. If desired, each link can be implemented to support L/M bits/sec for a system with a crosspoint switch to reconfigure the N×M meshes based on the number of active line cards. If desired, the ingress and egress N×M meshes can be replaced with a TDM switch, which would further reduce the number of links as in FIG. 54.

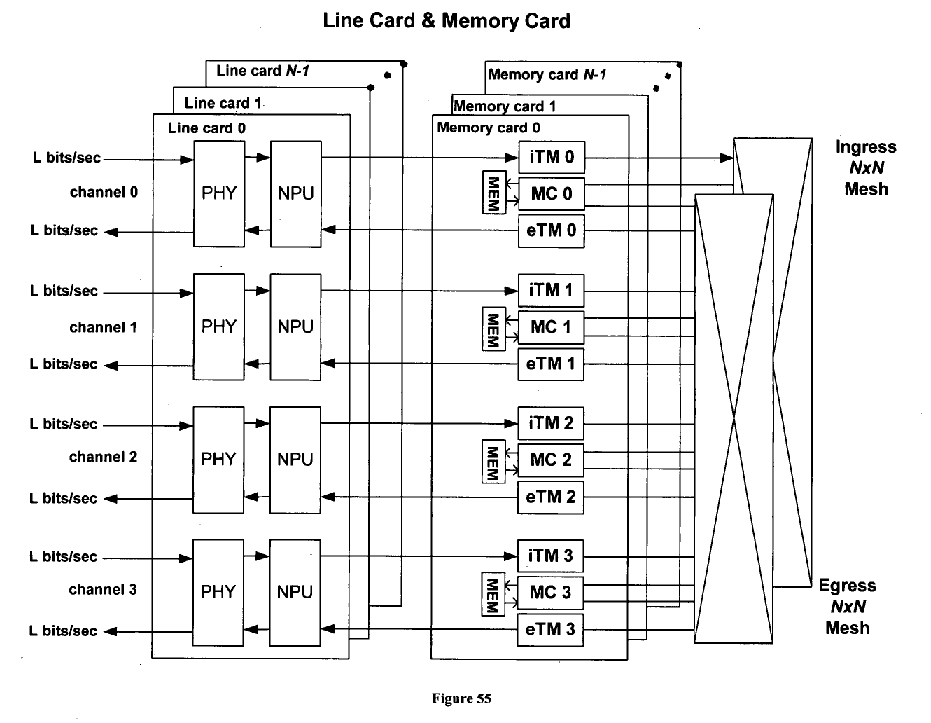

An alternate embodiment of the invention partitions the system into line cards and memory cards for supporting configurations with higher port densities and line-rates. In this alternate embodiment, a line card is comprised of a physical interface and network processor, and a memory card is comprised of a TM, MC and memory banks. A point-to-point fiber link connects each network processor residing on a line card to a corresponding TM and its respective logical iTM and eTM blocks residing on a memory card as in FIG. 55. Again, for purpose of illustration, the iTM and eTM are shown separately, but actually may reside on a single TM.

The partitioning of the system into line cards and memory cards, moreover, may provide significantly more board real estate that can be used for increasing the number of parts. Thus a memory card can fit more memory devices to increase the size of the fast-random access element memory bank matrix to support higher port densities. The additional memory banks can also be used to increase the total number of queues or size of the queues depending on the requirements of the application. A line card can also be populated, moreover, with more physical interfaces and network processors. This system partitioning also allows the flexibility to connect multiple line cards to a single memory card or a single line card to multiple memory cards.

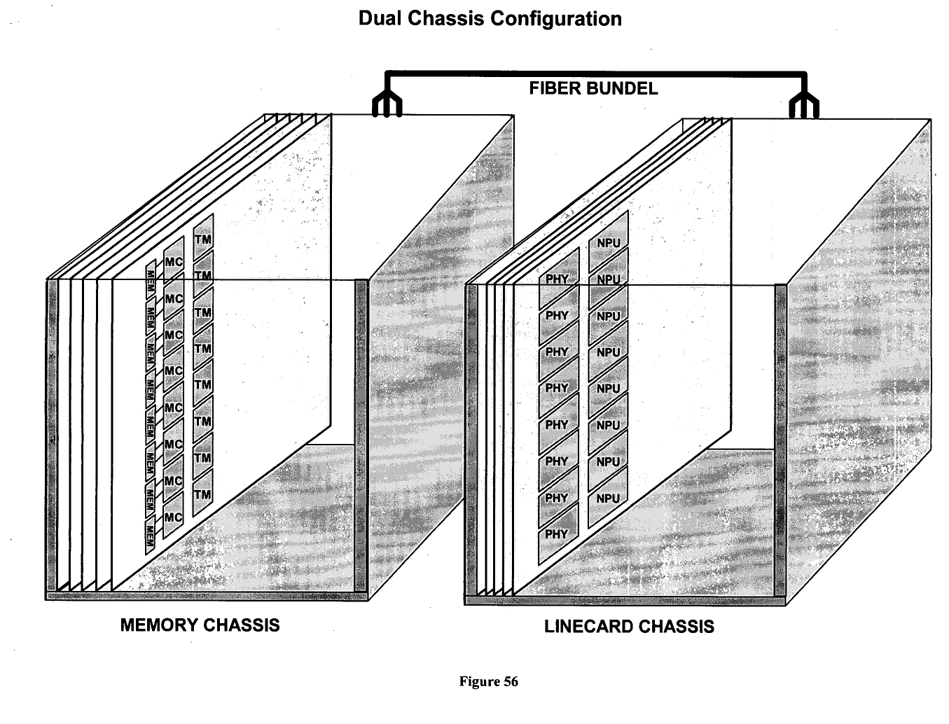

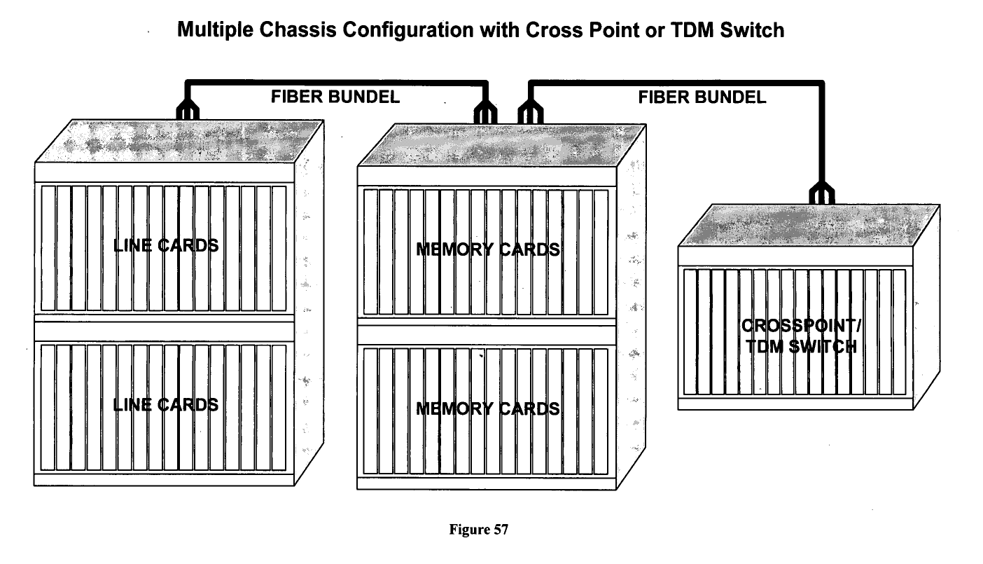

A single line card, for example, may be populated with many low speed physical interfaces, such that the aggregate bandwidth across all the physical interfaces requires a single network processor and corresponding TM. In this case, a single memory card with multiple TMs would be connected to multiple line cards via the point-to-point fiber cable. Similarly, a single line card can be populated with more high-speed interfaces than a single memory card can support. Thus, multiple memory cards can be connected to a single line card via the point-to-point fiber cable. The line cards and memory cards can reside in different chassis, which is possible with point-to-point fiber cable which allows cards to be physically separated as in FIG. 56. Furthermore, the ingress and egress N×M meshes would reside in the memory card chassis. Finally, for large system configurations, a separate chassis comprised of crosspoint or TDM switches may be connected to the memory card chassis via point-to-point fiber cable as in FIG. 57.

### Summary of Operation

The before-described significant improvement over prior art schemes, can be attributed to the novel physically distributed, logically shared, and data slice synchronized, shared memory operation of the invention. An important aspect of the invention resides in the operation of each data queue as a unified FIFO sliced across the M memory banks, which may only be written to by a single ingress port and read by a single egress port, for unicast data. This feature of the invention significantly simplifies the control logic by guaranteeing that the state of each queue is identical in every memory bank, which totally eliminates the need for a separate control path as in prior art systems.

Each input port segments the incoming data into lines and then further segments each line into M data slices. The M data slices are fed to the M memory slices through the ingress N×M mesh and written to the corresponding memory banks. Each data slice is written to the same predetermined address location across the M memory slices and respective memory bank column slices of the corresponding unified FIFO. The state of the queue is identical, or in lock step, across all M memory slices because each memory slice wrote a data slice to the same FIFO entry. Similarly, the next line and respective data slices destined to the same queue are written to the same adjacent address location across the M memory slices and respective memory bank column slices.

If the incoming data is less than a line or does not end on a line boundary, then an input port must pad the line with dummy-padding slices that can later be identified on the read path and removed accordingly. This guarantees that when a line is written to single entry in the corresponding unified FIFO, that each memory slice and respective column slice is written with either a data slice or a dummy-padding slice, and thus remains synchronized or in lock step. It should be noted that packets with the worst-case alignment to line boundaries, which are lines that require the maximum amount of dummy-padding slices, do not require additional link bandwidth. The invention provides a dummy-padding indication flag embedded in the current data slice, which obviates the need to actually transmit the dummy-padding slices across the ingress N×M mesh. Based on this scheme, each memory slice and respective memory controller (MC) is able to generate and write a dummy-padding slice to the required memory location.

The worst-case alignment of back-to-back data arriving at L bits/sec, furthermore, may also appear to require additional ingress link bandwidth; however, the invention provides a novel data slice rotation scheme, which transmits the first data slice of the current line on the link adjacent to the last data slice of the previous line, independent of destination queue. The ingress N×M mesh, therefore, does not require overspeed, but the egress port must rotate the data slices back to the original order.

As before mentioned, the operation of each unified FIFO is controlled with read and write pointers, which are located on each memory slice and respective MC. The ingress side of the system owns the corresponding write pointer and infers the read pointer, while the egress side owns the corresponding read pointer and infers the write pointer.

In regard to the ingress side, the following control functions occur every 32 ns to keep up with a line rate of L bits/sec: generation of a physical write address for the current line and respective data slices, update of the corresponding write pointer, and check of the queue depth for admission into the shared memory.

The invention, furthermore, does not require an input port to schedule when a data slice is actually written to the corresponding memory bank, as in the prior art. Since the input port evenly segments the data across the M memory banks, it writes L/M bits/sec to each memory bank. If all N input ports are writing data simultaneously, each memory bank will effectively write data at (L/M)×N bits/sec or L bits/sec, when M=N. Thus, no memory bank is ever over-subscribed under any possible traffic scenario. It should be noted that the aggregate write bandwidth to a single memory slice is only L bits/sec; however, the number of random accesses required is N every minimum data transfer time. An important design consideration of the distributed sliced shared memory is the implementation of a memory structure that meets the fast random access capability required by the invention.

Consider a networking example of a next generation core router with 64 OC192 or ˜10 Gb/s interfaces, where N=64, M=64 and C=1 byte and L=16 GB/s. The worst-case scenario is a 40 byte packet arriving and departing every 40 ns on all 64 input ports and output ports respectively. A 40 byte packet with network related overhead effectively becomes 64 bytes; thus, assume the requirement is to maintain 64 bytes every 32 ns on each input and output port. For this system configuration, the line and data slice size is 64 bytes and 1 byte respectively. This implies that each memory slice, for the worst-case scenario, must provide 64 write accesses and 64 read accesses for the input and output ports respectively. The aggregate memory bandwidth required is 32 Gb/s (2×(64×8)/32)); however, this is not the problem, but rather meeting the high number of random accesses required every 32 ns with currently available DRAM technology.

The invention offers a novel and unique 2-element memory stage that utilizes a novel combination of both high-speed commodity SRAMs with back-to-back random read and write access capability, together with the storage capability of commodity DRAMs, implementing a memory matrix suited to solving the memory access problem described above.

In summary, the ingress side of the invention does not require the input ports writing to a predetermined memory bank based on a load-balancing or fixed scheduling scheme, as the prior art suggests must be done to prevent oversubscribing a memory bank. In addition, the invention does not require burst-absorbing FIFOs in front of each memory bank because a FIFO entry spans M memory banks and is not contained in a single memory bank, which the prior art suggests can result in “pathologic” cases when write pointers synchronize to the same memory bank, and which can result in a burst condition. The invention provides a unique and ideal non-blocking path into shared memory that is highly scalable and requires no additional buffering other than the actual shared memory. This architecture also minimizes the write path control logic to simple internal or external memory capable of storing millions of pointers.

In further summary as to the egress side of the system, the present invention provides a novel read path architecture that, as before mentioned, eliminates the need for a separate control path by taking advantage of the unique distributed shared memory of the invention, which operates in lock-step across M memory slices. The read path architecture of the invention, furthermore, eliminates the need for a per queue packet storage on each output port, which significantly reduces system latency and minimizes jitter on the output line. By not requiring a separate control path and per queue packet storage on the output port, the architecture of the invention is significantly more scalable in terms of number of ports and queues.

A single output port receives L/M bits/sec from each of the M memory slices through the N×M egress mesh to achieve L bits/sec output line rate. Each memory controller residing on a memory slice has a time-division-multiplexing (TDM) algorithm that gives N output ports equal read bandwidth to the connected memory banks. A single traffic manager (TM) resides on or is associated with each memory slice and is dedicated to a single output port. The egress side of the traffic manager (eTM) generates read request messages to M memory controllers, specifying the queue and number of lines to read, based on the specified per queue rate allocation. Each memory controller services the read request messages from N eTMs in their corresponding TDM slots. Similar to the write path, a line comprised of M data slices is read from the same predetermined address location across the M memory slices and respective memory bank column slices of the corresponding unified FIFO. The state of the queue is identical and in lock step across all M memory slices because each memory slice reads either a data slice or dummy-padding slice from the same FIFO entry. Each data slice or dummy-padding slice is ultimately returned through the egress N×M mesh to the corresponding output ports.

The egress traffic manager (eTM) in its application to the invention, moreover, takes advantage of the unique and novel lockstep operation of the memory slices that guarantees that the state of a queue is identical across all M memory slices. The operation of each unified FIFO is controlled with read and write pointer located across the M memory slices and respective MCs, operating in lock step. The ingress port owns the corresponding write pointer and infers the read pointer, while the egress port owns the corresponding read pointer and infers the write pointer.

With regard to the egress side, each traffic manager monitors its local memory controller (MC) for read and write operations to its own queues. This information is used to infer that a line has been read or written across the M memory banks—herein defined as an inferred line read, and an inferred line write operation. Each egress traffic manager owns the read pointer and infers the state of the write pointer for each of its queues, and updates the corresponding pointers based on the inferred operations, accordingly. For example, if an inferred line write operation is detected in the local MC, the corresponding write pointer is incremented. Similarly, if an inferred line read operation is detected in the local MC, the corresponding read pointer is incremented. The per queue line count is a function of the difference between the corresponding pointers. An alternate approach is to directly either increment or decrement each line count when the corresponding inferred line operations are detected.

Thus, the eTM determines the full and empty state of a queue by the corresponding pointers and line count. This information is also used to infer the approximate number of bytes in a queue for bandwidth management functions. The eTM updating queue state information directly from the MC is actually a non-blocking enqueue function. This novel operation eliminates the need for the traffic managers to exchange control information, and obviates the need for a separate control plane between TMs, as required by prior arts.

In operation, the eTM makes a decision to dequeue X lines from a queue based on the scheduling algorithm, assigned allocated rate, and estimated number of bytes in the queue. The eTM generates a read request message, which includes a read address derived from the corresponding read pointer, which is broadcast to all M memory slices and corresponding memory controllers. It should be noted that reading the same physical address location from each memory slice is equivalent to reading a single line or entry from the corresponding unified sliced FIFO. It should also be noted that the read request messages do not require a separate control plane to reach the M memory slices, but will rather traverse the ingress N×M mesh with an in-band protocol. This has before been pointed out in connection with the system partitioning section.

Another issue that limits the read path in prior art systems, is a requirement to have per queue packet storage on the output port because data is dequeued from the memory without knowledge of packet boundaries. Incomplete packets, therefore, must wait to be completed in this per queue packet storage, which may result in a significant increase in system latency, and jitter on the output line. This also significantly limits scalability in terms of numbers of queues.

In accordance with the present invention, on the other hand, the ability is provided to dequeue data on packet boundaries and thus eliminate the need for per queue packet storage on the output port. The input port embeds a count that is stored in memory with each data slice, termed a continuation count. A memory controller uses this count to determine the number of additional data slices to read in order to reach the next continuation count or end of the current packet. The continuation count is comprised of relatively few bits because a single packet can have multiple continuation counts.

Each MC has a read request FIFO per output port, which is serviced in the corresponding output ports TDM time-slot. A read request specifies the number of lines from a queue the corresponding eTM requested, based on the specified dequeue bit-rate. The per output port read request FIFO guarantees that the same read request is serviced across the M memory slices in the same corresponding TDM time-slot. A single read request generates multiple physical reads up to the number of lines requested. The MC continues to read from the same queue based on the continuation count until the end of the current packet is reached. Again, this occurs in the corresponding output ports TDM time-slot. It should be noted that for unaligned packets, all M memory slices still read the same number of data slices, because of the dummy-padding slices inserted by the corresponding ingress port.

Furthermore, there are no read pointer coherency issues as a result of the M memory slices and respective MCs reading beyond the X lines requested by the eTM. This is because the corresponding read pointer and line count is updated by the actual number of inferred line read operations monitored by the corresponding eTM in the local MC. Finally, the eTM also adjusts its bandwidth accounting, based on the actual lines returned and the actual number of bytes in the dequeued packet.

In conclusion, the present invention is able to provide close to ideal quality of service (QOS), by guaranteeing packets are written to memory with no contention , minimal latency and independent of incoming rate and destination; and furthermore, guaranteeing any output port can dequeue up to line rate from any of its queues, again independent of the original incoming packet rate and destination. In such a system the latency and jitter of a data packet are based purely on the occupancy of the destination queue at the time the packet enters the queue, the desired dequeue or drain rate onto the output line, and the desired order of queue servicing.

### Simulation Model and Test Results

The invention, as described, has been accurately modeled and computer simulated as a proof of concept exercise. A 64-port networking system was modeled as a physically distributed, logically shared, and data slice-synchronized shared memory switch. The following is a description of the model, simulation environment, tests and results.

The system that is modeled comprises 64 full-duplex OC192 or 9.584 Gb/s interface line cards, where each line card contains both ingress and egress ports, and one slice of the memory (N=M=64). The 64 cards or slices are partitioned into 4 egress groups, with each group containing 16 ports and 16 memory slices. For this system configuration, a line is comprised of 16 data slices, with a data slice and line size of 6 bytes and 96 bytes respectively. Each egress port has 4 QOS levels, 0, 1, 2 and 3, where QOS level 0 is the highest priority and QOS level 3 is the lowest priority. Each QOS level has a queue per ingress port for a total of 16384 (64×64×4) queues in the system.

The architectural model is a cycle-accurate model that validates the architecture as well as generates performance metrics. The system model consists of a number of smaller models, including the ingress and egress traffic manager (TM), memory controller (MC), QDR SRAM, RLDRAM, and ingress and egress network processor unit (NPU). The individual models are written using C++ in the SystemC environment. SystemC is open-source software that is used to model digital hardware and consists of a simulation kernel that provides the necessary engine to drive the simulation. SystemC provides the necessary clocking and thread control, furthermore, to allow modeling parallel hardware processes. If the C++ code models the behavior at a very low level, then the cycle-by-cycle delays are accurately reproduced.

Each C++ model contains code that represents the behavior of the hardware. Each model, in addition, also contains verification code so that the whole system is self-checking for errors. The results of the simulations are extracted from log files that are generated during the simulation. The log files contain the raw information that documents the packet data flowing through the system. After the simulation, scripts are used to extract the information and present the delay and rate information for any port and any flow of data through any queue.

Utilizing the C++ SystemC approach, the model emulates all aspects of the inventions non-blocking read and write path, including memory bandwidth (read and write access) and storage of the QDR SRAM and RLDRAM elements, link bandwidth of the ingress and egress N×M meshes, state-machines and pipeline stages required by the MC and TM chips. Furthermore, all aspects of the invention inferred control path are also modeled, including inferred read and write pointer updates, line count updates, enqueue and dequeue functions, and request generation. In fact, enough detail exists in the model, that implementation of such a system can use the C++ code as a detailed specification.

It should be noted that this model assumes that the network processor unit (NPU) can maintain line-rate for 40 byte packets on both the ingress and egress datapath. The NPU pipeline delays are not included in the latency results because this is not considered part of the packet switch sub-system. The additional latency introduced by an NPU for a particular end application can be directly added to the following test results to get final system latency numbers.

### Premium Traffic in the Presence of Massive Over-subscription (64-Ports to 1-Port Test)

The purpose of the first set of tests is to demonstrate the QOS capability of the invention in the presence of massive over-subscription. To create the worst-case over-subscription traffic scenario, 64 ingress ports are enabled to send 100% line-rate to a single egress port, for an aggregate traffic load of 6400% or ˜640 Gb/s. (It should be noted that all percentages given are a percentage of OC192 line-rate or 9.584 Gb/s.) The first test demonstrates a single egress port preserving 10% premium traffic in the presence of over-subscription. Similarly, the second test demonstrates a single egress port preserving 90% premium traffic in the presence of over-subscription. The premium traffic sent to QOS level 0 is comprised of 40 byte packets, and the background traffic sent to QOS levels 1, 2 and 3 is comprised of standard Internet Imix, defined as a mixture of 40 byte, 552 byte, 576 byte and 1500 byte packets.

The first test enables each ingress port to send an equal portion of the 10% premium traffic to the egress port under test. Each ingress port, therefore, will send a 40 byte packet stream of 10/64% to the egress port under test, for an aggregate premium traffic load of 64×10/64% or 10%. Each ingress port will utilize the remaining ingress bandwidth to send Imix traffic sprayed at random across QOS levels 1, 2 and 3 of the egress port under test, for an aggregate background traffic load of 6390%. In summary, the first test sends the egress port under test, 10% premium traffic of 40 byte packets to the corresponding queues in QOS level 0, and 6390% of background Imix traffic to the corresponding queues in QOS levels 1, 2 and 3.

Similarly, the second test enables each ingress port to send an equal portion of the 90% premium traffic to the egress port under test. Each ingress port, therefore, will send a 40 byte packet stream of 90/64% to the egress port under test, for an aggregate premium traffic load of 64×90/64% or 90%. Again, each ingress port will utilize the remaining ingress bandwidth to send Imix traffic sprayed at random across QOS levels 1, 2 and 3 of the egress port under test, for an aggregate background traffic load of 6310%. In summary, the second test sends the egress port under test, 90% premium traffic of 40 byte packets to the corresponding queues in QOS level 0, and 6310% of background Imix traffic to the corresponding queues in QOS levels 1, 2 and 3. All tests were run for 1.25 million clock cycles (10 milliseconds). The following tables contain the test results. (Note that NA refers to not applicable table entries.)

(Test 1) 10% premium traffic in the
presence of 6400% traffic load

| | | Egress | Average | Worst-Case |
|---|---|---|---|---|
| Port under | | (Port 0) | Latency | Latency |
| Test (Egress | Ingress | (Worst-case) | (Measured) | (Measured) |
| Port 0) | Traffic | (Measured) | (Micro-sec) | (Micro-sec) |
| QOS level 0 | 10% | 10% | 2.18 us | 9.11 us |
| queues | | | | |
| QOS level 1, | 6390% | 89.9% | Backlogged | Backlogged |
| 2, 3 queues | | | | |
| Aggregate | 6400% | 99.9% | NA | NA |
| bandwidth | | | | |

(Test 2) 90% premium traffic in the
presence of 6400% traffic load

| | | Egress | Average | Worst-Case |
|---|---|---|---|---|
| Port under | | (Port 0) | Latency | Latency |
| Test (Egress | Ingress | (Worst-case) | (Measured) | (Measured) |
| Port 0) | Traffic | (Measured) | (Micro-sec) | (Micro-sec) |
| QOS level 0 | 90% | 90% | 1.52 us | 9.36 us |
| queues | | | | |
| QOS level 1, | 6310% | 9.9% | Backlogged | Backlogged |
| 2, 3 queues | | | | |
| Aggregate | 6400% | 99.9% | NA | NA |
| bandwidth | | | | |

The results from this set of tests demonstrate that the 10% and 90% premium traffic streams sent to QOS level 0 are not effected in the presence of the massively oversubscribed background Imix traffic sent to QOS levels 1, 2 and 3. The oversubscribed queues fill up and drop traffic (shown as backlogged on the results table); however, the corresponding queues in QOS level 0 do not drop any traffic. In other words, the premium traffic receives the required egress bandwidth to maintain a low and bounded latency through the system. This also demonstrates queue isolation between the QOS levels. The remaining egress bandwidth, furthermore, is optimally utilized by sending background Imix traffic from QOS levels 1, 2 and 3, such that the aggregate egress bandwidth is ˜100%.

It should be noted, that the difference between the average latency and the worst-case latency is due to the multiplexing delay of the background traffic onto the output line, which must occur at some point, and is not due to the invention. (Note that 1500 byte Imix packets in the corresponding queues for QOS levels 1, 2 and 3 result in the worst-case multiplexing delay.) It should also be noted that the 10% premium traffic has a slightly higher average latency due to the higher percentage of background traffic multiplexing delay onto the output line, compared to the 90% premium traffic scenario.

In conclusion, the invention provides low and bounded latency for the premium traffic in QOS level 0, while still maintaining ˜100% output line utilization with traffic from QOS levels 1, 2 and 3. The invention QOS capability is close to ideal, especially considering that the prior art may have latency in the millisecond range depending on the output line utilization, which may have to be significantly reduced to provide latency in the microsecond range.

### Premium Traffic in the Presence of Over-subscription on Multiple Ports (64-Ports to 16-Ports Test)

The purpose of the second set of tests is to demonstrate the QOS capability of the invention on multiple egress ports in the presence of over-subscription. To create the over-subscribed traffic scenario, 64 ingress ports are enabled to send 100% line-rate to 16 egress ports, for an aggregate traffic load of 400% or ˜40 Gb/s per egress port. The first test demonstrates each of the 16 egress ports preserving 10% premium traffic in the presence of over-subscription. Similarly, the second test demonstrates each of the 16 egress ports preserving 90% premium traffic in the presence of over-subscription. Again, the premium traffic sent to QOS level 0 is comprised of 40 byte packets, and the background traffic sent to QOS levels 1, 2 and 3 is comprised of standard Internet Imix, defined as a mixture of 40 byte, 552 byte, 576 byte and 1500 byte packets, as before-mentioned.

It should be noted that the number of egress ports under test is not arbitrary, but chosen because this particular implementation of the invention has 4 egress groups with 16 egress ports per group. The architecture of the invention guarantees that each egress group operates independently of the other groups. A single egress group, therefore, is sufficient to demonstrate the worst-case traffic scenarios. In addition, 64 ingress ports sending data to 16 egress ports, provides the test with significant over-subscription.

The first test enables each ingress port to send an equal portion of the 10% premium traffic to each egress port under test. Each ingress port, therefore, will send a 40 byte packet stream of 10/64% to each of the 16 egress ports under test, for an aggregate premium traffic load of 64×10/64% or 10% per egress port. Each ingress port will utilize the remaining ingress bandwidth to send Imix traffic sprayed at random across QOS levels 1, 2 and 3 of the 16 egress ports under test, for an aggregate background traffic load of 390% per egress port. In summary, the first test sends each of the 16 egress ports under test, 10% premium traffic of 40 byte packets to the corresponding queues in QOS level 0, and 390% of background Imix traffic to the corresponding queues in QOS levels 1, 2 and 3.

Similarly, the second test enables each ingress port to send an equal portion of the 90% premium traffic to each egress port under test. Each ingress port, therefore, will send a 40 byte packet stream of 90/64% to each of the 16 egress ports under test, for an aggregate premium traffic load of 64×90/64% or 90% per egress port. Again, each ingress port will utilize the remaining ingress bandwidth to send Imix traffic sprayed at random across QOS levels 1, 2 and 3 of the 16 egress ports under test, for an aggregate background traffic load of 310% per egress port. In summary, the second test sends each of the 16 egress ports under test, 90% premium traffic of 40 byte packets to the corresponding queues in QOS level 0, and 310% of background Imix traffic to the corresponding queues in QOS levels 1, 2 and 3.

The following tables contain the test results. It should be noted that in order to simplify reading and interpreting the results, the measured egress bandwidth is the average across all of the 16 egress ports. The premium traffic worst-case latency is the absolute worst-case across all of the 16 egress ports. Furthermore, the premium traffic average latency is the average taken across all of the 16 egress ports.

(Test 1) 10% premium traffic in the presence of 400% traffic load

| | | Egress | Average | Worst-Case |
|---|---|---|---|---|
| Port under | Ingress | (Port 0-15) | Latency | Latency |
| Test (Egress | Traffic Per | (Worst-case) | (Measured) | (Measured) |
| Port 0-15) | Egress Port | (Measured) | (Micro-sec) | (Micro-sec) |
| QOS level 0 | 10% | 10% | 2.48 us | 9.18 us |
| queues | | | | |
| QOS level 1, | 390% | 89.98% | Backlogged | Backlogged |
| 2, 3 queues | | | | |
| Aggregate | 400% | 99.98% | NA | NA |
| bandwidth | | | | |

(Test 2) 90% premium traffic in the presence of 400% traffic load

| | | Egress | Average | Worst-Case |
|---|---|---|---|---|
| Port under | Ingress | (Port 0-15) | Latency | Latency |
| Test (Egress | Traffic Per | (Worst-case) | (Measured) | (Measured) |
| Port 0-15) | Egress Port | (Measured) | (Micro-sec) | (Micro-sec) |
| QOS level 0 | 90% | 90% | 1.54 us | 9.27 us |
| queues | | | | |
| QOS level 1, | 310% | 9.99% | Backlogged | Backlogged |
| 2, 3 queues | | | | |
| Aggregate | 400% | 99.99% | NA | NA |
| bandwidth | | | | |

Similar to the results from the first set of tests, the current tests demonstrate that the 10% and 90% premium traffic streams sent to QOS level 0 are not affected in the presence of the oversubscribed background Imix traffic sent to QOS levels 1, 2 and 3 for each of the 16 egress ports under test. The over-subscribed background traffic results in causing the corresponding queues in QOS levels 1, 2 and 3 to fill up and drop traffic; however, the corresponding queues in QOS level 0 do not drop any traffic. In other words, the premium traffic receives the required egress bandwidth to maintain a low and bounded latency through the system. The remaining egress bandwidth, furthermore, is optimally utilized by sending background Imix traffic from QOS levels 1,2 and 3, such that the aggregate egress bandwidth is ˜100% for each of the egress ports under test.

While the first set of tests demonstrated QOS on a single port and queue isolation, the current tests demonstrate QOS on multiple egress ports and port isolation. In fact, the throughput and worst-case latency measured across the 16 egress ports closely match the previous results from the single egress port tests for both the 10% and 90% premium traffic scenarios. This truly demonstrates the capability of the invention to provide queue and port isolation required for ideal QOS. This also shows the capability of the invention to scale to multiple ports and still provide the same QOS as a single port.

It should be noted, as before-mentioned, that the difference between the average latency and the worst-case latency is due to the background traffic multiplexing delay onto the output line, which must occur at some point, and is not due to the invention. (Note that QOS levels 1, 2 and 3 may all contain 1500 byte Imix packets, which is the cause of the worst-case multiplexing delay.) It should also be noted that the 10% premium traffic has a slightly higher average latency due to the higher percentage of background traffic multiplexing delay onto the output line, compared to the 90% premium traffic scenario.

In conclusion, the invention provides low and bounded latency for the premium traffic in QOS level 0, while still maintaining ˜100% output line utilization with traffic from QOS levels 1, 2 and 3 across multiple egress ports. The invention QOS capability is close to ideal and scales to multiple ports, especially considering that the prior art may have QOS degradation due to latency and output utilization variations depending on the number of active queues and ports.

### Premium Traffic in the Presence of Temporary Burst Conditions On All Ports (64-Ports to 64-Ports Test)

The purpose of the third set of tests is to demonstrate the QOS capability of the invention on all 64 egress ports in the presence of burst conditions. To create the burst traffic, 64 ingress ports are enabled to send 100% line-rate to 64 egress ports, for an aggregate traffic load of 100% or ˜10 Gb/s per egress port. The burst conditions, however, occur naturally due to the at-random spraying of the background Imix traffic to QOS levels 1, 2 and 3 of all egress ports. The first test demonstrates each of the 64 egress ports preserving 10% premium traffic in the presence of burst conditions. Similarly, the second test demonstrates each of the 64 egress ports preserving 90% premium traffic in the presence of burst conditions. Again, the premium traffic sent to QOS level 0 is comprised of 40 byte packets, and the background traffic sent to QOS levels 1, 2 and 3, is comprised of standard Internet Imix, defined as a mixture of 40 byte, 552 byte, 576 byte and 1500 byte packets, as before-mentioned.

It should be noted that sustained over-subscription from 64 ingress ports to 64 egress ports can only be demonstrated with loss of throughput on some egress ports, based on the percentage of over-subscription required. A burst traffic profile, therefore, is more desirable, in order to demonstrate QOS on all 64 ports simultaneously and with full output line rate. This set of tests takes advantage of the fact that the background traffic is sprayed at random to QOS levels 1, 2 and 3 across all 64 egress ports, which generates the required test temporary burst conditions; however, over a period of time, all 64 egress ports will also receive the same amount of average traffic load, which is required to show full output line rate on all 64 egress ports.

The first test enables each ingress port to send an equal portion of the 10% premium traffic to each egress port under test. Each ingress port, therefore, will send a 40 byte packet stream of 10/64% to each of the 64 egress ports under test, for an aggregate premium traffic load of 64×10/64% or 10% per egress port. Each ingress port will utilize the remaining ingress bandwidth to send Imix traffic sprayed at random across QOS levels 1, 2 and 3 of the 64 egress ports under test, for an aggregate background traffic load of 90% per egress port. The random nature of the background traffic, however, will create temporary burst conditions to QOS levels 1, 2 and 3, as previously described. Therefore, at times, each egress port will experience more or less background traffic than the average 90%. In summary, the first test sends each egress port under test, 10% premium traffic of 40 byte packets to the corresponding queues in QOS level 0, and an average of 90% background Imix traffic to the corresponding queues in QOS levels 1, 2 and 3.

Similarly, the second test enables each ingress port to send an equal portion of the 90% premium traffic to each egress port under test. Each ingress port, therefore, will send a 40 byte packet stream of 90/64% to each of the 64 egress ports under test, for an aggregate premium traffic load of 64×90/64% or 90% per egress port. Again, each ingress port will utilize the remaining ingress bandwidth to send Imix traffic sprayed at random across QOS levels 1, 2 and 3 of the 64 egress ports under test, for an aggregate background traffic load of 10% per egress port. As previously explained, the random nature of the background traffic will create temporary burst conditions to QOS levels 1, 2 and 3. In summary, the second test sends each egress port under test, 90% premium traffic of 40 byte packets to the corresponding queues in QOS level 0, and an average of 10% background Imix traffic to the corresponding queues in QOS levels 1, 2 and 3.

The following tables contain the test results. It should be noted that in order to simplify reading the results, the measured egress bandwidth is again the average across all of the 64 egress ports. The premium traffic worst-case latency is the absolute worst-case, while the average latency is the average across all of the 64 egress ports.

(Test 1) 10% premium traffic in the
presence of ˜100% traffic load

| | Ingress | Egress | Average | | Worst-Case | |
|---|---|---|---|---|---|---|
| Port under | Traffic | (Port 0-63) | Latency | | Latency | |
| Test (Egress | To each | (Worst-case) | (Measured) | | (Measured) | |
| Port 0-63) | Egress Port | (Measured) | (Micro-sec) | | (Micro-sec) | |
| QOS level 0 | 10% | 10% | 2.1 | us | 9.12 | us |
| queues | | | | | | |
| QOS level 1 | 30% | 30% | 2.3 | us | 9.5 | us |
| queues | | | | | | |
| QOS level 2 | 29.9% | 29.9% | 2.6 | us | 49 | us |
| queues | | | | | | |
| QOS level 3 | 29.6% | 29.6% | 45.5 | us | 998 | us |
| queues | | | | | | |

| | | | | |
|---|---|---|---|---|
| Aggregate | 99.5% | 99.5% | NA | NA |
| bandwidth | | | | |

(Test 2) 90% premium traffic in the
presence of ˜100% traffic load

| | Ingress | Egress | Average | | Worst-Case | |
|---|---|---|---|---|---|---|
| Port under | Traffic | (Port 0-63) | Latency | | Latency | |
| Test (Egress | To each | (Worst-case) | (Measured) | | (Measured) | |
| Port 0-63) | Egress Port | (Measured) | (Micro-sec) | | (Micro-sec) | |
| QOS level 0 | 90% | 90% | 1.54 | us | 9.5 | us |
| queues | | | | | | |
| QOS level 1 | 3.2% | 3.2% | 1.81 | us | 112 | us |
| queues | | | | | | |
| QOS level 2 | 3.3% | 3.3% | 4.8 | us | 326 | us |
| queues | | | | | | |
| QOS level 3 | 3.1% | 3.1% | 18.6 | us | 995 | us |
| queues | | | | | | |

| | | | | |
|---|---|---|---|---|
| Aggregate | 99.6% | 99.6% | NA | NA |
| bandwidth | | | | |

Similar to the results from the first and second set of tests, the current tests demonstrate that the 10% and 90% premium traffic streams sent to QOS level 0 are not effected in the presence of the background Imix traffic bursts sent to QOS levels 1, 2 and 3, for each of the 64 egress ports under test. In fact, the average and worst-case latency results for the current test correlate very closely with all the previous test results for 10% and 90% premium traffic respectively. The current test, however, does not oversubscribe QOS levels 1, 2 and 3 like the previous sets of tests, but instead generates background traffic bursts, such that the average traffic load is ˜100%, as before-mentioned. This implies that an ideal switching architecture would be able to absorb all bursts in the corresponding queues, provided of course a burst to a queue does not exceed the queue depth, and fill the output line to 100% without dropping any packets. This is what the current test results show are indeed the characteristics of the present invention. The latency for the higher QOS levels are low and bounded because the corresponding queues are guaranteed to be serviced first before the corresponding queues in the lower priority QOS levels; however, since the average aggregate ingress and egress bandwidth is matched, and the low priority queues are guaranteed to be serviced at some point, the low priority queues will not drop any packet, but, of course, experience high latencies.

This test is a good example of a converged network application of the invention, where premium revenue generating voice, video and virtual private network traffic may be carried on the same network as Internet traffic. The higher QOS levels guarantee throughput and low latency for voice and video packets, while lower QOS levels may guarantee throughput and delivery of data transfers, for example, for a virtual private network, which may not require latency guarantees. The lowest QOS level may be used for Internet traffic, which does not require either latency or throughput guarantees because dropped packets are retransmitted through the network on alternate paths; therefore the lowest priority QOS levels may be left unmanaged and oversubscribed. If premium services are not currently using all the egress bandwidth, then more bandwidth can be given to the lower QOS levels, such that the output is always operating at ˜100%. A network comprised of networking systems with ideal QOS, such as the present invention, would significantly minimize operating and capital expenses because a single network infrastructure would carry all classes of traffic. Furthermore, link capacity between systems would be fully utilized reducing the cost per mile to maintain and light fiber optics.

In conclusion, this simulation model, tests and results demonstrate the earlier-presented claims that the invention provides a switching architecture that can provide ideal QOS, and, moreover, can to do so with practical implementation in current technology.

Further modifications will also occur to those skilled in this art, including the various possible locations of the memory controllers, traffic managers, etc. on or separate from the line cards, and such are considered to fall within the spirit and scope of the invention as defined in the appended claims

What is claimed is:

1. A method of non-blocking output-buffered switching of time-successive lines of input data streams along a data path between N input and N output data ports provided with corresponding respective ingress and egress data line cards, and wherein each ingress data port line card receives L bits of data per second of an input data stream to be fed to M memory slices and written to the corresponding memory banks and ultimately read by the corresponding output port egress data line cards, the method comprising,
creating a physically distributed logically shared memory datapath architecture wherein each line card is associated with a corresponding memory bank, a memory controller and a traffic manager;
connecting each ingress line card to its corresponding memory bank and also to the memory bank of every other line card through an N×M mesh, providing each input port ingress line card with data write access to all the M memory banks, and wherein each data link provides L/M bits per second path utilization;
connecting the M memory banks through an N×M mesh to egress line cards of the corresponding output data ports, with each memory bank being connected not only to its corresponding output port but also to every other output port as well, providing each output port egress line card with data read access to all the M memory banks;
segmenting each of the successive lines of each input data stream at each ingress data line card into a row of M data segment slices along the line;
partitioning data queues for the memory banks into M physically distributed separate column slices of memory data storage locations or spaces, one corresponding to each data segment slice;
writing each such data segment slice of a line along the corresponding link of the ingress N×M mesh into its corresponding memory bank column slice at the same predetermined corresponding storage location or space address in its respective corresponding memory bank column slices as the other data segment slices of the data line occupy in their respective memory bank column slice, whereby the writing-in and storage of the data line slices occurs in lockstep as a row across the M memory bank column slices; and
writing the data segment slices of the next successive data line into their corresponding memory bank column slices at the same queue storage location or space address thereof adjacent the storage location or space row address in that memory bank column slice of the corresponding data segment slice already written in from the preceding input data stream line.

2. The method of claim 1 wherein the data-slice writing into memory is effected simultaneously for the slices in each line, and the slice is controlled in size for load-balancing across the M memory banks.

3. The method of claim 2 wherein each of the data lines is caused to have the same line width.

4. The method of claim 3 wherein, in the event any line lacks sufficient data slices to satisfy this width, padding a line with dummy-padding slices sufficient to achieve the same line width and to enable said lockstep storage.

5. The method of claim 1 wherein the architecture of the distributed lockstep memory bank storage is operated to resemble the operation of a single logical FIFO per data queue of width spanning the M memory banks and with a write bandwidth of L bits/second.

6. The method of claim 1 wherein said architecture is integrated with a distributed data control path that enables the respective line cards to derive respective data queue pointers for en-queuing and de-queuing functions.

7. The method of claim 6 wherein, at the egress side of the distributed data control path, each traffic manager monitors its own read and write pointers to infer the status of the respective queues since the lines that comprise the queue span the M memory banks.

8. The method of claim 7 wherein there is provided monitoring of the read and write of the data slices at the corresponding memory bank to provide an architecture for inferring of the line count on the data slice that is current for a particular queue.

9. The method of claim 8 wherein the integrating of the distributed control path with the distributed shared memory architecture enables the traffic managers of the respective egress line cards to provide for quality of service in maintaining data allocations and bit-rate accuracy, and for each of re-distributing unused bandwidth for full output line-rate, and for adaptive bandwidth scaling.

10. The method of claim 1 wherein each queue of the physically distributed column slices is unified across the M memory slices in the sense that the addressing of all the data segment slices of a queue is identical across all the memory bank column slices for the same line.

11. The method of claim 4 wherein the padded data written into memory ensures that the state of a queue is identical for all M memory slices, with read and write pointers derived from the respective line cards being identical across all the M memory slices.

12. The method of claim 6 wherein the ingress side of the distributed control path maintains write pointers for the queues dedicated to that input port, and in the form of an array index by the queue number.

13. The method of claim 12 wherein a write pointer is read from the array based on the queue number and then incremented by the total line count of data transfer, and then written back to the array within a time of minimum data transfer adapted to keep up with L bits/second.

14. The method of claim 1 wherein each output port is provided with a queue per input port per class of service, thereby eliminating any requirement for a queue to have more than L bits/second of write bandwidth, and thereby enabling delivery of ideal quality of service in terms of bandwidth with low latency and jitter.

15. The method of claim 6 wherein the memory bank is partitioned into multiple memory column slices with each memory slice containing all of the columns from each corresponding queue and receiving corresponding multiple data streams from different input ports.

16. The method of claim 15 wherein read and write pointers for a single queue are matched across all the M memory slices and corresponding multiple memory column slices, with the multiple data streams being written at the same time, and with each of the multiple queues operating independently of one another.

17. The method of claim 16 wherein at the output ports, each memory slice reads thereto up to N data slices, one for each of the corresponding output ports during each time-successive output data line, with corresponding multiple data slices, one for each of the multiple queues, being read out to their respective output ports.

18. The method of claim 16 wherein, as the data from the multiple queues is read out of memory, each output port is supplied with the necessary data to maintain line rate on its output.

19. The method of claim 1 wherein, in the non-blocking write datapath from the input ports into the shared memory bank slices, the non-blocking is effected regardless of the input data traffic rate and output port destination, providing a nominal, close to zero, latency on the write path into the shared memory banks.

20. The method of claim 6, wherein in the non-blocking read data path from the shared memory slices to the output ports, the non-blocking is effected regardless of data traffic queue rates up to L bits/second per port and independently of the input data packet rate.

21. The method of claim 20 wherein contention between the N output ports is eliminated by providing each output port with equal read access from each memory slice, guaranteeing L/M bits/second from each memory slice for an aggregate bandwidth of L bits/second.

22. The method of claim 8 wherein the inferring of the line count on the data slice provides a non-blocking inferred control path that permits the traffic manager to infer the read and write pointer of the corresponding queue at the egress to provide ideal QOS.

23. The method of claim 1 wherein a non-blocking matrix of the two-element memory stage for the memory banks is provided to guarantee a non-blocking write path from the N input ports and a non-blocking read path from the N output ports.

24. The method of claim 23 wherein the two-element memory stage is formed of an SRAM memory element enabling temporary data storage therein that builds blocks of data on a per queue basis, and a relatively low speed DRAM memory element for providing primary data packet buffer memory.

25. The method of claim 1 wherein for J read and write accesses of size D data bits every T nanoseconds, and a requirement to transmit or receive P data bits every T nanoseconds, a matrix memory organization of (N×N)/(J/2 ×J/2) memory banks is pointed on each of the memory slices, providing a bandwidth of each link of L bits/second divided by the number M of memory slices, where M is defined as P/D.

26. The method of claim 25 wherein the memory organization can be varied by changing the number of memory banks on a single memory slice, trading-off additional links and memory slices.

27. The method of claim 25 wherein the number of ingress links, egress links and memory banks per memory slice are balanced to achieve the desired card real estate, backplane connectivity and implementation.

28. The method of claim 27 wherein such balancing is achieved by removing rows and respective output ports from the N×N matrix to reduce the number of memory banks per memory slice, while increasing the number of memory slices and ingress links and maintaining the number of egress links.

29. The method of claim 27 wherein such balancing is achieved by removing columns and respective ingress ports from the N×N matrix to reduce the number of memory banks per memory slice, increasing the number of memory slices and egress links while maintaining the number of ingress links.

30. The method of claim 4 wherein link bandwidth is not consumed by dummy-padding slices through the placing of the first data slice of the current incoming data line on the link adjacent to the link used by the last data slice of the previous data line, such that the data slices have been rotated within a line.

31. The method of claim 30 wherein a control bit is embedded with the starting data slice to indicate to the egress how to rotate the data slices back to the original order within a line, and a second control bit is embedded with each data slice to indicate if a dummy-padding slice is required for the subsequent line.

32. The method of claim 31 wherein, when a dummy-padding slice is to be written to memory based on the current data slice, said control bit indicates that a dummy-padding slice is required at the subsequent memory slice address and with no requirement of increased link bandwidth.

33. The method of claim 1 wherein the write pointers reside on the memory slice, insuring that physical addresses are never sent on the N×M ingress or egress meshes.

34. The method of claim 33 wherein a minimal queue identifier is transmitted with each data slice to store the data slice into the appropriate location address in the memory slice, while only referencing the queues of the respective current ingress port.

35. The method of claim 24 wherein, when the two-element memory stage is transferring a relatively slow wide block transfer from the SRAM to the DRAM, data slices are accordingly written to the SRAM at a location address based on a minimal queue identifier, permitting address generation to reside on the memory controller and not on the input ports and obviating a high address look-up rate on the controller.

36. The method of claim 35 wherein, when N=M, said memory controller does not require knowledge of the physical address until said transferring of a block of data from the SRAM to the DRAM.

37. The method of claim 36 wherein the SRAM is selected as QDR SRAM and the DRAM is selected as RLDRAM.

38. The method of claim 8 wherein the traffic manager of each output port derives inferred write pointers by monitoring the memory controller for writing to its own queues based on the current state of the read and write pointers, and deriving inferred read pointers by monitoring the memory controller for read operations to its own queues.

39. The method of claim 9 wherein in the egress data path of each output port, the egress traffic manager is integrated into the egress data path through the inferred control architecture, enqueuing of data from the corresponding memory slice to the egress traffic manager and scheduling the same while managing the bandwidth, request generation and reading from memory, and then updating the corresponding originating input port.

40. The method of claim 39 wherein during said enqueuing of data from each egress traffic manager from its own memory slice, each egress traffic manager infers from the ingress and egress data path activity on its own corresponding memory slice, the state of its queues across the M memory banks.

41. The method of claim 40 wherein said egress traffic manager, while enqueuing, monitors an interface to the corresponding memory controller for queue identifiers representing write operations for its queues, and counting and accumulating the number of write operations to each of its queues, thereby calculating the corresponding line counts and write pointers.

42. The method of claim 41 wherein the egress traffic manager residing on each memory slice provides QOS to its corresponding output port by determining precisely when and how much data should be dequeued from each of its queues, basing such determining on a scheduling algorithm, a bandwidth management algorithm and the latest information of the state of the queues of each egress traffic manager.

43. The method of claim 40 wherein output port time slots are determined by read request from the corresponding egress traffic manager, and upon the granting of read access to an output port, processing the corresponding read requests, and thereupon transmitting the data slices to the corresponding output port.

44. The method of claim 43 wherein there is embedding of a continuation count for determining the number of further data slices necessary to read in order to reach the end of a current data packet, thereby allowing each egress traffic manager to dequeue data on the boundaries of the data packet to its corresponding output port.

45. The method of claim 43 wherein each ingress traffic manager monitors read operations to its dedicated queues to infer the state of its read pointers, enabling deriving the line count or depth of all queues dedicated to it based on corresponding write pointers and inferred read pointers, and using said depth to determine when to write or drop an incoming data packet to memory.

46. The method of claim 1 wherein, as additional line cards are provided to add to the aggregate memory bandwidth and storage thereof, redistributing the data slices equally amongst all memory slices, utilizing the memory bandwidth and storage of the new memory slices, and reducing the bandwidth to the active memory slices, thereby freeing up memory bandwidth to accommodate data slices from new line cards, such that the aggregate read and write bandwidth to each memory slice is 2×L bits/second, when N=M.

47. The method of claim 46 wherein the queue size, physical location and newly added queues are reconfigured, with hot swapping that supports line cards being removed or inserted without loss of data or disruption of service to data traffic on the active line cards, by the ingress side embedding a control flag with the current data slice, which indicates to the egress side that the ingress side will switch over to a new system configuration at a predetermined address location in the corresponding queue, and to also switch over to the new system configuration when reading from the same address.

48. The method of claim 1 wherein a crosspoint switch is interposed between the links that comprises the N×M ingress and egress meshes to provide connectivity flexibility.

49. The method of claim 1 wherein a time division multiplexer switch is substituted for the N×M ingress and egress meshes and interposed between the input and output ports, providing programmable connectivity between memory slices and the traffic manager while reducing the number of physical links.

50. A method of non-blocking output-buffered switching of time-successive lines of input data streams along a data path between N input and N output data ports provided with corresponding respective ingress and egress data line cards, and wherein each ingress data port line card receives L bits of data per second of an input data stream to be fed to M memory slices and written to corresponding memory banks and ultimately read by corresponding output port egress data line cards, the method comprising, providing a non-blocking matrix of two-element memory stages for the memory banks to guarantee a non-blocking data write path from the N input ports and a non-blocking data read path from the N output ports, wherein the memory stages comprise a combined SRAM memory element enabling temporary data storage therein that builds blocks of data on a per queue basis, and a relatively low speed DRAM main memory element for providing main data packet buffer memory.

51. The method of claim 50 wherein the SRAM element provides fast random access capability required to provide said non-blocking matrix, while the DRAM element provides the queue depth capability to absorb data including during bursts or times of oversubscribed traffic.

52. The method of claim 51 wherein the SRAM element performs a data cache function, always directly accessed by the connected ingress and egress ports, which do not directly access the DRAM element, such that the cache always stores the head of each data queue for the connected egress ports to read from, and the tail of each queue for the connected ingress ports to which to write.

53. The method of claim 52 wherein the SRAM cache is partitioned into queues that correspond to queues maintained in the DRAM memory such that said cache and a memory management controller are seamlessly transferring blocks of data between the SRAM-based cache and the DRAM-based main memory, while guaranteeing the connected egress and ingress ports their respective read and write accesses to the corresponding queues every data transfer interval.

54. The method of claim 53 wherein the cache comprises a QDR SRAM-based cache partitioned into primary and secondary regions and with each queue assigned a ring buffer in each region.

55. The method of claim 54 wherein each queue may operate in two modes; a “combined-cache mode” wherein data is written and read in a single ring buffer by the corresponding ingress and egress ports, respectively; and a “split-cache mode” wherein one ring buffer functions as an egress-cache, and the other ring buffer operates as an ingress-cache.

56. The method of claim 55 wherein, in the “combined-cache mode”, the egress port reads from the head of a queue, and the corresponding ingress port writes to the tail of the queue, with said head and tail contained within a single ring buffer.

57. The method of claim 55 wherein, in the “split-cache mode”, said egress-cache is read by the corresponding egress port, and written by a memory controller to transfer blocks of data from the DRAM-based memory, while said ingress-cache is written by the corresponding ingress port and read by the memory controller for block transfers to the DRAM-based memory, with the head and tail of the queue stored in the two separate ring buffers.

58. The method of claim 57 wherein the head of the queue is contained in the egress-cache, and the tail is contained in the ingress-cache, with the intermediate queue data stored in the DRAM-based main memory.

59. The method of claim 55 wherein, upon the advent of an oversubscribed queue resulting in a ring buffer fill-up, the memory controller effects switching the mode of the oversubscribed queue from combined-cache mode operation to the split-cache operation, enabling a second ring buffer to allow the corresponding ingress port to write the next incoming data directly to it in a seamless manner, and similarly upon the advent of an undersubscribed queue resulting in a ring buffer running dry, the memory controller effects switching the mode of the undersubscribed queue from split-cache mode operation to the combined-cache operation, disabling the first ring buffer to allow the corresponding egress port to read data directly from the second ring buffer in a seamless manner.

60. The method of claim 55 wherein the memory controller transfers blocks of data from the ingress-cache to the main memory to prevent the corresponding ring buffer from overflowing, and similarly transferring blocks of data from the main memory to the egress-cache to prevent the corresponding ring buffer from running dry.

61. The method of claim 55 wherein during queue operation in the split-cache mode, the memory controller transfers blocks of data in and out of the DRAM main memory to prevent starving corresponding egress ports and to prevent the corresponding ingress ports from prematurely dropping data.

62. The method of claim 61 wherein there is the providing of TDM algorithms to guarantee fairness between ingress ports competing for block transfers to the main memory for their queues that are operating in split-cache mode, and between the corresponding egress ports competing for block transfers from the main memory, and with regard to worst-case queue scenarios.

63. The method of claim 55 wherein the dynamic use of the cache memory space allows each queue independently to operate in either combined or split-cache mode, providing a seamless switchover therebetween without interruption of service to the ingress and egress ports.

64. Apparatus for non-blocking output-buffered switching of time-successive lines of input data streams along a data path between N input and N output data ports provided with corresponding respective ingress and egress data line cards, and wherein each ingress data port line card receives L bits of data per second of an input data stream to be fed to M memory slices and written to the corresponding memory banks and ultimately read by the corresponding output port egress data line cards, the apparatus having, in combination,
a physically distributed logically shared memory datapath of architecture wherein each line card is associated with a corresponding memory bank, a memory controller and a traffic manager, and wherein each ingress line card is connected to its corresponding memory bank and also to the memory bank of every other line card through an N×M mesh, providing each input port ingress line card with data write access to all the M memory banks, and wherein each data link provides L/M bits per second path utilization;
a further N×M mesh connecting the M memory banks to egress line cards of the corresponding output data ports, with each memory bank being connected not only to its corresponding output port but also to every other output port as well, providing each output port egress line card with data read access to all the M memory banks;
means for segmenting each of the successive lines of each input data stream at each ingress data line card into a row of M data segment slices along the line;
means for partitioning data queues for the memory banks into M physically distributed separate column slices of memory data storage locations or spaces, one corresponding to each data segment slice;
means for writing each such data segment slice of a line along the corresponding link of the ingress N×M mesh into its corresponding memory bank column slice and at the same predetermined corresponding storage location or space address in its respective corresponding memory bank column slice as the other data segment slices of the data line occupy in their respective memory bank column slice, whereby the writing-in and storage of the data line slices occurs in lockstep as a row across the M memory bank column slices; and
means for writing the data segment slices of the next successive data line into their corresponding memory bank column slices at the same queue storage location or space address thereof adjacent the storage location or space row address in that memory bank column slice of the corresponding data segment slice already written in from the preceding input data stream line.

65. The apparatus of claim 64 wherein means is provided for writing the data-slice into memory simultaneously for the slices in each line, and the slice is controlled in size for load-balancing across the memory banks.

66. The apparatus of claim 65 wherein each of the data lines is adjusted to have the same line width.

67. The apparatus of claim 66 wherein, in the event any line lacks sufficient data slices to satisfy this width, means is provided for padding a line with dummy-padding slices sufficient to achieve the same line width and to enable said lockstep storage.

68. The apparatus of claim 64 wherein means is provided for operating the architecture of the distributed lockstep memory bank storage to resemble the operation of a single logical FIFO per data queue of width spanning the M memory banks and with a write bandwidth of L bits/second.

69. The apparatus of claim 64 wherein means is provided for integrating said architecture with a distributed data control path architecture that enables the respective line cards to derive respective data queue pointers for enqueuing and dequeuing functions without a separate control path or centralized scheduler.

70. The apparatus of claim 69 wherein, at the egress side of the distributed data control path, each traffic manager is provided with means for monitoring its own read and write pointers to infer the status of the respective queues, with the lines that comprise the queue spanning the M memory banks.

71. The apparatus of claim 70 wherein the read and write of the data slices is monitored at the corresponding memory controller to permit inferring of line count on the data slice that is current for a particular queue.

72. The apparatus of claim 71 wherein the means for the integrating of the distributed control path with the distributed shared memory architecture enables the traffic managers of the respective egress line cards to provide for quality of service in maintaining data allocations and bit-rate accuracy, and for each of re-distributing unused bandwidth for full output line-rate, and for adaptive bandwidth scaling.

73. The apparatus of claim 64 wherein each queue, though physically distributed, is unified through addressing all the data segment slices of a queue identically across all the M memory bank column slices for the same line.

74. The apparatus of claim 67 wherein the padded data written by the padding means into memory ensure that the state of a queue is identical for all memory slices, with read and write pointers derived from the respective line cards being identical across all the memory slices.

75. The apparatus of claim 74 wherein the ingress side of the distributed control path maintains write pointers for the queues dedicated to that input port, and in the form of an array indexed by queue number.

76. The apparatus of claim 75 wherein means is provided for reading a write pointer from the array based on the queue number and then incremented by the total line count of data transfer, and then written back to the array within a time of minimum data transfer adapted to keep up with L bits/second.

77. The apparatus of claim 64 wherein each output port is provided with a queue per input port per class of service, thereby eliminating any requirement for a queue to have more than L bits/second of write bandwidth, and thereby enabling delivery of ideal quality of service in terms of bandwidth with low latency and jitter.

78. The apparatus of claim 69 wherein the memory bank is partitioned into multiple memory column slices with each memory slice containing all of the columns from each queue and receiving corresponding multiple data streams from different input ports.

79. The apparatus of claim 78 wherein read and write pointers for a single queue are matched across all the M memory slices and corresponding multiple memory column slices, with the multiple data streams being written at the same time and with each of the multiple queues operating independently of one another.

80. The apparatus of claim 79 wherein at the egress ports, means is provided for enabling each memory slice to read up to N data slices, one to each of corresponding output ports during each time-successive output data line, with corresponding multiple data slices, one for each of the multiple queues, being read out to their respective output ports.

81. The apparatus of claim 79 wherein, as the data from the multiple queues is read out of memory, means is provided to supply each output port with the necessary data to maintain line rate on its output.

82. The apparatus of claim 64 wherein, in the non-blocking write data path from the input port into the shared memory bank slices, means is provided for effecting the non-blocking regardless of the input data traffic rate and output port destination, providing a nominal, close to zero, latency on the write path into the shared memory banks.

83. The apparatus of claim 64, wherein in the non-blocking read data path from the shared memory slices to the output ports, means is provided for effecting non-blocking regardless of data traffic queue rates up to L bits/second per port and independent of the input data packet rate.

84. The apparatus of claim 83 wherein means is provided for eliminating contention between the N output ports by providing each output port with equal read access from each memory slice, guaranteeing L/M bits/second from each memory slice for an aggregate bandwidth of L bits/second.

85. The apparatus of claim 71 wherein means for the inferring of the line count on the data slice provides a non-blocking inferred control path that permits the traffic manager at the egress to provide ideal QOS.

86. The apparatus of claim 64 wherein a non-blocking matrix of two-element memory stages for the memory banks is provided to guarantee a non-blocking write path from the N input ports and a non-blocking read path from the N output ports.

87. The apparatus of claim 86 wherein the two-element memory stages are formed of an SRAM memory element enabling temporary data storage therein that builds blocks of data on a per queue basis, and a relatively low speed DRAM memory element for providing primary data packet buffer memory.

88. The apparatus of claim 87 wherein the SRAM element performs a data cache function, always directly accessed by the connected ingress and egress ports but without directly accessing the DRAM element, such that the cache always stores the head of each data queue for the connected egress ports to read from, and the tail of each queue for the connected ingress ports to which to write.

89. The apparatus of claim 88 wherein the SRAM cache is partitioned into queues that correspond to queues maintained in the DRAM memory such that said cache and a memory management controller are seamlessly transferring blocks of data between the SRAM-based cache and the DRAM-based main memory, while guaranteeing the connected egress and ingress ports their respective read and write accesses to the corresponding queues every data transfer interval.

90. The apparatus of claim 89 wherein the cache comprises a QDR SRAM-based cache partitioned into primary and secondary regions and with each queue assigned a ring buffer in each region.

91. The apparatus of claim 90 wherein each queue may operate in two modes; a “combined-cache mode” wherein data is written and read in a single ring buffer by the corresponding ingress and egress ports, respectively; and a “split-cache mode” wherein one ring buffer functions as an egress-cache, and the other ring buffer operates as an ingress-cache.

92. The apparatus of claim 91 wherein, in the “combined-cache mode”, the egress port reads from the head of a queue, and the corresponding ingress port writes to the tail of the queue, with said head and tail contained within a single ring buffer.

93. The apparatus of claim 91 wherein, in the “split-cache mode”, said egress-cache is read by the corresponding egress port, and written by a memory controller to transfer blocks of data from the DRAM-based memory, while said ingress-cache is written by the corresponding ingress port and read by the memory controller for block transfers to the DRAM-based memory, with the head and tail of the queue stored in the two separate ring buffers.

94. The apparatus of claim 93 wherein the head of the queue is contained in the egress-cache, and the tail is contained in the ingress-cache, with the intermediate queue data stored in the DRAM-based main memory.

95. The apparatus of claim 91 wherein, upon the advent of an oversubscribed queue resulting in a ring buffer fill-up, the memory controller effects switching the mode of the oversubscribed queue from combined-cache mode operation to the split-cache operation, enabling a second ring buffer to allow the corresponding ingress port to write the next incoming data directly to it in a seamless manner, and similarly upon the advent of an undersubscribed queue resulting in a ring buffer running dry, the memory controller effects switching the mode of the undersubscribed queue from split-cache mode operation to the combined-cache operation, disabling the first ring buffer to allow the corresponding egress port to read data directly from the second ring buffer in a seamless manner.

96. The apparatus of claim 91 wherein the memory controller transfers blocks of data from the ingress-cache to the main memory to prevent the corresponding ring buffer from overflowing, and similarly transferring blocks of data from the main memory to the egress-cache to prevent the corresponding ring buffer from running dry.

97. The apparatus of claim 91 wherein during queue operation in the split-cache mode, the memory controller transfers blocks of data in and out of the DRAM main memory to prevent starving corresponding egress ports and to prevent the corresponding ingress ports from prematurely dropping data.

98. The apparatus of claim 97 wherein a TDM algorithm is provided to guarantee fairness between ingress ports competing for block transfers to the main memory for their queues that are operating in split-cache mode, and between the corresponding egress ports competing for block transfers from the main memory, and with regard to worst-case queue scenarios.

99. The apparatus of claim 91 wherein the dynamic use of the cache memory space allows each queue independently to operate in either combined or split-cache mode, providing a seamless switchover therebetween without interruption of service to the ingress and egress ports.

100. The apparatus of claim 51 wherein for J read and J write accesses of size D data bits every T nanoseconds, and a requirement to transmit or receive P data bits every T nanoseconds, a matrix memory organization of (N×N)/(J/2×J/2) memory banks is pointed on each of the memory slices, providing a bandwidth of each link of L bits/second divided by the number M of memory slices, where M is defined as P/D.

101. The apparatus of claim 100 wherein the memory organization is variable by changing the number of memory banks on a single memory slice, trading-off additional links and memory slices.

102. The apparatus of claim 100 wherein means is provided for balancing the number of ingress lanes, egress links and memory banks per memory slice to achieve the desired card real estate, backplane connectivity and implementation.

103. The apparatus of claim 100 wherein such balancing is achieved by means for removing rows and respective output ports from the N×N matrix to reduce the number of memory banks per memory slice, while increasing the number of memory slices and ingress links and maintaining the number of egress links.

104. The apparatus of claim 100 wherein such balancing is achieved by means for removing columns and respective ingress ports from the N×N matrix to reduce the number of memory banks per memory slice, thereby increasing the number of memory slices and egress links while maintaining the number of ingress links.

105. The apparatus of claim 67 wherein means is provided to ensure that link bandwidth is not consumed by dummy-padding slices through placing the first data slice of the current incoming data line on the link adjacent to the link used by the last data slice of the previous data line such that the data slices have been rotated within a line.

106. The apparatus of claim 105 wherein a control bit is embedded with the starting data slice to indicate to the egress how to rotate the data slices back to the original order within a line, and a second control bit is embedded with each data slice to indicate if a dummy-padding slice is required for the subsequent line.

107. The apparatus of claim 106 wherein, when a dummy-padding slice is to be written to memory based on the current data slice, means is provided such that said control bit indicates that a dummy-padding slice is required at the subsequent memory slice address with no requirement of increased bandwidth.

108. The apparatus of claim 64 wherein the write pointers reside on the memory slice, insuring that physical addresses are never sent on the N×M ingress or egress meshes.

109. The apparatus of claim 108 wherein means is provided for generating a minimal queue identifier to be transmitted with each data slice to store the data slice into the appropriate location address in the memory slice, while only referencing the queues of the respective current ingress port.

110. The apparatus of claim 87 wherein, when the two-element memory stage is transferring a relatively slow wide block transfer from the SRAM to the DRAM, means is provided for writing data slices accordingly to the SRAM at a location address based on a minimal queue identifier, permitting address generation to reside on the memory controller and not on the input ports and obviating the need for a high address look-up rate on the controller.

111. The apparatus of claim 110 wherein, when N=M, means is provided whereby said memory controller does not require knowledge of the physical address until said transferring of line data from the SRAM to the DRAM.

112. The apparatus of claim 111 wherein the SRAM is selected as QDR SRAM and the DRAM is selected as a RLDRAM.

113. The apparatus of claim 71 wherein the traffic manager of each egress port derives inferred write pointers by monitoring the memory controller for writing to its own queues based on the current state of the read and write pointers, and derives inferred read pointers by monitoring the memory controller for read operations to its own queues.

114. The apparatus of claim 72 wherein means is provided for integrating the egress traffic manager of each output port into the egress data path through the inferred control architecture, and means for enqueuing data from the corresponding memory slice to the egress traffic manager and scheduling the same while managing the bandwidth, request generation and reading from memory and then updating the corresponding originating input port.

115. The apparatus of claim 114 wherein during said enqueuing of data from each egress traffic manager from its own memory slice, each egress traffic manager infers from the ingress and egress data path activity on its own corresponding memory slice the state of its queues across the memory banks.

116. The apparatus of claim 115 wherein means is provided at the egress traffic manager to monitor an interface to the corresponding memory controller for queue identifiers representing write operations for its queues, and means for counting and accumulating the number of write operations to each of its queues, thereby calculating the corresponding line counts and write pointers.

117. The apparatus of claim 1 16 wherein the egress traffic manager residing on each memory slice provides QOS to its corresponding output port through means for determining precisely when and how much data should be dequeued from each of its queues, basing such determining on a scheduling algorithm, a bandwidth management algorithm and the latest information of the state of the queues of each egress traffic manager.

118. The apparatus of claim 1 15 wherein output port time slots are determined by read request from the corresponding egress traffic manager, with means operable upon the granting of read access to an output port, for processing the corresponding read requests, and thereupon transmitting the data slices to the corresponding output port.

119. The apparatus of claim 118 wherein there is provided means for embedding a continuation count for determining the number of further data slices necessary to read, in order to reach the end of a current data packet, thereby allowing each egress traffic manager to dequeue data on packet boundaries to its corresponding egress port.

120. The apparatus of claim 118 wherein each ingress traffic manager is provided with means for monitoring read operations to its dedicated queues to infer the state of its read pointers, means for deriving the line counts or depth of all queues dedicated to it based on corresponding write pointers and inferred read pointers, and means for using said depth to determine when to write or drop an incoming data packet to memory.

121. The apparatus of claim 64 wherein, as additional line cards are provided to add to the aggregate memory bandwidth and storage thereof, means is provided for redistributing the data slices equally amongst all memory slices, utilizing the memory bandwidth and storage of the new memory slices, and reducing bandwidth to the active memory slices, thereby freeing up memory bandwidth to accommodate data slices from new line cards, such that the aggregate read and write bandwidth to each memory slice is 2×L bits/second, when N=M.

122. The apparatus of claim 121 wherein means is provided for reconfiguring the queue size and the physical location and newly added queues with hot swapping facility that supports line cards being removed or inserted without loss of data or disruption of service to data traffic on the active line cards, by the ingress side embedding a control flag with the current data slice, which indicates to the egress side that the ingress side will switch over to a new system configuration at a predetermined address location in the corresponding queue, and to also switch over to the new system configuration when reading from the same address.

123. The apparatus of claim 64 wherein a crosspoint switch is interposed between the links that comprise the N×M ingress and egress meshes to provide connectivity flexibility.

124. The apparatus of claim 64 wherein a time division multiplexer switch is substituted for the N×M ingress and egress meshes and interposed between the input and output ports providing programmable connectivity between memory slices on the traffic managers while reducing the number of physical links.

125. An apparatus for non-blocking output-buffered switching of time-successive lines of input data streams along a data path between N ingress and N egress data ports provided with corresponding respective ingress and egress data line cards, and wherein each ingress data port line card receives L bits of data per second of an input data stream to be fed to M memory slices and written to the corresponding memory banks and ultimately read by the corresponding output port egress data line cards, the apparatus having, in combination, a non-blocking matrix of two-element memory stages for the memory banks to guarantee a non-blocking data write path from the N ingress ports and a non-blocking data read path from the N egress ports, wherein the memory stages comprise a combined SRAM memory element enabling temporary data storage therein that builds blocks of data on a per queue basis, and a relatively low speed DRAM main memory element for providing primary data packet buffer memory.

126. The apparatus of claim 64 wherein multicasting is provided through means for dedicating a queue to be written by a single input port and read by 1 to N output ports, thereby enabling N input ports to multicast the incoming data traffic to the N output ports while maintaining the input line rate of L bits/sec, and similarly enabling N output ports to multicast up to the output line rate of L bits/sec.

127. The method of claim 1 wherein multicasting is effected by dedicating a queue for multicasting per input port per multicast group to enable the queue-to-be-multicast to be written by a single input port and read by 1 to N output ports, thereby enabling N input ports to multicast the incoming data traffic to the N output ports while maintaining the input line rate of L bits/sec, and similarly enabling N output ports to multicast up to the output line rate of L bits/sec.

128. The method of claim 8 wherein, in multicast operation with multicast queues, the line count is only decremented after all output ports have read a line from the queue, thereby achieving per multicast queue line count coherency across all input ports and respective traffic managers.

129. The method of claim 8 wherein, with unicast queues with a single input and output port respective writing and reading queues, the inferred read and write pointers or line counts determine the fullness of a queue for the purpose of either admitting or dropping an incoming data packet, either to increment the corresponding line count when writing to a queue, or for a read operation to the same queue in order to decrement the corresponding line count.

130. The method of claim 1 wherein the ingress line card, the egress line card and the memory slice reside on the same line card.

131. The method of claim 63 wherein when a queue switches from combined cache mode to split-cache mode, the egress cache is full of data and the ingress cache is empty, which guarantees data for the connected egress port and available storage for the connected ingress port, in regard to the worst-case queue scenarios.
